(19) United States
(12) Patent Application Publication
(10) Pub. No.: US 2013/0259129 A1
(43) Pub. Date: Oct. 3, 2013

(54) IMAGE PROCESSING DEVICE AND METHOD

(71) Applicant: Kazushi Sato, Kanagawa (JP)

(72) Inventor: Kazushi Sato, Kanagawa (JP)

(21) Appl. No.: 13/993,443

(22) PCT Filed: Dec. 13, 2011
(86) PCT No.: PCT/JP2011/078764

§ 371 Date: Jun. 12, 2013

(30) Foreign Application Priority Data
Dec. 20, 2010 (JP) 2010283427
Mar. 11, 2011 (JP) 2011054559
Jun. 9, 2011 (JP) 2011129406

(51) Int. Cl. H04N 7/36

(52) U.S. Cl. CPC H04N 19/00733
USPC 375/240.12

(57) ABSTRACT

The present disclosure relates an image processing device and method enabling merging blocks in the temporal direction in motion compensation. Provided is an image processing device including a determining unit configured to determine whether or not motion information of a current block which is to be processed, and motion information of a co-located block situated in the temporal periphery of the current block, match, and a merge information generating unit configured to, in the event that determination is made by the determining unit that these match, generate temporal merge information specifying the co-located block as a block with which the current block is to be temporally merged.

### TECHNICAL FIELD

The present disclosure relates to an image processing device and method.

### BACKGROUND ART

One of the important technologies in video encoding formats such as MPEG4, H.264/AVC (Advanced Video Coding), and HEVC (High Efficiency Video Coding) and so forth, is inter-frame prediction. With inter-frame prediction, the content of an encoded image is predicted using a reference image, and just the difference between the prediction image and actual image is encoded. This realizes compression of code amount. However, in the event that an object is moving greatly within a series of images, the difference between the prediction image and actual image becomes great, and high compression rate cannot be obtained with simple inter-frame prediction. Accordingly, by recognizing motion of objects as vectors, and performing compensation of pixel values in regions where motion is manifested in accordance to motion vectors, realizes reduction of prediction error in inter-frame prediction. Such a technique is called motion compensation.

With H.264/AVC, motion vectors can be set for blocks or partitions of any size of 16×16 pixels, 16×8 pixels, 8×16 pixels, 8×8 pixels, 8×4 pixels, 4×8 pixels, or 4×4 pixels. On the other hand, with HEVC which is a next-generation video encoding format, coding units (CU: Coding Unit) specified in a range of 4×4 pixels through 32×32 pixels are further sectioned into one or more prediction units (PU: Prediction Unit), and motion vectors can be set for each prediction unit. The sizes and shapes of blocks equivalent to prediction units in HEVC are more varied than with blocks in H.264/AVC, and motion of objects can be reflected in motion compensation more accurately (see NPL 1 below) Further, NPL 2 below proposes reducing the amount of code of motion information encoded for each block, by merging (merging) neighbor blocks in the image which share motion information.

Now, a motion vector set to a certain block normally will have correlation with motion vectors set to surrounding blocks. For example, in the event that one moving object is moving within a series of images, the motion vectors of blocks belonging to a range where the moving object is, will have correlation with each other (i.e., either the same or at least similar) Also, there are cases where a motion vector set to a certain block has correlation with motion vectors set to corresponding blocks in a reference image of which the temporal direction distance is close. Accordingly, there is known a technology where motion vectors are predicted using such spatial correlation or temporal correlation of motion, and encode only the difference between the prediction motion vectors and actual motion vectors, so as to further reduce the amount of code of motion vectors (see NPL 3 below).

### CITATION LIST

### Non Patent Literature

NPL 1: JCTVC-B205, “Test Model under Consideration”, Joint Collaborative Team on Video Coding meeting: Geneva, CH, 21-28 July, 2010
NPL 2: JCTVC-A116, “Video Coding Technology Proposal by Fraunhofer HHI”, M. Winken, et al, April, 2010
NPL 3: VCEG-AI22, “Motion Vector Coding with Optimal PMV Selection”, Jungyoup Yang, et al, July, 2008

### SUMMARY OF INVENTION

### Technical Problem

Generally, near the boundary between a moving object moving within a series of images and the background, spatial correlation of motion between the moving object and the background is lost. However, cases where temporal correlation of motion is not lost even near the boundary between a moving object and the background are not unusual. FIG. 38 illustrates an example of such a situation. Referencing FIG. 38, in an image a moving object Obj1 is moving toward a direction D, from a reference image IMref to an image to be encoded IMO. A block B0 within the image to be encoded IMO is situated near the boundary between the moving object Obj1 and the background. The motion vector of this block B0 is actually more similar to a motion vector MVcol of a co-located block Bcol within the reference image IMref, rather than motion vectors MV1 and MV2 of neighbor blocks B1 and B2 within the image to be encoded IMO. In this case, merging neighbor blocks within the image to be encoded (e.g., blocks B0, B1, and B2 in FIG. 38) as with the technique described in the aforementioned NPL 2 worsens image quality. Under such a situation, enabling merging of blocks in the temporal direction besides merging of blocks in the spatial direction can be expected to reap the benefits of reduction in code amount due to merging of blocks, without deteriorating image quality.

Accordingly, the present disclosure proposes an image processing device and method enabling merging of blocks in the temporal direction in motion compensation.

### Solution to Problem

An aspect of the present disclosure is an image processing device including: a determining unit configured to determine whether or not motion information of a current block which is to be processed, and motion information of a co-located block situated in the temporal periphery of the current block, match; and a merge information generating unit configured to, in the event that determination is made by the determining unit that these match, generate temporal merge information specifying the co-located block as a block with which the current block is to be temporally merged.

The merge information generating unit may select the co-located block having motion information matching the motion information of the current block, as the block with which the current block is to be merged, and generate the temporal merge information specifying the selected co-located block.

The merge information generating unit may generate temporal merge enable information specifying whether to temporally merge the co-located block with the current block, as the temporal merge information.

The merge information generating unit may generate temporal motion identification information identifying that the motion information of the current block and the motion information of the co-located block are the same, as the temporal merge information.

The determining unit may determine whether or not motion information of the current block, and motion information of a peripheral block situated in the spatial periphery of the current block, match; and in the event that determination is made by the determining unit that these match, the merge information generating unit may generate spatial merge information specifying the peripheral block as a block with which the current block is to be spatially merged.

The merge information generating unit may generate merge type information identifying the type of processing for merging.

In the event of taking the co-located block and the peripheral block as candidate blocks for performing merging, the merge information generating unit may generate identification information identifying that the motion information of the current block and the motion information of the candidate blocks are the same.

Further included may be a priority order control unit configured to control the priority order of merging the co-located block and the peripheral block with the current block, with the merge information generating unit selecting a block to merge with the current block following the priority order controlled by the priority order control unit.

The priority order control unit may control the priority order in accordance with motion features of the current block.

The priority order control unit may control the priority order such that, in the event that the current block is a still region, the co-located block is given higher priority than the peripheral block.

The priority order control unit may control the priority order such that, in the event that the current block is a moving region, the peripheral block is given higher priority than the co-located block.

Also, an aspect of the present disclosure is an image processing method of an image processing device, the method including: a determining unit determining whether or not motion information of a current block which is to be processed, and motion information of a co-located block situated in the temporal periphery of the current block, match; and in the event that determination is made by the determining unit that these match, a merge information generating unit generating temporal merge information specifying the co-located block as a block with which the current block is to be temporally merged.

Another aspect of the present disclosure is an image processing device, including: a merge information reception unit configured to receive temporal merge information specifying a co-located block, situated in the temporal periphery of a current block which is to be processed, as a block to be temporally merged with the current block; and a setting unit configured to set motion information of the co-located block, specified by the temporal merge information received from the merge information reception unit, as motion information of the current block.

The temporal merge information may specify a co-located block having motion information matching the motion information of the current block, as the block with which the current block is to be temporally merged.

The temporal merge information may include temporal merge enable information specifying whether to temporally merge the co-located block with the current block.

The temporal merge information may include temporal motion identification information identifying that the motion information of the current block and the motion information of the co-located block are the same.

The merge information reception unit may receive spatial merge information specifying a peripheral block, situated in the spatial periphery of the current block, as a block to be spatially merged with the current block; with the setting unit setting motion information of the peripheral block, specified by the spatial merge information received from the merge information reception unit, as motion information of the current block.

The merge information reception unit may receive merge type information identifying the type of processing for merging.

In the event of taking the co-located block and the peripheral block as candidate blocks for performing merging, the merge information reception unit may receive identification information identifying that the motion information of the current block and the motion information of the candidate blocks are the same.

The setting unit may select the co-located block or the peripheral block as a block to merge with the current block, following information received by the merge information reception unit, indicating priority order of merging with the current block, and set the motion information of the selected block as the motion information for the current block.

The priority order may be controlled in accordance with motion features of the current block.

In the event that the current block is a still region, the co-located block may be given higher priority than the peripheral block.

In the event that the current block is a moving region, the peripheral block may be given higher priority than the co-located block.

Another aspect of the present disclosure is an image processing method of an image processing device, the method including: a merge information reception unit receiving temporal merge information specifying a co-located block, situated in the temporal periphery of a current block which is to be processed, as a block to be temporally merged with the current block; and a setting unit setting motion information of the co-located block, specified by the received temporal merge information, as motion information of the current block.

With an aspect of the present disclosure, determination is made regarding whether or not motion information of a current block which is to be processed, and motion information of a co-located block situated in the temporal periphery of the current block, match; and in the event that determination is made that these match, temporal merge information is generated specifying the co-located block as a block with which the current block is to be temporally merged.

With another aspect of the present disclosure, temporal merge information is received specifying a co-located block, situated in the temporal periphery of a current block which is to be processed, as a block to be temporally merged with the current block; and motion information of the co-located block, specified by the received temporal merge information, is set as motion information of the current block.

### Advantageous Effects of Invention

As described above, with an image processing device and method according to the present disclosure, merging blocks in the temporal direction in motion compensation is enabled, and code amount of motion information can be further reduced.

### BRIEF DESCRIPTION OF DRAWINGS

FIG. 1 is a block diagram illustrating an example of the configuration of an image encoding device according to an embodiment.

FIG. 2 is a block diagram illustrating a detailed configuration of a motion search unit of the image encoding device according to an embodiment.

FIG. 3 is an explanatory diagram for describing sectioning of blocks.

FIG. 4 is an explanatory diagram for describing spatial prediction of motion vectors.

FIG. 5 is an explanatory diagram for describing temporal prediction of motion vectors.

FIG. 6 is an explanatory diagram for describing a multi-reference frame.

FIG. 7 is an explanatory diagram for describing a temporal direct mode.

FIG. 8 is an explanatory diagram illustrating a first example of merge information generated with an embodiment.

FIG. 9 is an explanatory diagram illustrating a second example of merge information generated with an embodiment.

FIG. 10 is an explanatory diagram illustrating a third example of merge information generated with an embodiment.

FIG. 11 is an explanatory diagram illustrating a fourth example of merge information generated with an embodiment.

FIG. 12 is an explanatory diagram illustrating a fifth example of merge information generated with an embodiment.

FIG. 13 is an explanatory diagram illustrating a sixth example of merge information generated with an embodiment.

FIG. 14 is a flowchart illustrating an example of the flow of merge information generating processing according to an embodiment.

FIG. 15 is block diagram illustrating an example of the configuration of an image decoding device according to an embodiment.

FIG. 16 is a block diagram illustrating a detailed configuration of a motion compensation unit of the image decoding device according to an embodiment.

FIG. 17 is a flowchart for describing an example of the flow of merge information decoding processing according to an embodiment.

FIG. 18 is a block diagram illustrating an example of a schematic configuration of a television device.

FIG. 19 is a block diagram illustrating an example of a schematic configuration of a cellular phone.

FIG. 20 is a block diagram illustrating an example of a schematic configuration of a recording/playing device.

FIG. 21 is a block diagram illustrating an example of a schematic configuration of an imaging apparatus.

FIG. 22 is a diagram illustrating an example of the configuration of a coding unit, etc.

FIG. 23 is a block diagram illustrating another example of the configuration of an image encoding device.

FIG. 24 is a diagram for describing merge mode.

FIG. 25 is a block diagram illustrating a primary configuration example of a motion prediction/compensation unit and a motion vector encoding unit.

FIG. 26 is a flowchart illustrating an example of the flow of encoding processing.

FIG. 27 is a flowchart for describing an example of the flow of inter motion prediction processing.

FIG. 28 is a flowchart for describing an example of the flow of merge information generating processing.

FIG. 29 is a flowchart continuing from FIG. 28, for describing an example of the flow of merge information generating processing.

FIG. 30 is a block diagram illustrating another example of the configuration of an image decoding device.

FIG. 31 is a block diagram illustrating a primary configuration example of a motion prediction/compensation unit and a motion vector encoding unit.

FIG. 32 is a flowchart for describing an example of the flow of decoding processing.

FIG. 33 is a flowchart for describing an example of the flow of prediction processing.

FIG. 34 is a flowchart for describing an example of the flow of inter motion prediction processing.

FIG. 35 is a flowchart for describing an example of the flow of merge information decoding processing.

FIG. 36 is a flowchart continuing from FIG. 35, for describing an example of the flow of merge information decoding processing.

FIG. 37 is a block diagram illustrating a primary configuration example of a personal computer.

FIG. 38 is an explanatory diagram for describing an example of spatial correlation and temporal correlation of motion.

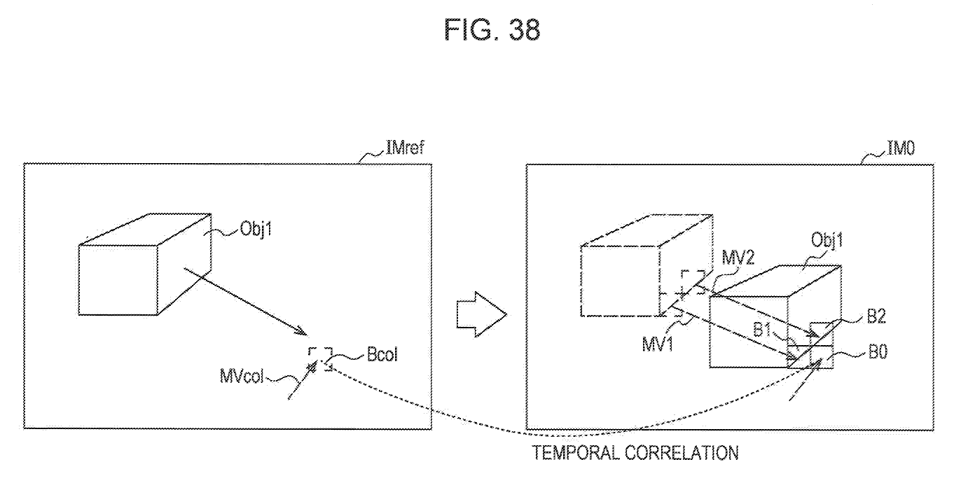

FIG. 39 is a diagram for describing an example of a merge mode control flag.

### DESCRIPTION OF EMBODIMENTS

Preferred embodiments of the present disclosure will be described below in detail with reference to the attached drawings. Note that in the present description and the drawings, components having essentially the same function will be denoted by the same reference numeral, thereby omitting redundant description.

Also, this “Description of Embodiments” will be described in the following order.

1. Configuration Example of Image Encoding Device According to an Embodiment
1-1. Overall Configuration Example
1-2. Configuration Example of Motion Search Unit
1-3. Description of Motion Vector Prediction Processing
1-4. Examples of Merge Information

2. Flow of Processing when Encoding According to an Embodiment

3. Configuration Example of Image Decoding Device According to an Embodiment
3-1. Overall Configuration Example
3-2. Configuration Example of Motion Compensation Unit

4. Flow of Processing when Decoding According to an Embodiment

5. Configuration Example of Image Encoding Device According to Another Embodiment

6. Flow of Processing when Encoding According to Another Embodiment

7. Configuration Example of Image Decoding Device According to Another Embodiment

8. Flow of Processing when Decoding According to Another Embodiment

9. Application Examples

10. Summarization

### 1. CONFIGURATION EXAMPLE OF IMAGE ENCODING DEVICE ACCORDING TO AN EMBODIMENT

[1-1. Overall Configuration Example]

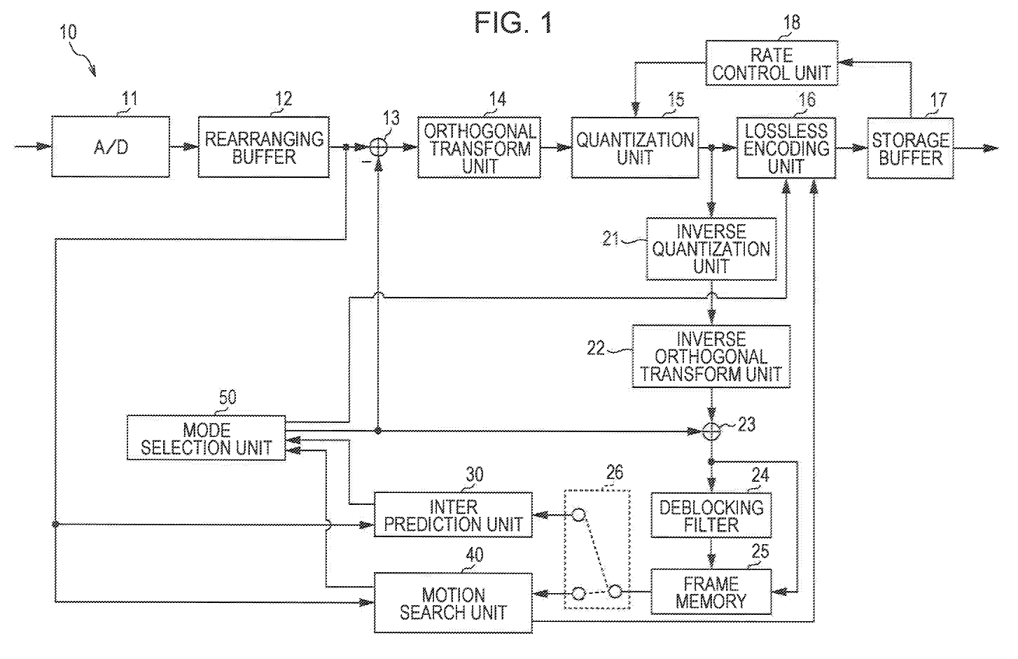

FIG. 1 is a block diagram illustrating an example of the configuration of an image encoding device 10 according to an embodiment of the present disclosure. Referencing FIG. 1, the image encoding device 10 includes an A/D (Analogue to Digital) conversion unit 11, a rearranging buffer 12, a subtracting unit 13, an orthogonal transform unit 14, a quantization unit 15, a lossless encoding unit 16, a storage buffer 17, a rate control unit 18 an inverse quantization unit 21, an inverse orthogonal transform unit 22, an adding unit 23, a deblocking filter 24, frame memory 25, a selector 26, an intra prediction unit 30, a motion search unit 40, and a mode selection unit 50.

The A/D conversion unit 11 converts image signal input in analog format into image data of digital format, and outputs a series of digital image data to the rearranging buffer 12.

The rearranging buffer 12 rearranges images included in the series of image data input from the A/D conversion unit 11. The rearranging buffer 12 rearranges the image according to a GOP (Group of Pictures) structure according to encoding processing, and subsequently outputs the image data after rearranging to the subtracting unit 13, intra prediction unit 30, and motion search unit 40.

The subtracting unit 13 is supplied with image data input from the rearranging buffer 12, and prediction image data selected by the mode selection unit 50 which will be described later. The subtracting unit 13 calculates prediction error data, which is difference between the image data input from the rearranging buffer 12 and prediction image data input from the mode selection unit 50, and outputs the calculated prediction error data to the orthogonal transform unit 14.

The orthogonal transform unit 14 performs orthogonal transform on the prediction error data input from the subtracting unit 13. The orthogonal transform performed by the orthogonal transform unit 14 may be, for example, discrete cosine transform (Discrete Cosine Transform: DCT) or Karhunen-Loéve transform or the like. The orthogonal transform unit 14 outputs transform coefficient data obtained by the orthogonal transform processing to the quantization unit 15.

The quantization unit 15 is supplied with the transform coefficient data input from the orthogonal transform unit 14, and rate control signals from the rate control unit 18 which will be described later. The quantization unit 15 quantizes the transform coefficient data, and outputs transform coefficient data following quantization (hereinafter referred to as quantized data) to the lossless encoding unit 16 and inverse quantization unit 21. Also, by switching quantization parameters (quantization scale) based on rate control signals from the rate control unit 18, the quantization unit 15 changes the bit rate of the quantized data input to the lossless encoding unit 16.

The lossless encoding unit 16 is supplied with quantized data input from the quantization unit 15, and information relating to intra prediction or inter prediction, generated by the intra prediction unit 30 or motion search unit 40 described later and selected by the mode selection unit 50. Information relating to intra prediction may include prediction mode information indicating the optimal intra prediction mode for each block, for example. Information relating to inter prediction may include prediction mode information, merge information and motion information, and so forth, for example, as described later.

The lossless encoding unit 16 performs lossless encoding processing regarding the quantized data, thereby generating an encoded stream. The lossless encoding performed by the lossless encoding unit 16 may be variable-length encoding, or arithmetic encoding or the like, for example. The lossless encoding unit 16 also multiplexes the aforementioned information relating to intra prediction or information relating to inter prediction within a header of the encoded stream (e.g., a block header or slice header or the like). The lossless encoding unit 16 then outputs the generated encoded stream to the storage buffer 17.

The storage buffer 17 temporarily stores the encoded stream input from the lossless encoding unit 16 using a storage medium such as semiconductor memory or the like. The storage buffer 17 then outputs the stored encoded stream at a rate corresponding to the band of the transmission path (or output line from the image encoding device 10).

The rate control unit 18 monitors the available capacity of the storage buffer 17. The rate control unit 18 also generates a rate control signal in accordance with the available capacity of the storage buffer 17, and outputs the generated rate control signal to the quantization unit 15. For example, in the event that the available capacity of the storage buffer 17 is low, the rate control unit 18 generates a rate control signal to lower the bit rate of the quantized data. Also, for example, in the event that the available capacity of the storage buffer 17 is sufficiently great, the rate control unit 18 generates a rate control signal to raise the bit rate of the quantized data.

The inverse quantization unit 21 performs inverse quantization processing on the quantized data input from the quantization unit 15. The inverse quantization unit 21 then outputs the transform coefficient data obtained by the inverse quantization processing to the inverse orthogonal transform unit 22.

The inverse orthogonal transform unit 22 performs inverse orthogonal transform processing on the transform coefficient data input from the inverse quantization unit 21, thereby restoring the prediction error data. The inverse orthogonal transform unit 22 then outputs the restored prediction error data to the adding unit 23.

The adding unit 23 adds the restored prediction error data input from the inverse orthogonal transform unit 22 and the prediction image data input from the mode selection unit 50, thereby generating decoded image data. The adding unit 23 then outputs the generated decoded image data to the deblocking filter 24 and the frame memory 25.

The deblocking filter 24 performs filtering processing to reduce block noise generated at the time of encoding the image. The deblocking filter 24 filters the decoded image data input from the adding unit 23 to remove block noise, and outputs the decoded image data after filtering to the frame memory 25.

The frame memory 25 stores the decoded image data input from the adding unit 23 and the decoded image data after filtering that is input from the deblocking filter 24, using a storage medium.

The selector 26 reads the decoded image data before filtering, to be used for intra prediction, from the frame memory 25, and supplies the decoded image data that has been read out to the intra prediction unit 30 as reference image data. Also, the selector 26 reads the decoded image data after filtering, to be used for inter prediction, from the frame memory 25, and supplies the decoded image data that has been read out to the motion search unit 40 as reference image data.

The intra prediction unit 30 performs intra prediction processing in each intra prediction mode, based on the image data to be encoded that is input from the rearranging buffer 12, and decoded image data supplied via the selector 26. For example, the intra prediction unit 30 evaluates prediction results by each inter prediction mode using predetermined cost functions. The intra prediction unit 30 then selects the intra prediction mode where the cost function value is the smallest, i.e., the intra prediction mode where the compression rate is the highest, as the optimal intra prediction mode. Further, the intra prediction unit 30 outputs prediction mode information indicating this optimal intra prediction mode, prediction image data, cost function value, and like information relating to intra prediction, to the mode selection unit 50.

The motion search unit 40 performs motion search processing with each block set within the image as an object, based on image data to be encoded that is input from the rearranging buffer 12, and decoded image data serving as reference image data supplied from the frame memory 25. Note that in the following description, the term block means a group of pixels in an increment to which a motion vector is set, and includes partitions in H.264/AVC and prediction units (PU) in HEVC.

More specifically, the motion search unit 40 sections a macroblock or coding unit (CU) set in the image, for example, into one or more blocks (PUs in the case of HEVC), following each of the multiple prediction modes. Next, the motion search unit 40 calculates a motion vector for each block, based on the pixel values of the reference image and the pixel values of the original image within each block. Next, the motion search unit 40 performs motion vector prediction using motion vectors set in other blocks. Also, the motion search unit 40 compares the motion vectors calculated for each block, with motion vectors already set to other blocks, and generates merge information including a flag indicating whether or not blocks are to be merged, in accordance with the comparison results thereof. The motion search unit 40 then selects, based on cost function value following a predetermined cost function, the optimal prediction mode and the merge mode for each block (whether or not to merge, and which block to be merged with).

Such motion search processing by the motion search unit 40 will be further described later. As a result of the motion search processing the motion search unit 40 outputs information relating to inter prediction such as prediction mode information, merge information, motion information, and cost function value and so forth, and prediction image data, to the mode selection unit 50.

The mode selection unit 50 compares the cost function value relating to intra prediction input from the intra prediction unit 30, with the cost function value relating to inter prediction input from the motion search unit 40. The mode selection unit 50 then selects, of intra prediction and inter prediction, the prediction technique with the smaller cost function value. In the event that intra prediction has been selected, the mode selection unit 50 outputs information relating to intra prediction to the lossless encoding unit 16, and also outputs prediction image data to the subtracting unit 13 and adding unit 23. Also, in the event that inter prediction has been selected, the mode selection unit 50 outputs the aforementioned information relating to inter prediction to the lossless encoding unit 16, and also outputs prediction image data to the subtracting unit 13 and adding unit 23.

[1-2. Configuration Example of Motion Search Unit]

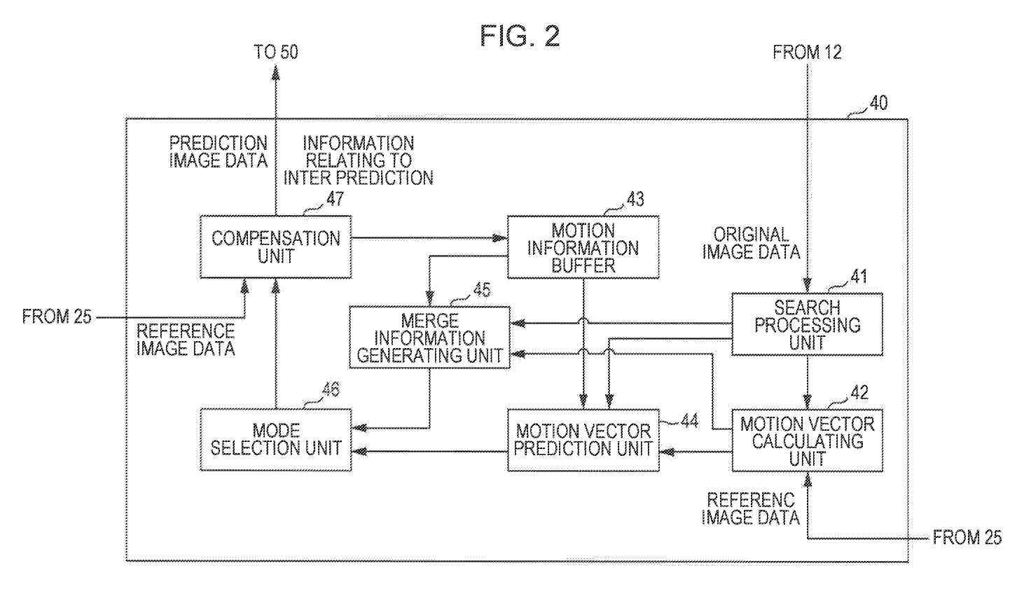

FIG. 2 is a block diagram illustrating an example of a detailed configuration of the motion search unit 40 of the image encoding device 10 illustrated in FIG. 1. With reference to FIG. 2, the motion search unit 40 has a search processing unit 41, a motion vector calculating unit 42, a motion information buffer 43, a motion vector prediction unit 44, a merge information generating unit 45, a mode selection unit 46, and a compensation unit 47.

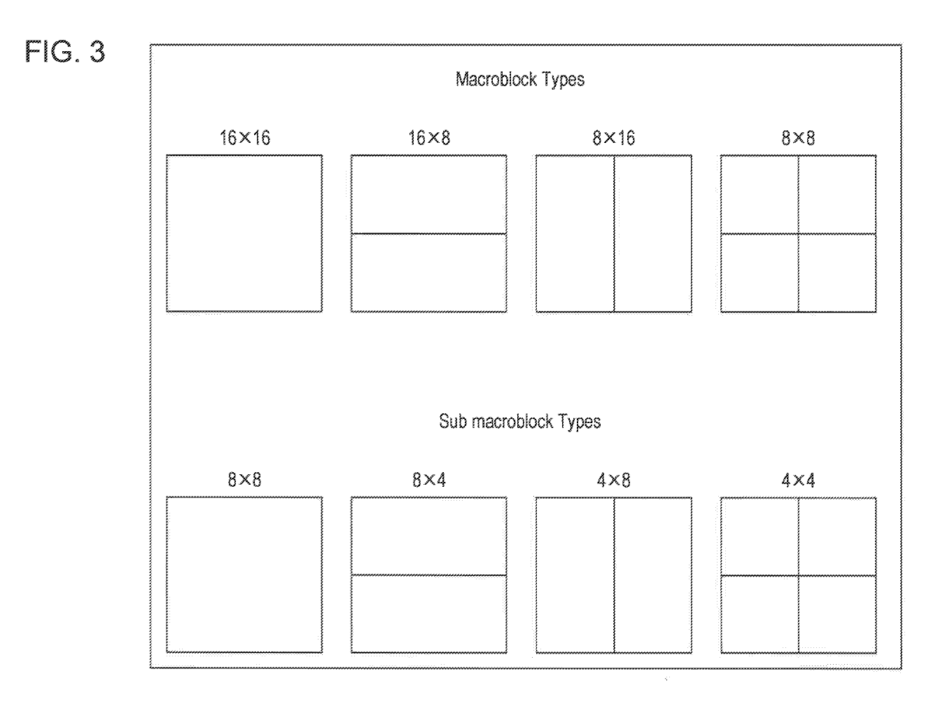

The search processing unit 41 controls the frame to search for an object whether or not to merge, for multiple prediction modes and each block. For example, in the case of H.264/AVC, the search processing unit 41 can section a 16×16 pixel macroblock into blocks of 16×8 pixels, 8×16 pixels, and 8×8 pixels. The search processing unit 41 can further section an 8×8 pixel block into blocks of 8×4 pixels, 4×8 pixels, and 4×4 pixels. Accordingly, in the case of H.264/AVC, eight prediction modes can exist to one macroblock, as exemplarily illustrated in FIG. 3. Also, in the case of HEVC for example, the search processing unit 41 can section up to a 32×32 pixel encoding unit into one or more blocks (prediction units). With HEVC, more varied settings of prediction units is possible as compared with the example in FIG. 3 (see NPL 1). The search processing unit 41 then causes the motion vector calculating unit 42 to calculate motion vectors for each of the sections blocks. Also, the search processing unit 41 causes the motion vector prediction unit 44 to predict motion vectors for each of the blocks. Also, the search processing unit 41 causes the merge information generating unit 45 to generate merge information for each of the blocks.

The motion vector calculating unit 42 calculates a motion vector for each block sectioned by the search processing unit 41, based on the pixel values of the original image, and the pixel values of the reference image input from the frame memory 25. The motion vector calculating unit 42 may calculate motion vectors with ½-pixel precision by interpolating intermediate pixel values of neighboring pixels by linear interpolation, for example. Also, the motion vector calculating unit 42 may further interpolate intermediate pixel values using a 6-tap FIR filter for example, so as to calculate motion vectors with ¼-pixel precision. The motion vector calculating unit 42 outputs the calculated motion vectors to the motion vector prediction unit 44 and merge information generating unit 45.

The motion information buffer 43 temporarily stores, using a storage medium, reference motion vectors and reference image information referenced in motion vector prediction processing by the motion vector prediction unit 44 and merge information generating processing by the merge information generating unit 45. Reference motion vectors stored by the motion information buffer 43 may include a motion vector set in a block within an already-encoded reference image, or a motion vector set in another block within the image to be encoded.

The motion vector prediction unit 44 sets a reference pixel position in each block sectioned by the search processing unit 41, and predicts a motion vector to be used of prediction of pixels values within each block, based on a motion vector (reference motion vector) set in a reference block corresponding to the set reference pixel position. The reference pixel position may be a pixel position uniformly defined beforehand, such as for example, the upper left of a rectangular block, the upper right thereof, or both, or the like.

The motion vector prediction unit 44 may predict multiple motion vectors for one certain block, using candidates of multiple prediction expressions. For example, a first prediction expression may be a prediction expression using spatial correlation of motion, and a second prediction expression a prediction expression using temporal correlation of motion. Also, as a third prediction expression, a prediction expression using both spatial correlation and temporal correlation of motion may be used. In the case of using spatial correlation of motion, the motion vector prediction unit 44 references a reference motion vector set to another block adjacent to the reference pixel position, stored in the motion information buffer 43, for example. Also, in the case of using temporal correlation of motion, the motion vector prediction unit 44 references a reference motion vector set in a block in the reference image regarding which co-location has been made with the reference pixel position, stored in the motion information buffer 43.

Upon calculating a prediction motion vector using one prediction expression for one block, the motion vector prediction unit 44 calculates a differential motion vector, representing the difference between the motion vector calculated by the motion vector calculating unit 42 and this prediction motion vector. The motion vector prediction unit 44 then correlates the above prediction expression with prediction expression information identifying it, and outputs the calculated differential motion vector and reference image information to the mode selection unit 46.

The merge information generating unit 45 generates merge information for each block, based on the motion vector and reference image information calculated by the motion vector calculating unit 42 for each block, and the reference motion vector and reference image information stored in the motion information buffer 43. With the present description, merge information means information for determining whether or not each block within an image is to be merged with another block, and in the case of merging, which block with which to merge. Blocks serving as candidates for merging with one certain block of interest include, in addition to a block neighboring the block of interest at the left and a block neighboring at the top, a co-located block within the reference image. With the present description, these blocks will be called candidate blocks. A co-located block means a block within the reference image, that includes a pixel at the same position as the reference pixel position in the block of interest.

Merge information generated by the merge information generating unit 45 may include three flags of “MergeFlag”, “MergeTempFlag”, and “MergeLeftFlag”, for example. MergeFlag is a flag indicating whether or not the motion information of the block of interest is the same as the motion information of at least one candidate block. For example, in the event of MergeFlag=1, the motion information of the block of interest is the same as the motion information of at least one candidate block. In the event of MergeFlag=0, the motion information of the block of interest differs from the motion information of all other candidate blocks. In the event of MergeFlag=0, the other two flags are not encoded, and instead motion information such as difference motion vector, prediction expression information, and reference image information and so forth are encoded regarding the block of interest. In the event of MergeFlag=1 and the motion information of three candidate blocks is all the same, the other two flags are not encoded, and the motion information regarding the block of interest is not encoded either.

MergeTempFlag is a flag indicating whether or not the motion information of the block of interest is the same as the motion information of a co-located block within the reference image. For example, in the event that MergeTempFlag=1, the motion information of the block of interest is the same as the motion information of a co-located block. In the event that MergeTempFlag=0, the motion information of the block of interest differs from the motion information of a co-located block. In the event that MergeTempFlag=1, MergeLeftFlag is not encoded. Also, in the event that MergeTempFlag=0 and the motion information of two neighbor blocks is the same as well, the other two flags are not encoded.

MergeLeftFlag is a flag indicating whether or not the motion information of the block of interest is the same as the motion information of the neighbor block to the left. For example, in the event that MergeLeftFlag=1, the motion information of the block of interest is the same as the motion information of the neighbor block to the left. In the event that MergeLeftFlag=0, the motion information of the block of interest differs from the motion information of the neighbor block to the left, and is the same as the motion information of the neighbor block above.

The merge information generating unit 45 generates merge information which can include these three flags, and outputs to the mode selection unit 46. With the present embodiment, several examples of merge information which can be generated by the merge information generating unit 45 will be described later with reference to the drawings.

Note that merge information is not restricted to the above-described examples. For example, in the event of not including a left neighbor block or top neighbor block in candidate blocs, the MergeLeftFlag may be omitted. Also, additional neighbor blocks, such as upper left or upper right or the like may be included in candidate blocks, and separate flags corresponding to these neighbor blocks may be added to the merge information. Further, besides co-located blocks, neighbor blocks of co-located blocks may be included in candidate blocks as well.

The mode selection unit 46 selects the inter prediction mode which minimizes the cost function value, using information input from the motion vector prediction unit 44 and merge information generating unit 45. Accordingly, the pattern of block sectioning, and whether or not there will be merging of the blocks, is decided. Also, in the event that a certain block is not to be merged with another block, motion information to be used for motion compensation of the block is decided. As described above, motion information can include reference image information, difference motion vector and prediction expression information, and so forth, The mode selection unit 46 then outputs the prediction mode information representing the selected prediction mode, merge information, motion information, and cost function value and so forth, to the compensation unit 47.

The compensation unit 47 generates prediction image data, using the information relating to inter prediction input from the mode selection unit 46 and reference image data input from the frame memory 25. The compensation unit 47 then outputs the information relating to inter prediction and the generated prediction image data to the mode selection unit 50. The compensation unit 47 also stores the motion information used to generate the prediction image data in the motion information buffer 43.

[1-3. Description of Motion Vector Prediction Processing]

Next, motion vector prediction processing by the above-described motion vector prediction unit 44 will be described.

(1) Spatial Prediction

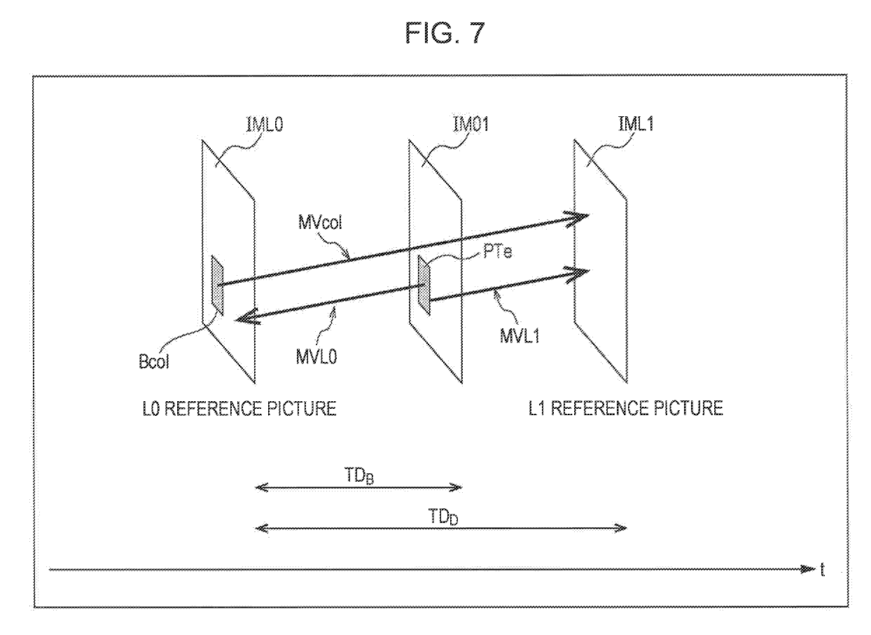

FIG. 7 is an explanatory diagram for describing about spatial prediction of motion vectors. Referencing FIG. 7, there are shown two reference pixel positions PX1 and PX2 in one block PTe. A prediction expression using spatial correlation of motion takes, as input, motion vectors set to other blocks neighboring these reference pixel positions PX1 and PX2, for example. Note that in the present description, the term “neighboring” includes not only cases where two blocks or pixels share a side, for example, but also cases of sharing apices.

For example, we will say that a motion vector set to a block BLa to which a pixel to the left of the reference pixel position PX1 belongs, is MVa. Also, we will say that a motion vector set to a block BLb to which a pixel above the reference pixel position PX1 belongs, is MVb. Also, we will say that a motion vector set to a block BLc to which a pixel to the upper right of the reference pixel position PX2 belongs, is MVc. These motion vectors MVa, MVb, and MVc are already encoded. A prediction motion vector PMVe regarding a block to be encoded PTe is calculated from the motion vectors MVa, MVb, and MVc using a prediction expression such as the following.

[Math. 1]

PMVe=med(MVa,Mvb,MVc) (1)

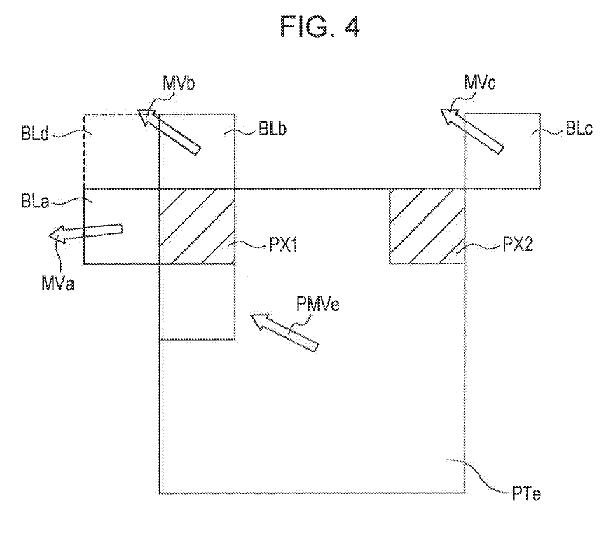

Now, med in Expression (1) represents a media operation. That is to say, according to Expression (1), the prediction motion vector PMVe is a vector having the median value of the horizontal components and the median value of the vertical components of the motion vectors MVa, MVb, and MVc, as the components thereof. Note that the above Expression (1) is but an example of a prediction expression using spatial correlation. For example, in the event that one of the motion vectors MVa, MVb, and MVc does not exist due to the block to be encoded being situated at the edge portion of the image, the motion vector that does not exist may be omitted from the arguments of the median operation. Also, in the event that the block to be encoded is situated at the right edge of the image for example, a motion vector set in block BLd illustrated in FIG. 4 may be used instead of the motion vector MVc.

Note that the prediction motion vector PMVe is also called a predictor (predictor). Particularly, a prediction motion vector calculated by a prediction expression using spatial correlation of motion as with Expression (1) is called a spatial predictor (spatial predictor). On the other hand, a prediction motion vector calculated by a prediction expression using temporal correlation of motion as described with the following section is called a temporal predictor (temporal predictor).

After determining the prediction motion vector PMVe in this way, the motion vector prediction unit 44 calculates a difference motion vector MVDe representing the difference between the motion vector MVe calculated by the motion vector calculating unit 42 and the prediction motion vector PMVe, as with the following expression.

[Math. 2]

MVDe=MVe−PMVe (2)

Difference motion vector information output from the motion search unit 40 as one of information relating to inter prediction represents this difference motion vector MVDe. In the event that the mode selection unit 46 selects not to merge a certain block with another block, such difference motion vector information regarding this block is output from the motion search unit 40 and encoded by the lossless encoding unit 16.

(2) Temporal Prediction

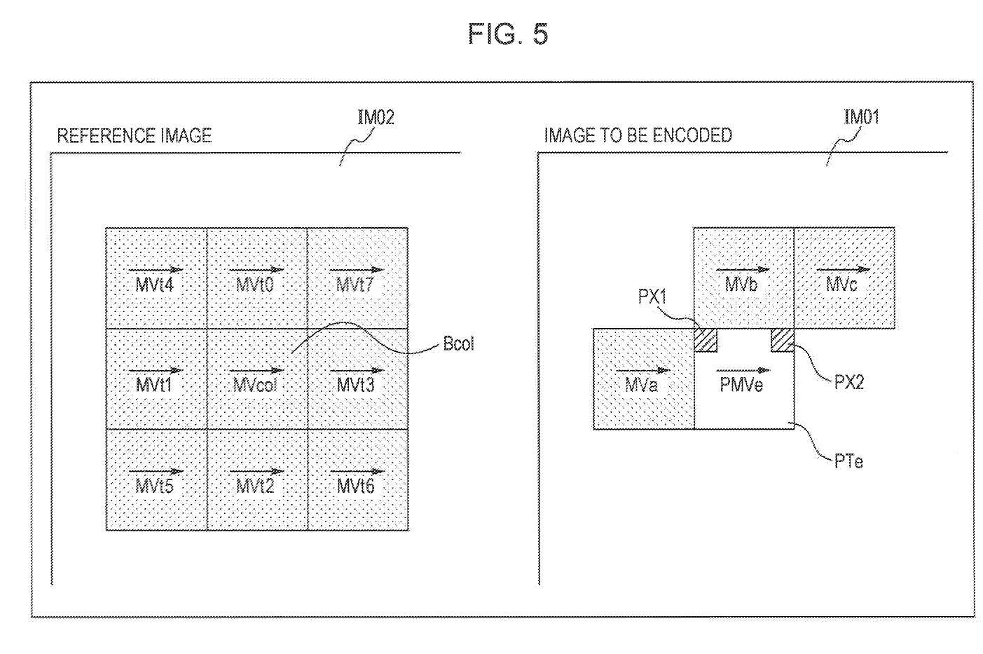

FIG. 5 is an explanatory diagram for describing temporal prediction of motion vectors. With reference to FIG. 5, an image to be encoded IM01 including a block to be encoded PTe, and a reference image IM02 are illustrated. A block Bcol within the reference image IM02 is a so-called co-located block including pixels at positions common with the reference pixel positions PX1 and PX2, within the reference image IM02. A prediction expression using temporal correlation of motion takes, for example, motion vectors set in this co-located block Bcol or in blocks neighboring the co-located block Bcol.

For example, we will say that the motion vector set to the co-located block Bcol is MVcol. Also, we will say that motion vectors set to blocks above, to the left, below, to the right, upper left, lower left, lower right, and upper right, of the co-located block Bcol, are MVt0 through MVt7, respectively. These motion vectors MVcol and MVt0 through MVt7 have already been encoded. In this case, the prediction motion vector PMVe can be calculated from the motion vector MVcol and MVt0 through MVt7, using the following prediction expression (3) or (4), for example.

[Math. 3]

PMVe=med(MVcol,MVt1, . . . ,MVt3) (3)

PMVe=med(MVcol,MVt1, . . . , MVt7) (4)

In this case as well, after having determined the prediction motion vector PMVe, the motion vector prediction unit 44 calculates the difference motion vector MVDe representing the difference between the motion vector MVe calculated by the motion vector calculating unit 42 and the prediction motion vector PMVe.

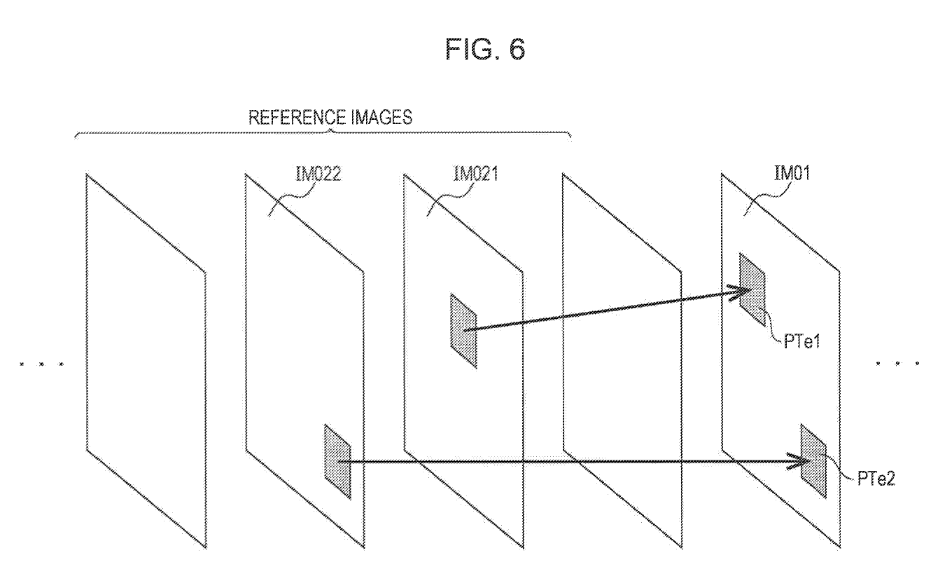

Note that while only one reference image IM02 is shown for one image to be encoded IM01 in the example in FIG. 5, different reference images may be used for each block within the one image to be encoded IM01. In the example in FIG. 6, the reference image to be referenced at the time of prediction of the motion vector of block PTe1 in the image to be encoded IM01 is IM021, and the reference image to be referenced at the time of prediction of the motion vector of block PTe2 is IM022. Such a reference image setting technique is called multi reference frame (Multi-Reference Frame).

(3) Direct Mode

Note that in order to avoid reduction in compression rate due to increase in information amount of the motion vector information, H.264/AVC has introduced the so-called direct mode, with primarily B pictures being the object thereof. In the direct mode, the motion vector information is not encoded, and motion vector information of the block to be encoded is generated from motion vector information of encoded blocks. The direct mode includes the spatial direct mode (Spatial Direct Mode) and temporal direct mode (Temporal Direct Mode), with these two modes being switched between for every slice, for example. This direct mode may be used with the present embodiment, as well.

For example, with the spatial direct mode, the motion vector MVe regarding the block to be encoded is determined by the following expression, using the above-described Prediction Expression (1)

[Math. 4]

MVe=PMVe (5)

FIG. 7 is an explanatory diagram for describing the temporal direct mode. In FIG. 7, reference image IML0 which is a L0 reference picture of the image to be encoded IM01, and reference image IML1 which is a L1 reference picture of the image to be encoded IM01, are illustrated. Block Bcol within the reference image IML0 is a co-located block of the block PTe to be encoded within the image IM01 to be encoded. Now, we will say that the motion vector set the co-located block Bcol is MVcol. We will also say that the distance on the temporal axis between the image to be encoded IM01 and the reference image IML0 is TDB, and the distance on the temporal axis between the reference image IML0 and the reference image IML1 is TDD. In the temporal direct mode, the motion vectors MVL0 and MVL1 regarding the block to be encoded PTe can be determined as with the following expressions.

$$\begin{matrix}[ Math . 5 ] & \\ MVL 0 = \frac{{TD}_{B}}{{TD}_{D}} MVcol & ( 6 ) \\ MVL 1 = \frac{{TD}_{D} - {TD}_{B}}{{TD}_{D}} MVcol & ( 7 )\end{matrix}$$

Note that POC (Picture Order Count) may be used as an index representing distance on the temporal axis. Whether or not to use such a direct mode can be specified in increments of blocks, for example.

[1-4. Examples of Merge Information]

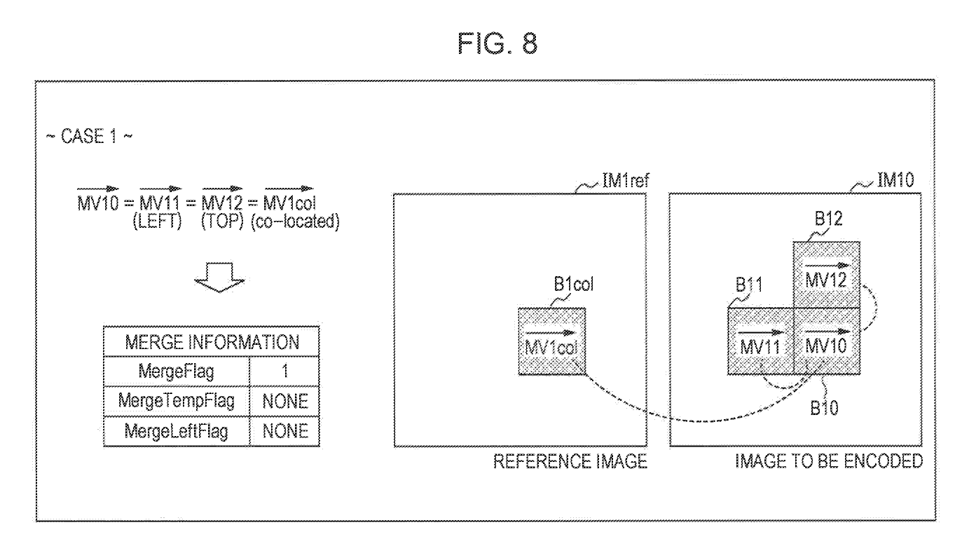

Next, examples of merge information which can be generated by the merge information generating unit 45 according to the present embodiment will be described with reference to FIG. 8 through FIG. 12. Note that form the perspective of simplifying description, description will be made here that only sameness of motion vectors between the block of interest and candidate blocks is determined for the merge information generating unit 45 to generate merge information. However, in reality, the merge information generating unit 45 may determine the sameness of other motion information (reference image information and so forth) besides motion vectors, when generating merge information.

### (1) First Example

FIG. 8 is an explanatory diagram illustrating a first example of merge information generated by the merge information generating unit 45 according to the present embodiment. Referencing FIG. 8, a block of interest B10 is shown within an image to be encoded IM10. Blocks B11 and B12 are neighbor blocks at the left and above the block of interest B10, respectively. A motion vector MV10 is a motion vector calculated by the motion vector calculating unit 42 regarding the block of interest B10. The motion vectors MV11 and MV12 are reference motion vectors set to the neighbor blocks B11 and B12, respectively. Further, a co-located block B1col of the block of interest B10 is shown within the reference image IM1ref. The motion vector MV1col is a reference motion vector set to the co-located block B1col.

In the first example, the motion vector MV10 is the same as all of the reference motion vectors MV11, MV12, and MV1col. In this case, the merge information generating unit 45 generates just MergeFlag=1 as merge information. MergeTempFlag and MergeLeftFlag are not included in merge information. MergeFlag=1 indicates that at least one of the candidate blocks is to be merged with the block of interest. Upon having received such merge information, the decoding side does not decode MergeTempFlag and MergeLeftFlag, but compares the motion information of the three candidate blocks B11, B12, and B1col, and upon recognizing that the motion information is all the same, sets to the block of interest B10 a motion vector the same as the motion vector set to the candidate blocks B11, B12, and B1col.

### (2) Second Example

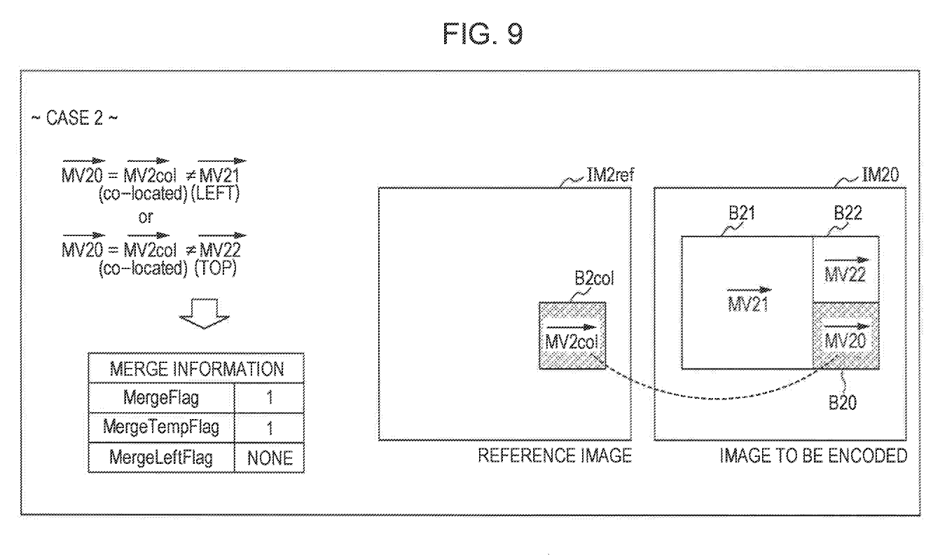

FIG. 9 is an explanatory diagram illustrating a second example of merge information generated by the merge information generating unit 45 according to the present embodiment. Referencing FIG. 9, a block of interest B20 is shown within an image to be encoded IM20. Blocks B21 and B22 are neighbor blocks at the left and above the block of interest B20, respectively. A motion vector MV20 is a motion vector calculated by the motion vector calculating unit 42 regarding the block of interest B20. The motion vectors MV21 and MV22 are reference motion vectors set to the neighbor blocks B21 and B22, respectively. Further, a co-located block B2col of the block of interest B20 is shown within the reference image IM2ref. The motion vector MV2col is a reference motion vector set to the co-located block B2col.

In the second example, the motion vector MV20 is the same as the reference motion vector MV2col. The motion vector MV20 is different from at least one of the reference motion vectors MV21 and MV22. In this case, the merge information generating unit 45 generates MergeFlag=1 and MergeTempFlag=1 as merge information. MergeLeftFlag is not included in merge information MergeTempFlag=1 indicates that the block of interest B20 and the co-located block B2col are to be merged. Upon having received such merge information, the decoding side does not decode MergeLeftFlag, and sets to the block of interest B20 a motion vector the same as the motion vector set to the co-located block B2col.

### (3) Third Example

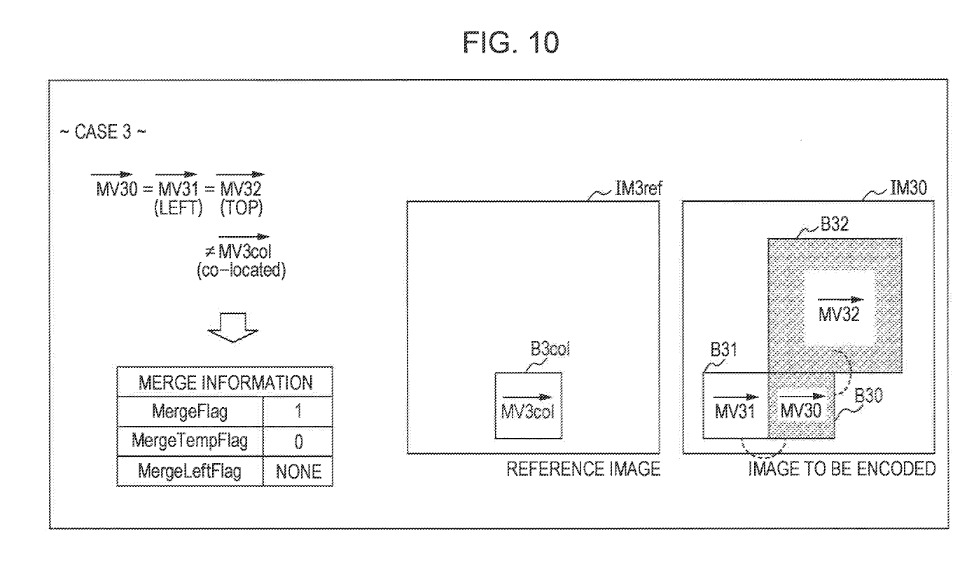

FIG. 10 is an explanatory diagram illustrating a third example of merge information generated by the merge information generating unit 45 according to the present embodiment. Referencing FIG. 10, a block of interest B30 is shown within an image to be encoded IM30. Blocks B31 and B32 are neighbor blocks at the left and above the block of interest B30, respectively. A motion vector MV30 is a motion vector calculated by the motion vector calculating unit 42 regarding the block of interest B30. The motion vectors MV31 and MV32 are reference motion vectors set to the neighbor blocks B31 and B32, respectively. Further, a co-located block B3col of the block of interest B30 is shown within the reference image IM3ref. The motion vector MV3col is a reference motion vector set to the co-located block B3col.

In the third example, the motion vector MV30 is the same as the reference motion vectors MV31 and MV32. The motion vector MV30 is different from reference motion vector MV3col. In this case, the merge information generating unit 45 generates MergeFlag=1 and MergeTempFlag=0 as merge information. MergeLeftFlag is not included in merge information. MergeTempFlag=0 indicates that the block of interest B30 and the co-located block B3col are not to be merged. Upon having received such merge information, the decoding side does not decode MergeLeftFlag, but compares the motion information of the neighbor blocks B31 and B32, and upon recognizing that the motion information is the same, sets to the block of interest B30 a motion vector the same as the motion vector set to the neighbor blocks 331 and B32.

### (4) Fourth Example

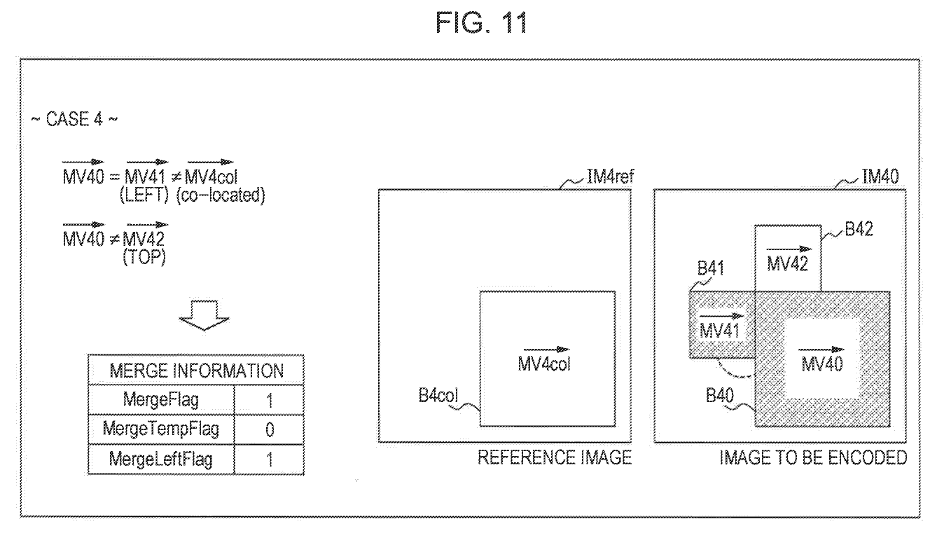

FIG. 11 is an explanatory diagram illustrating a fourth example of merge information generated by the merge information generating unit 45 according to the present embodiment. Referencing FIG. 11, a block of interest B40 is shown within an image to be encoded IM40. Blocks B41 and B42 are neighbor blocks at the left and above the block of interest B40, respectively. A motion vector MV40 is a motion vector calculated by the motion vector calculating unit 42 regarding the block of interest B40. The motion vectors MV41 and MV42 are reference motion vectors set to the neighbor blocks B41 and B42, respectively. Further, a co-located block B4col of the block of interest B40 is shown within the reference image IM4ref. The motion vector MV4col is a reference motion vector set to the co-located block B4col.

In the fourth example, the motion vector MV40 is the same as the reference motion vector MV41. The motion vector MV40 is different from at the reference motion vectors MV42 and MV4col. In this case, the merge information generating unit 45 generates MergeFlag=1, MergeTempFlag=0, and MergeLeftFlag=1 as merge information. MergeLeftFlag=1 indicates that the block of interest B40 and the neighbor block B41 are to be merged. Upon having received such merge information, the decoding side sets to the block of interest B40 a motion vector the same as the motion vector set to the neighbor block B41.

### (5) Fifth Example

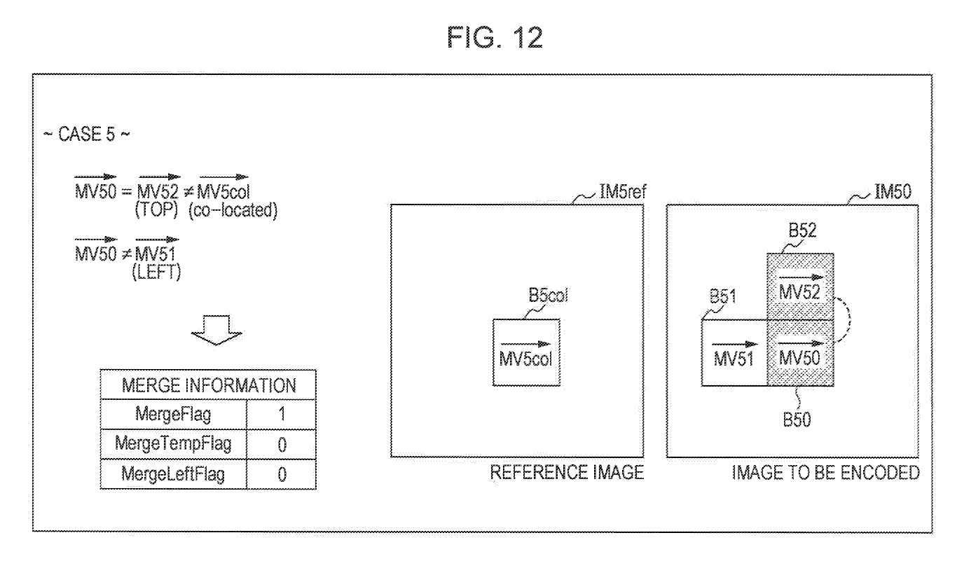

FIG. 12 is an explanatory diagram illustrating a fifth example of merge information generated by the merge information generating unit 45 according to the present embodiment. Referencing FIG. 12, a block of interest B50 is shown within an image to be encoded IM50. Blocks B51 and B52 are neighbor blocks at the left and above the block of interest B50, respectively. A motion vector MV50 is a motion vector calculated by the motion vector calculating unit 42 regarding the block of interest B50. The motion vectors MV51 and MV52 are reference motion vectors set to the neighbor blocks B51 and B52, respectively. Further, a co-located block B5col of the block of interest B50 is shown within the reference image IM5ref. The motion vector MV5col is a reference motion vector set to the co-located block B5col.

In the fifth example, the motion vector MV50 is the same as the reference motion vector MV52. The motion vector MV50 is different from the reference motion vectors MV51 and MV5col. In this case, the merge information generating unit 45 generates MergeFlag=1, MergeTempFlag=0, and MergeLeftFlag=0 as merge information. MergeLeftFlag=0 indicates that the block of interest B50 and the neighbor block BSI are not to be merged. Taking into consideration MergeFlag=1 and MergeTempFlag=0, this also means that the block of interest B50 and the neighbor block B52 are to be merged. Upon having received such merge information, the decoding side sets to the block of interest B50 a motion vector the same as the motion vector set to the neighbor block B52.

### (6) Sixth Example

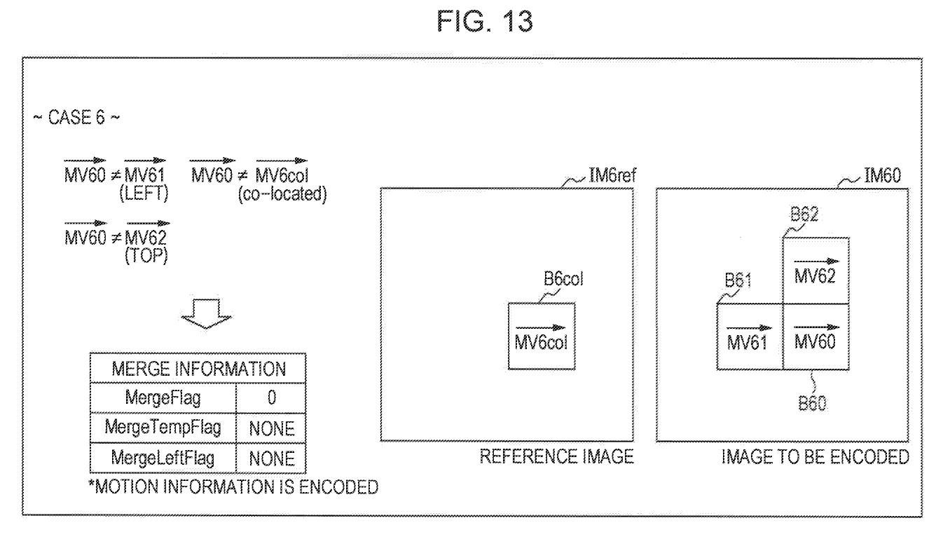

FIG. 13 is an explanatory diagram illustrating a sixth example of merge information generated by the merge information generating unit 45 according to the present embodiment. Referencing FIG. 13, a block of interest B60 is shown within an image to be encoded IM60. Blocks B61 and B62 are neighbor blocks at the left and above the block of interest B60, respectively. A motion vector MV60 is a motion vector calculated by the motion vector calculating unit 42 regarding the block of interest B60. The motion vectors MV61 and MV62 are reference motion vectors set to the neighbor blocks B61 and B62, respectively. Further, a co-located block B6col of the block of interest B60 is shown within the reference image IM6ref. The motion vector MV6col is a reference motion vector set to the co-located block B6col.

In the sixth example, the motion vector MV60 is different from all of the reference motion vectors MV61, MV62, and MV6col. In this case, the merge information generating unit 45 generates just MergeFlag=0 as merge information. MergeTempFlag and MergeLeftFlag are not included in merge information. MergeFlag=0 indicates that none of the candidate blocks are to be merged with the block of interest. In this case, motion information is encoded in addition to the merge information for the block of interest B60. Upon having received such merge information, the decoding side predicts a motion vector for the block of interest B60 based on the motion information, and sets a unique motion vector.

### 2. FLOW OF PROCESSING WHEN ENCODING ACCORDING TO AN EMBODIMENT

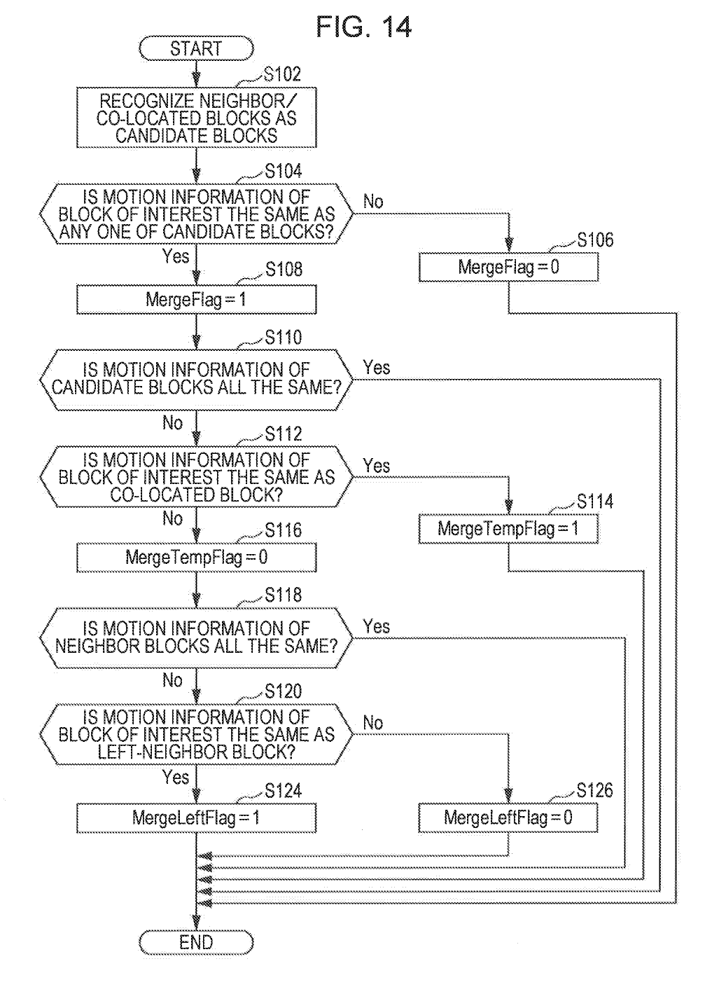

FIG. 14 is a flowchart illustrating an example of the flow of merge information generating processing performed by the merge information generating unit 45 of the motion search unit 40 according to the present embodiment. The merge information generating processing exemplarily illustrated in FIG. 14 can be performed for each of the blocks formed by sectioning a macroblock or coding unit, under control by the search processing unit 41.

With reference to FIG. 14, the merge information generating unit 45 first recognizes a co-located block within a neighbor block of the block of interest and a reference image, as being a candidate block to serve as a candidate of merging with the block of interest (step S102).

Next, the merge information generating unit 45 determines the motion information of which candidate block that the motion information of the block of interest is the same as (step S104). Now, in the event that the motion information of the block of interest is different from motion information of all candidate blocks, MergeFlag is set to zero (step S106), and the merge information generating processing ends. On the other hand, in the event that the motion information of the block of interest is the same as the motion information of any of the candidate blocks, MergeFlag is set to 1 (step S108), and the processing advances to step S110.

In step S110, the merge information generating unit 45 determines whether or not motion information of the candidate blocks is all the same (step S110). Now, in the event that motion information of the candidate blocks is all the same, MergeTempFlag and MergeLeftFlag are not generated, and the merge information generating processing ends. On the other hand, in the event that motion information of the candidate blocks is not all the same, the processing advances to step S112.

In step S112, the merge information generating unit 45 determines whether or not the motion information of the block of interest is the same as the motion information of the co-located block (step S112). Now, in the event that the motion information of the block of interest is the same as the motion information of the co-located block, the MergeTempFlag is set to 1 (step S114), and the merge information generating processing ends. In this case, the MergeLeftFlag is not generated. In the other hand, the motion information of the block of interest is not the same as the motion information of the co-located block, the MergeTempFlag is set to zero (step S116), and the processing advances to step S118.

In step S118, the merge information generating unit 45 determines whether or not the motion information of neighbor blocks is the same with each other (step S118). Now, in the event that the motion information of neighbor blocks is the same, the MergeLeftFlag is not generated, and the merge information generating processing ends. On the other hand, in the event that the motion information of neighbor blocks is not the same, the processing advances to step S120.

In step S120, the merge information generating unit 45 determines whether or not the motion information of the block of interest is the same as the motion information of the neighbor block to the left (step S120). Here, in the event that the motion information of the block of interest is the same as the motion information of the neighbor block to the left, the MergeLeftFlag is set to 1 (step S124), and the merge information generating processing ends. In the other hand, in the event that the motion information of the block of interest is not the same as the motion information of the neighbor block to the left, the MergeLeftFlag is set to zero (step S126), and the merge information generating processing ends.

Now, the merge information generating unit 45 may execute the merge information generating processing described here for each of the horizontal component and vertical component of the motion vectors. In this case, merge information for the horizontal component and merge information for the vertical component are generated for each block. As a result, the effects of reducing motion information by merging blocks can be had for each component of the motion vectors, and further improvement in compression rate can be expected.

### 3. CONFIGURATION EXAMPLE OF IMAGE DECODING DEVICE ACCORDING TO AN EMBODIMENT

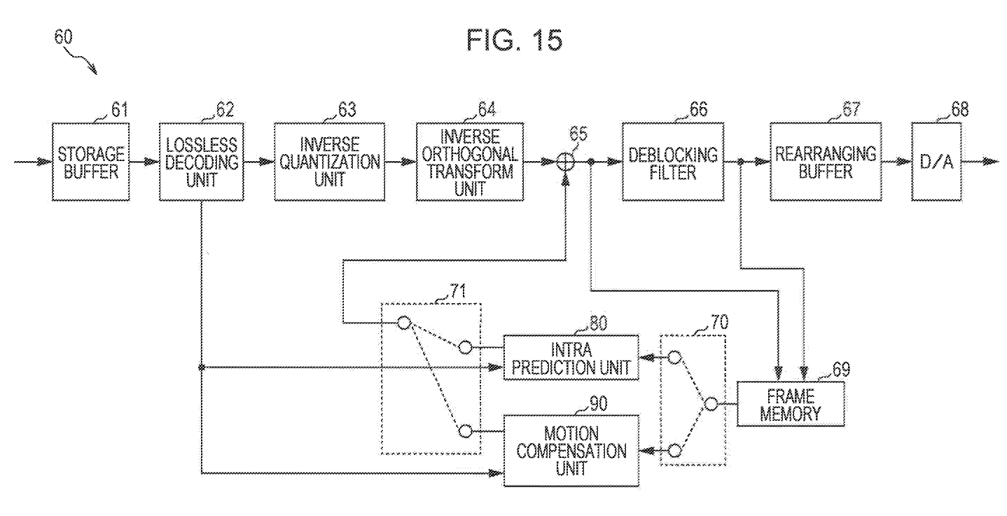

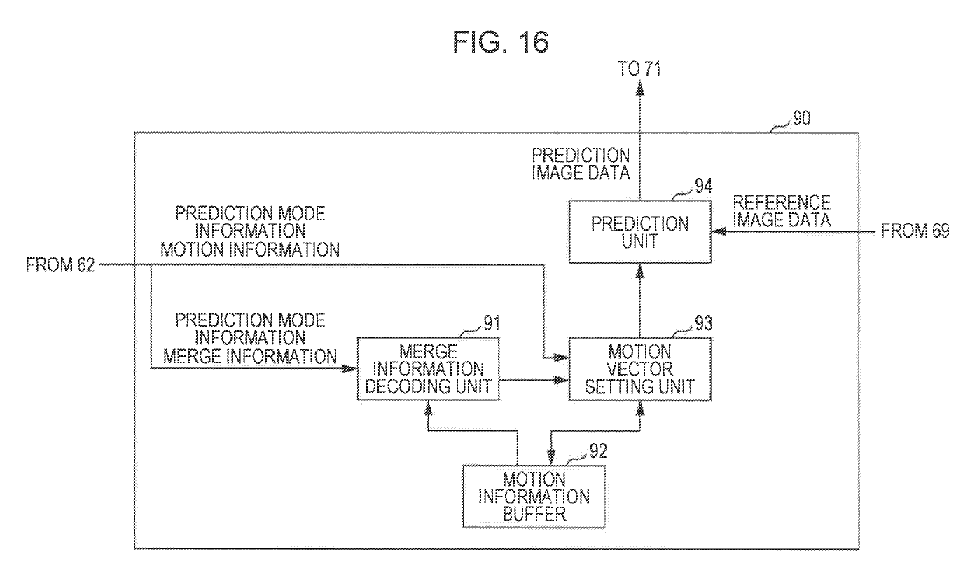

In this section, a configuration example of an image decoding device according to an embodiment of the present disclosure will be described with reference to FIG. 15 and FIG. 16.

[3-1. Overall Configuration Example]

FIG. 15 is a block diagram illustrating an example of the configuration of an image decoding device 60 according to an embodiment of the present disclosure. Referencing FIG. 15, the image decoding device 60 includes a storage buffer 61, a lossless decoding unit 62, an inverse quantization unit 63, an inverse orthogonal transform unit 64, an adding unit 65, a deblocking filter 66, a rearranging buffer 67, a D/A (Digital to Analogue) conversion unit 68, frame memory 69, selectors 70 and 71, an intra prediction unit 80, and a motion compensation unit 90.

The storage buffer 61 temporarily stores encoded streams input via a transmission path, using a storage medium.

The lossless decoding unit 62 decodes the encoded streams input from the storage buffer 61, following the encoding format used at the time of encoding. The lossless decoding unit 62 also decodes information multiplexed in the header region of the encoded stream. Information multiplexed in the header region of the encoded stream may include, for example, information relating to intra prediction and information relating to inter prediction, within block headers. The lossless decoding unit 62 outputs information relating to intra prediction to the intra prediction unit 80. The lossless decoding unit 62 also outputs information relating to inter prediction to the motion compensation unit 90.

The inverse quantization unit 63 performs inverse quantization of quantized data after decoding by the lossless decoding unit 62. The inverse orthogonal transform unit 64 performs inverse orthogonal transform on transform coefficient data input from the inverse quantization unit 63, following the orthogonal transform format used at the time of encoding, thereby generating prediction error data. The inverse orthogonal transform unit 64 then outputs the generated prediction error data to the adding unit 65.

The adding unit 65 adds the prediction error data input from the inverse orthogonal transform unit 64 and prediction image data input from the selector 71, thereby generating decoded image data. The adding unit 65 then outputs the generated decoded image data to the deblocking filter 66 and frame memory 69.

The deblocking filter 66 removes block noise by filtering the decoded image data input from the adding unit 65, and outputs the decoded image data after filtering to the rearranging buffer 67 and frame memory 69.

The rearranging buffer 67 rearranges the images input from the deblocking filter 66, thereby generating a series of image data in time-sequence. The rearranging buffer 67 then outputs the generated image data to the D/A conversion unit 68.

The D/A conversion unit 68 converts the digital format image data input from the rearranging buffer 67 into analog format image signals. The D/A conversion unit 68 then outputs the analog image signals to a display (not shown) connected to the image decoding device 60 for example, so as to display the image.

The frame memory 69 stores decoded image data before filtering that is input from the adding unit 65, and decoded image data after filtering that is input from the deblocking filter 66, using a recording medium.

The selector 70 switches the output destination of the image data from the frame memory 69 between the intra prediction unit 80 and the motion compensation unit 90, for each block within the image, in accordance with the mode information obtained by the lossless decoding unit 62. For example, in the event that the intra prediction mode has been specified, the selector 70 outputs the decoded image data before filtering, that is supplied from the frame memory 69, to the intra prediction unit 80 as reference image data. Also, in the event that the inter prediction mode has been specified, the selector 70 outputs the decoded image data after filtering, that is supplied from the frame memory 69, to the motion compensation unit 90 as reference image data.

The selector 71 switches the output source of the prediction image data to be supplied to the adding unit 65 between the intra prediction unit 80 and the motion compensation unit 90, for each block within the image, in accordance with the mode information obtained by the lossless decoding unit 62. For example, in the event that the intra prediction mode has been specified, the selector 71 supplies the adding unit 65 with prediction image data output from the intra prediction unit 80. Also, in the event that the inter prediction mode has been specified, the selector 71 supplies the adding unit 65 with prediction image data output from the motion compensation unit 90.

The intra prediction unit 80 performs intra-screen prediction of pixel values based on the information relating to intra prediction that is input from the lossless decoding unit 62 and the reference image data from the frame memory 69, and generates prediction image data. The intra prediction unit 80 then outputs the generated prediction image data to the selector 71.

The motion compensation unit 90 performs motion compensation processing based on the information relating to inter prediction that is input from the lossless decoding unit 62 and reference image data from the frame memory 69, and generates prediction image data. The motion compensation unit 90 then outputs the generated prediction image data to the selector 71. Such motion compensation processing by the motion compensation unit 90 will be further described later.

[3-2. Configuration Example of Motion Compensation Unit]

FIG. 16 is a block diagram illustrating a detailed configuration example of the motion compensation unit 90 of the image decoding device 60 illustrated in FIG. 15. Referencing FIG. 16, the motion compensation unit 90 has a merge information decoding unit 91, a motion information buffer 92, a motion vector setting unit 93, and a prediction unit 94.

The merge information decoding unit 91 recognizes each block, serving as units of prediction of motion vectors within the image to be decoded, based on the prediction mode information included in information relating to inter prediction that is input from the lossless decoding unit 62. The merge information decoding unit 91 then decodes merge information to recognize whether or not each block is to be merged with another block, and if to be merged, with which block to be merged. The results of decoding of the merge information by the merge information decoding unit 91 are output to the motion vector setting unit 93.

The motion information buffer 92 temporarily stores motion information such as the motion vectors set to each block by the motion vector setting unit 93 and reference image information and so forth, using a storage medium.

The motion vector setting unit 93 sets, for each block in the image to be decoded, motion vectors to be used for prediction of pixel values within that block, in accordance with the decoding results of the merge information by the merge information decoding unit 91. For example, in the event that a certain block of interest is to be merged with another block, the motion vector setting unit 93 sets the motion vector set to the other block, as the motion vector of the block of interest. On the other hand, in the event that a certain block of interest is not to be merged with another block, the motion vector setting unit 93 sets a motion vector to the block of interest using difference motion vectors, prediction expression information, and reference image information, obtained by decoding the motion information included in the information relating to inter prediction. That is to say, in this case, the motion vector setting unit 93 substitutes a reference motion vector in to a prediction expression identified by the prediction expression information, and calculates a prediction motion vector. The motion vector setting unit 93 then adds a difference motion vector to the calculated prediction motion vector to calculate a motion vector, and sets the calculated motion vector to the block of interest. The motion vector setting unit 93 outputs the motion vectors set to each block and reference image information corresponding thereto, to the prediction unit 94.

The prediction unit 94 generates prediction pixel values for each block within the image to be decoded, using the motion vectors and reference image information set by the motion vector setting unit 93, and the reference image data input from the frame memory 69. The prediction unit 94 then outputs the prediction image data including the generated prediction pixel values to the selector 71.

[4. Flow of Processing when Decoding According to an Embodiment]

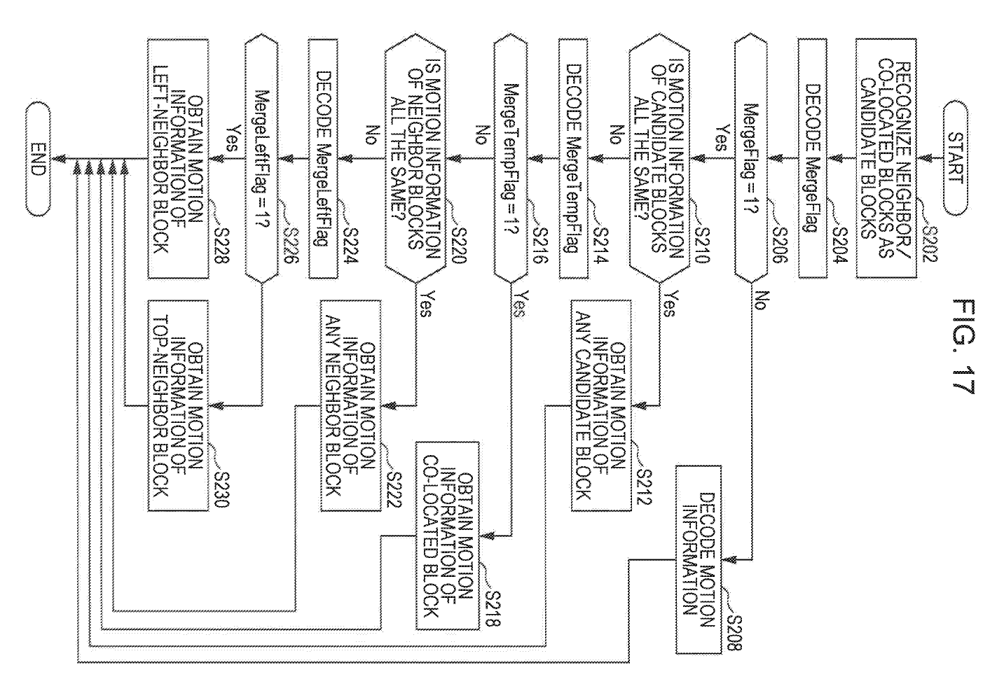

FIG. 17 is a flowchart illustrating an example of the flow of merge information decoding processing by the merge information decoding unit 91 of the motion compensation unit 90 according to the present embodiment. The merge information generating processing exemplarily illustrated in FIG. 17 may be executed for each block within the image to be decoded.

Referencing FIG. 14, first, the merge information decoding unit 91 recognizes neighbor blocks to the block of interest and co-located block within the reference image, as candidate blocks serving as candidates of merging with the block of interest (step S202).

Next, the merge information decoding unit 91 decides the MergeFlag included in the merge information (step S204), The merge information decoding unit 91 then determines which of 1 or zero the MergeFlag is (step S206), If the MergeFlag is zero here, the merge information decoding unit 91 does not decode flags other than the MergeFlag. In this case, motion information is decoded by the motion vector setting unit 93 for the block of interest, with difference motion vector, prediction expression information, and reference image information for motion vector prediction being obtained (step S208).

In the event that MergeFlag is 1 in step S206, the merge information decoding unit 91 determines whether or not all motion information of the candidate blocks is the same (step S210). Now, in the event that all motion information of the candidate blocks is the same, the merge information decoding unit 91 does not decode flags other than the MergeFlag. In this case, the motion vector setting unit 93 obtains motion information of any one of the candidate blocks, and uses the obtained motion information to set the motion vector (step S212).

In step S210, in the event that all motion information of the candidate blocks is not the same, the merge information decoding unit 91 decodes the MergeTempFlag included in the merge information (step S214). The merge information decoding unit 91 then determines which of 1 or zero the MergeTempFlag is (step S216). Now, in the event that MergeTempFlag is 1, the merge information decoding unit. 91 does not decode the MergeLeftFlag. In this case, the motion vector setting unit 93 obtains the motion information of the co-located block, and uses the obtained motion information to set the motion vector (step S218).

In the event that MergeTempFlag is zero in step S216, the merge information decoding unit 91 determines whether or not the motion information of the neighbor blocks is the same with each other (step S220). Now, in the event that the motion information of the neighbor blocks is the same, the merge information decoding unit 91 does not decode the MergeLeftFlag. In this case, the motion vector setting unit 93 obtains the motion information of any one of the neighbor blocks, and uses the obtained motion information to set the motion vector (step S222).

In step S220, in the event that the motion information of the neighbor blocks is not the same, the merge information decoding unit 91 decodes the MergeLeftFlag included in the merge information (step S224). The merge information decoding unit 91 then determines which of 1 or zero the MergeLeftFlag is (step S226). Now, in the event that MergeLeftFlag is 1, the motion vector setting unit 93 obtains the motion information of the neighbor block to the left, and uses the obtained motion information to set a motion vector (step S228). On the other hand, in the event that the MergeLeftFlag is zero, the motion vector setting unit 93 obtains motion information of the neighbor block above, and uses the obtained motion information to set a motion vector (step S230).

Note that in the event that merge information of the horizontal component and merge information of the vertical component are provided separately, the merge information decoding unit 91 executes the merge information decoding processing described here for each of the horizontal component and vertical component of the motion vector.

### 5. CONFIGURATION EXAMPLE OF IMAGE ENCODING DEVICE ACCORDING TO ANOTHER EMBODIMENT

[Coding Units]

Now, the macroblock size of 16×16 pixels is not optimal for large image frames such as UHD (Ultra High Definition; 4000×2000 pixels) which will be handled by next-generation encoding formats.

Accordingly, standardization of an encoding format called HEVC (High Efficiency Video Coding) is currently being advanced by JCTVC (Joint Collaboration Team-Video Coding) serving as a standardization organization of collaboration between ITU-T (International Telecommunication Union Telecommunication Standardization Sector) and ISO (International Organization for Standardization)/IEC (International Electrochenical Commission) with further improvement in encoding efficiency than AVC as an object.

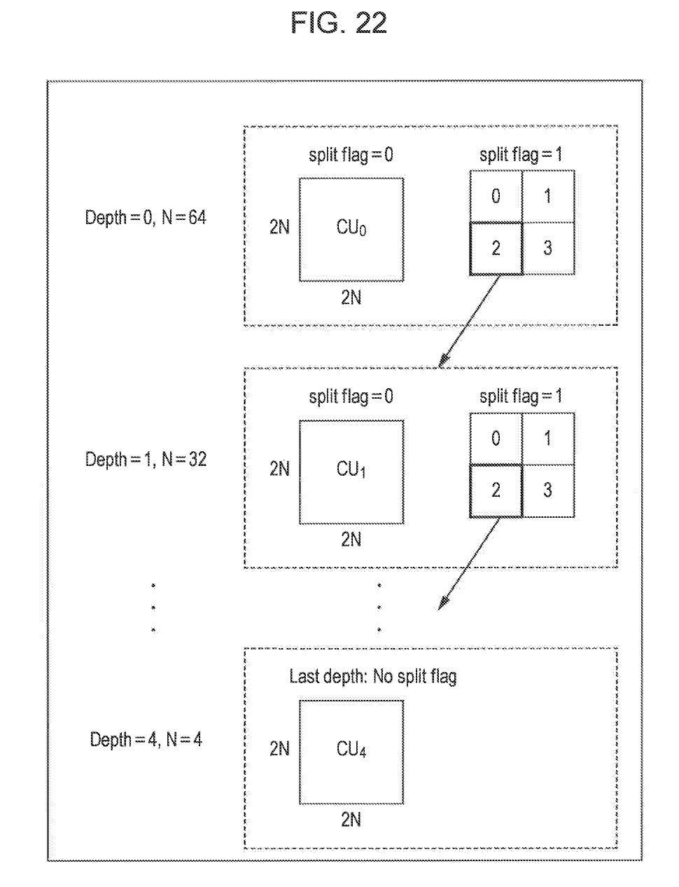

While a hierarchical structure of macroblocks and sub-macroblocks is stipulated under AVC as illustrated in FIG. 3, coding units (CU (Coding Unit)) are stipulated with HEVC as illustrated in FIG. 22.

A CU is also referred to as Coding Tree Block (CTB), and is a partial region of an image in picture increments, serving the same purpose as a macroblock in AVC. The latter is fixed to the size of 16×16 pixels, the size of the former is not fixed, and accordingly is specified within image compressed information in the corresponding sequence.

For example, with a sequence parameter set (SPS (Sequence Parameter Set)) included in the encoded data serving as output, a CU having the maximum size (LCU (Largest Coding Unit)), and the minimum size (SCU (Smallest Coding Unit)) are stipulated.

Within each LCU, division can be made into smaller sized CUs by setting split-flag=1 within a range not smaller than the SCU size. With the example in FIG. 22, the size of an LCU is 128, and the maximum hierarchy depth is 5. A CU having a size of 2N×2N is divided into a CU having a size of N×N which is one hierarchical level lower when the value of split_flag is “1”.

Further, a CU is divided into prediction units ((Prediction Unit (PU)) serving as intra or inter prediction processing increment regions (partial region of an image in picture increments), and also divided into transform units ((Transform Unit (TU)) serving as orthogonal transform processing increment regions (partial regions of images in picture increments). Currently, with HEVC, in addition to 4×4 and 8×8, 16×16 and 32×32 orthogonal transform can be used as well.

If we define CUs as described with HEVC above, and employ an encoding format where various types of processing can be performed with these CUs as increments, macroblocks in AVC can be considered to be equivalent to LCUs. Note however, that CUs have a hierarchical structure such as illustrated in FIG. 22, so the size of the LCU at the highest hierarchical level is generally set greater than a macroblock in AVC, such as 128×128 pixels, for example.

The present disclosure can also be applied to an encoding format using these CUs, PUs, and TUs and the like instead of macroblocks. That is to say, processing increments for performing prediction processing may be optionally determined regions. That is to say, in the following, a region to be subjected to processing of prediction processing (also called current region or region of interest) and peripheral regions thereof are not restricted to such macroblocks and sub-macroblocks, and encompass CUs, PUs, TUs, and so forth.

Also, control of the order of priority of peripheral regions to merge into a current region in the merge mode may be performed by optional processing increments, and may be performed every prediction processing increment region such as CU or PU or the like for example, not just sequences, pictures, and slices. In this case, the order of priority of peripheral regions in the merge mode is controlled in accordance with motion features of the region to be processed, more specifically in accordance to whether the region to be processed (current region) is a region configured of a still image (still region) or a region configured of an image of a moving object (moving region) That is to say, in this case, whether or not the region is a still region is distinguished for each region.

[Image Encoding Device]

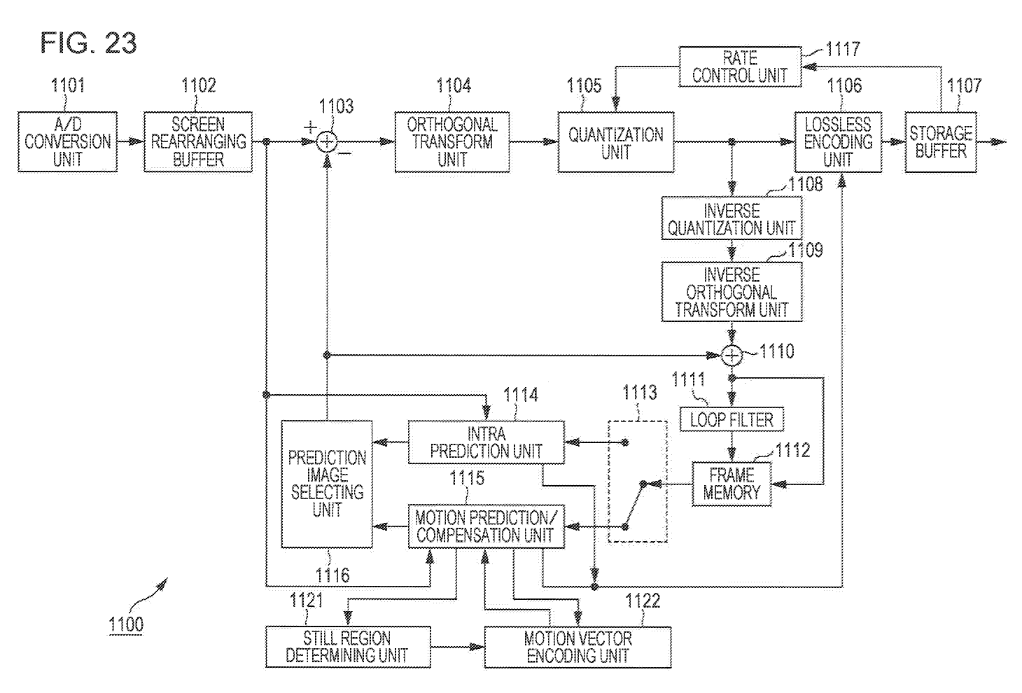

FIG. 23 is a block diagram illustrating a primary configuration example of an image encoding device in this case.

The image encoding device 1100 illustrated in FIG. 23 is basically the same device as the image encoding device 10 in FIG. 1, and encodes image data. Note that, as described with reference to FIG. 23, the image encoding device 1100 performs inter prediction in increments of prediction units (PUs).

An image encoding device 1100 illustrated in FIG. 23 includes an A/D conversion unit 1101, a screen rearranging buffer 1102, a computing unit 1103, an orthogonal transform unit 1104, a quantization unit 1105, a lossless encoding unit 1106, and a storage buffer 1107. Also, the image encoding device 1100 has an inverse quantization unit 1108, an inverse orthogonal transform unit 1109, a computing unit 1110, a loop filter 111, frame memory 1112, a selecting unit 1113, an intra prediction unit 1114, a motion prediction/compensation unit 1115, a prediction image selecting unit 1116, and a rate control unit 1117.

The image encoding device 1100 further includes a still region determining unit 1121 and a motion vector encoding unit 1122.

The A/D conversion unit 1101 performs A/D conversion of the input image data, and supplies the image data after conversion (digital data) to the screen rearranging buffer 1102, so as to be stored. The screen rearranging buffer 1102 rearranges the stored images of frame in the order of display into a frame order for encoding, in accordance with the GOP, and supplies the images of which the frame order has been rearranged to the computing unit 1103. Also, the screen rearranging buffer 1102 also supplies the images of which the frame order has been rearranged, to the intra prediction unit 1114 and motion prediction/compensation unit 1115 as well.

The computing unit 1103 subtracts a prediction image supplied from the intra prediction unit 1114 or motion prediction/compensation unit 1115 via the prediction image selecting unit 1116, from an image read out from the screen rearranging buffer 1102, and outputs the difference information thereof to the orthogonal transform unit 1104.

For example, in a case of an image for which inter encoding is to be performed, the computing unit 1103 subtracts a prediction image supplied from the motion prediction/compensation unit 1115, from an image read out from the screen rearranging buffer 1102.

The orthogonal transform unit 1104 subjects the difference information supplied from the computing unit 1103 to orthogonal transform such as discrete cosine transform or Karhunen-Loéve transform or the like. Note that the orthogonal transform method is optional. The orthogonal transform unit 1104 supplies the transform coefficients thereof to the quantization unit 1105.

The quantization unit 1105 quantizes the transform coefficients supplied from the orthogonal transform unit 1104. The quantization unit 1105 sets quantization parameters based on information relating to target values of encoding amount, supplied from the rate control unit 1117, and performs quantization thereof. Note that the method of this quantization is optional. The quantization unit 1105 supplies the quantized transform coefficients to the lossless encoding unit 1106.

The lossless encoding unit 1106 encodes the transform coefficients that have been quantized at the quantization unit 1105 with an optional encoding format. The coefficient data has been quantized under control of the rate control unit 1117, so this code amount is the target value set by the rate control unit 1117 (or approximates the target value).

Also, the lossless encoding unit 1106 obtains information indicating the mode of intra prediction from the intra prediction unit 1114, and obtains information indicating the mode of inter prediction and motion vector information and so forth from the motion prediction/compensation unit 1115. Further, the lossless encoding unit 1106 obtains filter coefficients and so forth used at the loop filter 1111.

The lossless encoding unit 1106 encodes these various types of information with an optional encoding format, and includes as a part of header information of the encoded data (multiplexes). The lossless encoding unit 1106 supplies the encoded data obtained by encoding to the storage buffer 1107 so as to be stored.

Examples of the encoding format of the lossless encoding unit 1106 include variable length coding, arithmetic coding, or the like. Examples of variable length coding include CAVLC (Context-Adaptive Variable Length Coding) stipulated by the H.264/AVC format. Examples of arithmetic coding include CABAC (Context-Adaptive Binary Arithmetic Coding).

The storage buffer 1107 temporarily holds the encoded data supplied from the lossless encoding unit 1106. The storage buffer 1107 outputs the encoded data held therein to an unshown recording device (recording medium) or transmission path or the like downstream, at a predetermined timing.

Also, the transform coefficients quantized at the quantization unit 1105 are supplied to the inverse quantization unit 1108 as well. The inverse quantization unit 1108 performs inverse quantization of the quantized transform coefficients with a method corresponding to the quantization by the quantization unit 1105. The method of inverse quantization may be any method, as long as it corresponds to the quantization processing by the quantization unit 1105. The inverse quantization unit 1108 supplies the obtained transform coefficients to the inverse orthogonal transform unit 1109.

The inverse orthogonal transform unit 1109 performs inverse orthogonal transform of the transform coefficients supplied from the inverse quantization unit 1108 with a method corresponding to the orthogonal transform processing by the orthogonal transform unit 1104. The method of inverse orthogonal transform may be any method, as long as it corresponds to the orthogonal transform processing by the orthogonal transform unit 1104. The output of inverse orthogonal transform (restored difference information) is supplied to the computing unit 1110.

The computing unit 1110 adds to the inverse orthogonal transform results supplied from the inverse orthogonal transform unit 1109, i.e., to the restored difference information, a prediction image supplied from the intra prediction unit 1114 or the motion prediction/compensation unit 1115 via the prediction image selecting unit 1116, and obtains a locally decoded image (decoded image). The decoded image is supplied to the loop filter 1111 or frame memory 1112.

The loop filter 1111 includes a deblocking filter, adaptive loop filter, or the like, and performs filtering processing as suitable on the decoded image supplied from the computing unit 1110. For example, the loop filter 1111 removes block noise of the decoded image by performing deblocking filter processing as to the decoded image. Also, the loop filter 1111 performs image quality improvement by performing loop filter processing on the deblocking filter processing results (decoded image regarding which removal of block noise has been performed) using a Wiener filter (Wiener Filter).

Note that the loop filter 1111 may perform optional filtering processing as to the decoded image. Also, the loop filter 1111 can supply information of filter coefficients used for filtering processing and so forth to the lossless encoding unit 1106, so as to be encoded.

The loop filter 1111 supplies the filtering processing results (decoded image after filtering processing) to the frame memory 1112. Note that as described above, the decoded image output from the computing unit 1110 may be supplied to the frame memory 1112 without going through the loop filter 1111. That is to say, the filtering processing by the loop filter 1111 may be omitted.

The frame memory 1112 stores the supplied decoded image, and supplies the stored decoded image to the selecting unit 1113 at a predetermined timing, as a reference image.

The selecting unit 1113 elects a supply destination of the reference image supplied from the frame memory 1112. For example, in the case of inter prediction, the selecting unit 1113 supplies the reference image supplied from the frame memory 1112 to the motion prediction/compensation unit 1115.

The intra prediction unit 1114 uses pixel values within the picture to be processed, which is the reference image supplied to the frame memory 1112 via the selecting unit 1113, to intra prediction (intra-screen prediction), to generate a prediction image with basically PUs as the processing increment. The intra prediction unit 1114 performs this intra prediction with multiple modes (intra prediction modes) prepared beforehand.

The intra prediction unit 1114 generates a prediction image with all of the candidate intra prediction modes, evaluates cost function values of the prediction images using the input image supplied from the screen rearranging buffer 1102, and selects an optimal mode. Upon selecting an optimal intra prediction mode, the intra prediction unit 1114 supplies the prediction image generated with that optimal mode to the prediction image selecting unit 1116.

Also, as described above, the intra prediction unit 1114 supplies the intra prediction mode information indicating the intra prediction mode employed, and so forth, to the lossless encoding unit 1106, so as to be encoded.

The motion prediction/compensation unit 1115 performs motion prediction (inter prediction) using the input image supplied from the screen rearranging buffer 1102 and the reference image supplied from the frame memory 1112 via the selecting unit 1113, with basically PUs as the processing increment, performs motion compensation processing in accordance with the detected motion vectors, and generates a prediction image (inter prediction image information). The motion prediction/compensation unit 1115 performs such inter prediction with multiple modes (inter prediction modes) prepared beforehand.

The motion prediction/compensation unit 1115 generates a prediction image with all of the candidate inter prediction modes, evaluates cost function values of the prediction images, and selects an optimal mode. Upon selecting an optimal inter prediction mode, the motion prediction/compensation unit 1115 supplies the prediction image generated in that optimal mode to the prediction image selecting unit 1116.

Also, the motion prediction/compensation unit 1115 supplies the lossless encoding unit 1106 with information indicating the inter prediction mode employed, information necessary for performing processing in that inter prediction mode at the time of decoding the encoded data, and so forth, so as to be encoded.

The prediction image selecting unit 1116 selects the supply source of a prediction image to supply to the computing unit 1103 and computing unit 1110. For example, in the case of inter prediction, the prediction image selecting unit 1116 selects the motion prediction/compensation unit 1115 as the supply source of a prediction image, and supplies a prediction image supplied from that motion prediction/compensation unit 1115 to the computing unit 1103 and computing unit 1110.

The rate control unit 1117 controls the rate of quantization operations of the quantization unit 1105 based on the code amount of the encoded data stored in the storage buffer 1107, so that overflow or underflow does not occur.

The still region determining unit 1121 performs determination regarding whether or not the current region is a still region (still region determination). The still region determining unit 1121 supplies the motion vector encoding unit 1122 with the determination results of whether still region or not.

The motion vector encoding unit 1122 controls the priority of peripheral regions to be merged with the current region in merge mode, based on the determination result of whether or not a still region, supplied from the still region determining unit 1121.

In the case of the merge mode, the motion vector encoding unit 1122 selects a peripheral region to be merged with the current region following the priority thereof, generates merge information which is information relating to that merge mode (information specifying a peripheral region to be merged with the current region) and supplies this merge information to the motion prediction/compensation unit 1115.

Also, in the event of not selecting the merge mode, the motion vector encoding unit 1122 generates prediction motion vector information, and generates difference (difference motion information) between that prediction motion vector information and the motion information (motion vectors) of the current region. The motion vector encoding unit 1122 supplies information such as the generated difference motion information and so forth to the motion prediction/compensation unit 1115.

[Merging of Motion Partitions]

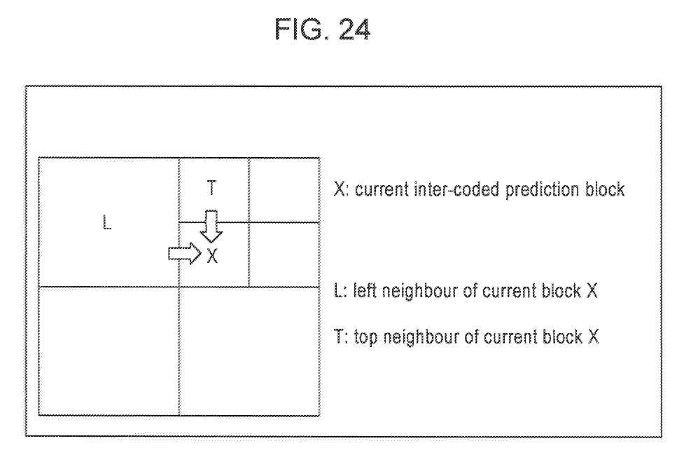

As one encoding method of motion information, there has been proposed, in NPL 2 for example, a technique called Motion Partition Merging (also called merge mode), such as illustrated in FIG. 24. With the merge mode, motion information of a current region is not transmitted but the motion information of the current region is reconstructed using motion information of peripheral regions that has already been processed. In the case of the merge mode described in this NPL 2, two flags of Merge_Flag and Merge_Left_Flag are transmitted.

When Merge_Flag=1, motion information of a current block X is the same as motion information of a block T or a block L, and at this time, the Merge_Left_Flag is transmitted in the image compression information to be output. In the event that the value thereof is 0, the motion information of the current block X is different from the block T and from the block L, and motion information relating to the block X is transmitted in the image compression information.

In the event that Merge_Flag=1 and also Merge_Left_Flag=1, the motion information of the current block X is the same as the motion information of the block L. In the event that Merge_Flag=1 and also Merge_Left_Flag=0, the motion information of the current block X is the same as the motion information of the block L.

The Motion Partition Merging described above is being proposed as a replacement for Skip in AVC.

In the case of merge mode with the image encoding device 1100, in order to suppress image deterioration where spatial direction correlation of motion vectors is low, like near boundaries between moving regions and still regions, not only spatial peripheral regions which are regions where motion information has already been generated (already-processed regions) existing in the same picture as the current region to be processed (current picture), but also a Co-Located region existing at the same position as the current region in a reference picture, i.e., a temporal peripheral region, is also taken as a candidate for regions to merge to the current region. The Co-Located region is also an already-processed region, as a matter of course.

That is to say, the motion vector encoding unit 1122 searches from the motion information of the peripheral region neighboring the current region above, the peripheral region neighboring the current region at the left, and the Co-Located region, for one that matches the motion information of the current region, and merges the current region with the matching region.

In this case, as described with reference to FIG. 8 through FIG. 13, the three flag information of MergeFlag, MergeTempFlag, and MergeLeftFlag are transmitted as merge information. That is to say, the motion vector encoding unit 1122 sets the above three flag values in accordance with the results of comparing the motion vectors of these regions with the motion vector of the current region.

Note that in the event that no peripheral region of which the motion information matches exists, the merge mode is not applied, so the motion vector encoding unit 1122 generates prediction motion vector information and difference motion information for the current region, and also transmits information relating to these as well.

[Priority Order Control]

In the event of using spatial direction motion correlation in a still region adjacent to a moving region, for example, motion vector information of the moving region may propagate to the still region and cause image deterioration. In other words, in the event of constantly taking spatial peripheral regions as candidates as with the method described in NPL 2, the motion information is not readily matched with the current region, and merge mode is less readily selected. As a result, improvement in encoding efficiency may be suppressed.

Accordingly, as described above, the motion vector encoding unit 1122 takes not only spatial peripheral regions but also the temporal peripheral region as candidates. Accordingly, the merge mode being less readily selected is suppressed, and deterioration in encoding efficiency can be suppressed.

However, even in this case, constantly giving motion information of a temporally peripheral region (Co-Located region) as described with reference to FIG. 14 for example, the MergeTempFlag becomes necessary even when a spatial peripheral region is selected, which may lead to unnecessarily increased code amount of merge information.

Accordingly, the motion vector encoding unit 1122 determines merging with which peripheral region to give priority to, based on motion features of the image.

More specifically, in the event that the image is an image where there is a higher probability that temporal correlation is higher than spatial correlation, the motion vector encoding unit 1122 controls such that merging with a temporal peripheral region (Co-Located region) is given priority. Also, in the event that the image is an image where there is a higher probability that spatial correlation is higher than temporal correlation, the motion vector encoding unit 1122 controls such that merging with a spatial peripheral region is given priority.

By adaptively determining the priority order of the peripheral regions, the motion vector encoding unit 1122 can reduce the number of flags included in the merge information, as described later. Accordingly, the motion vector encoding unit 1122 can suppress deterioration in encoding efficiency due to increased merge information.

Also, by determining whether or not to merge with the current region, starting from a peripheral region with higher priority, the load of processing relating to merge information generation can be alleviated.

Further, the motion vector encoding unit 1122 determines which peripheral region to give priority, based on the motion features of the current region. That is to say, the motion vector encoding unit 1122 determines the priority order of the peripheral regions in the merge mode for each region in prediction processing increments, based on the still region determining results of the still region determining unit 1121 as described above.

More specifically, in the event that the still region determining unit 1121 has determined that the current region which is to be processed is a still region, the probability is high that temporal correlation is higher than spatial correlation, so the motion vector encoding unit 1122 effects control so as to give priority to the temporal peripheral region (Co-Located region). Also, in the event that the still region determining unit 1121 has determined that the current region which is to be processed is a moving region, the probability is high that spatial correlation is higher than temporal correlation, so the motion vector encoding unit 1122 effects control so as to give priority to a spatial peripheral region.

Thus, by determining priority order more adaptively, the motion vector encoding unit 1122 can further reduce the number of flags included in merge information. Accordingly, the motion vector encoding unit 1122 can further suppress deterioration in encoding efficiency due to increased merge information.

[Still Region Determination]

Still region determination by the still region determining unit 1121 is performed using the motion information as to the Co-Located region in the reference picture that has already been processed at the point that the current region is to be processed (motion information has already been calculated).

We will say that the current region is PUcurr, the Co-Located region is PUcol, the horizontal component of the motion vector information of the Co-Located region PUcol is MVhcol and the vertical component is MVvcol, and reference index where the Co-Located region PUcol exists is Refcol. The still region determining unit 1121 uses these values to perform-sill region determination of the current region PUcurr.

That is to say, in a case where the following Expression (8) and Expression (9) hold, and also Expression (10) holds, with θ as a threshold, a case where Ref_PicR_reordering is applied, or a case where the reference index Refcol has a POC value indicating a picture immediately before, the still region determining unit 1121 determines the current region PUcurr to be a still region.

|MVhcol|≦θ (8)

|MVvcol|≦θ (9)

Refcol=0 (10)

By the value of the reference index Refcol being 0 in Expression (10), the still region determining unit 1121 determines that the reference region Pucol of the Co-Located region in the reference picture is almost unmistakably configured of a still image. Also, the value of 6 in Expression (8) and Expression (9) should be 0 if both the input image and reference image are original images themselves with no encoding distortion. However, in reality, though the input image is the original itself, the reference image is a decoded image and generally includes encoding distortion. Accordingly, even in the case of a still image, the 0 as the value of θ is not necessarily appropriate.

Accordingly, in the event that the value of the motion vector has ¼-pixel precision, the still region determining unit 1121 sets θ=4. That is to say, in the event that the precision of the motion vector is within 1.0 in integer-pixel precision, the still region determining unit 1121 determines this to be a still region.

The still region determining unit 1121 thus performs still region determination for each region in prediction processing increments, so the motion vector encoding unit 1122 can further suppress deterioration in encoding efficiency by controlling the priority order of peripheral regions following the determination made by the still region determining unit 1121.

Note that in the above, description has been made that three regions are taken as candidates for peripheral regions to use motion information, but is not restricted to this, and with the method described in NPL 2 for example, the Co-Located region may be taken as a merge candidate instead of the region neighboring the current region to the left (Left), or the Co-Located region may be taken as a merge candidate instead of the region neighboring the current region above (Top). Thus, the merge candidates are two regions, so deterioration in encoding efficiency in merge mode can be suppressed with a syntax the same as with the method described in NPL 2.

### [Motion Prediction/Compensation Unit, Still Region Determining Unit, and Motion Vector Encoding Unit]

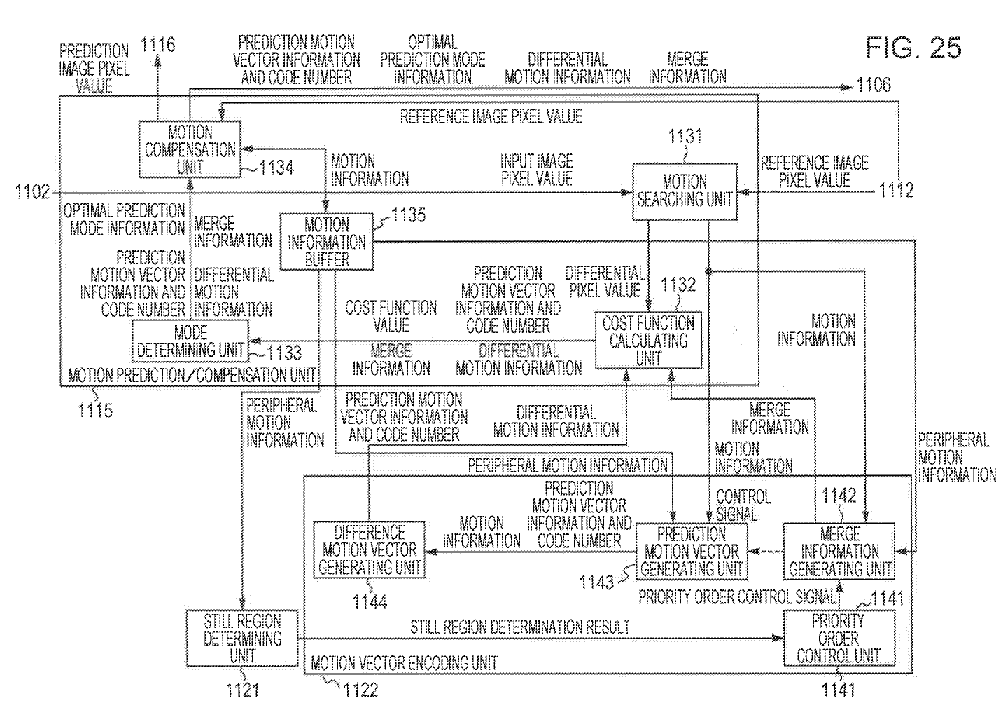

FIG. 25 is a block diagram illustrating a primary configuration example of the motion prediction/compensation unit 1115, still region determining unit 1121, and motion vector encoding unit 1122.

As illustrated in FIG. 25, the motion prediction/compensation unit 1115 has a motion search unit 1131, a cost function calculating unit 1132, a mode determining unit 1133, a motion compensating unit 1134, and a motion information buffer 1135.

Also, the motion vector encoding unit 1122 has a priority order control unit 1141, a merge information generating unit 1142, a prediction motion vector generating unit 1143, and a difference motion vector generating unit 1144.

The motion search unit 1131 receives input of input image pixel values from the screen rearranging buffer 1102 and reference image pixel values from the frame memory 1112. The motion search unit 1131 performs motion search processing on all inter prediction modes, and generates motion information including a motion vector and reference index. The motion search unit 1131 supplies the motion information to the merge information generating unit 1142 and prediction motion vector generating unit 1143 of the motion vector encoding unit 1122.

Also, the still region determining unit 1121 obtains peripheral information which is motion information of peripheral regions stored in the motion information buffer 1135 of the motion prediction/compensation unit 1115, and determines whether or not the region to be processed (current region) is a still region or not, from the peripheral motion information.

For example, with regard to a temporal peripheral region PUcol, in a case where Expression (8) and Expression (9) above hold, and also Expression (10) holds, a case where Ref_PicR_reordering is applied, or a case where the reference index Refcol has a POC value, the still region determining unit 1121 determines that the current region PUcurr is a still region. The still region determining unit 1121 supplies such still region determination results to the priority order control unit 1141 of the motion vector encoding unit 1122.

Upon obtaining still region determination results from the still region determining unit 1121, the priority order control unit 1141 of the motion vector encoding unit 1122 decides the priority order of peripheral regions in merge mode following the still region determination results, and supplies priority order control signals controlling the priority order thereof to the merge information generating unit 1142.

The merge information generating unit 1142 obtains motion information of the current region from the motion search region 1131, obtains motion information of candidate peripheral regions from the motion information buffer 1135, and compares these following control of the priority order control unit 1141. The merge information generating unit 1142 sets values of the flags such as MergeFlag, MergeTempFlag, and MergeLeftFlag and so forth, in accordance with the comparison results, and generates merge information including the flag information thereof.

The merge information generating unit 1142 supplies the generated merge information to the cost function calculating unit 1132. Also; in the event that there is no match between the motion information of the current region and the peripheral motion information, and merge mode is not selected, the merge information generating unit 1142 supplies the prediction motion vector generating unit 1143 with control signals instructing generating of a prediction motion vector.

The prediction motion vector generating unit 1143 follows the control signals and obtains the motion information in each inter prediction mode for the current region from the motion search unit 1131, and obtains peripheral motion information corresponding to each motion information from the motion information buffer 1135. The prediction motion vector generating unit 1143 uses this peripheral motion information to generate multiple candidate prediction motion vector information.

The prediction motion vector generating unit 1143 supplies the difference motion vector generating unit 1144 with the information obtained from the motion search unit 1131, each candidate prediction vector information generated, and code numbers assigned to each.

The difference motion vector generating unit 1144 selects an optimal one from the prediction motion vector information supplied thereto, for each inter prediction mode, and generates difference motion vector information including the difference value between the motion information and the prediction motion vector information thereof. The difference motion vector generating unit 1144 supplies the generated difference motion vector information in each inter prediction mode, the prediction motion vector information of the selected inter prediction mode, and the code number thereof, to the cost function calculating unit 1132 of the motion prediction/compensation unit 1115.

Also, the motion search unit 1131 uses the searched motion vector information to perform compensation processing on the reference image, and thus generates a prediction image. Further, the motion search unit 1131 calculates the difference between the prediction image and the input image (difference pixel values), and supplies the difference pixel values to the cost function calculating unit 1132.

The cost function calculating unit 1132 uses the difference pixel values of each inter prediction mode, supplied from the motion search unit 1131, and calculates the cost function values in each inter prediction mode. The cost function calculating unit 1132 supplies the cost function value in each inter prediction mode that have been calculated, and merge information to the mode determining unit 1133. The cost function calculating unit 1132 also supplies, as necessary, the difference motion information in each inter prediction mode, the prediction motion vector information in each inter prediction mode, and the code numbers thereof, to the mode determining unit 1133.

The mode determining unit 1133 determines which of the inter prediction modes to use, using the cost function values as to the inter prediction modes, and takes the inter prediction mode with the smallest cost function value as being an optimal prediction mode. The mode determining unit 1133 supplies the optimal mode information which is information relating to the optimal prediction mode thereof, and the merge information, to the motion compensating unit 1134. The mode determining unit 1133 also supplies, as necessary, the difference motion information, prediction vector information, and code number, of the inter prediction mode selected to be the optimal prediction mode, to the motion compensating unit 1134.

The motion compensating unit 1134 obtains a motion vector for the optimal prediction mode using the supplied information. For example, in the event that merge mode has been selected, the motion compensating unit 1134 obtains motion information of a peripheral region specified by the merge information from the motion information buffer 1135, and takes the motion vector thereof as the motion vector of the optimal prediction mode. Also, in the event that merge mode has not been selected, the motion compensating unit 1134 generates the motion vector of the optimal prediction mode, suing the difference motion information and prediction motion vector information and so forth supplied from the mode determining unit 1133, and performs compensation of the reference image from the frame memory 1112 using the obtained motion vector, thereby generating a prediction image for the optimal prediction mode.

In the event that inter prediction has been selected by the prediction image selecting unit 1116, a signal indicating this is supplied from the prediction image selecting unit 1116. In response to this, the motion compensating unit 1134 supplies the optimal prediction information and merge information to the lossless encoding unit 1106. The motion compensating unit 1134 also supplies, as necessary, the difference motion vector information of the optimal mode, and the code number of the prediction motion vector information, to the lossless encoding unit 1106.

Also, the motion compensating unit 1134 stores optimal prediction mode motion information in the motion information buffer 1135. Note that in the event that inter prediction is not selected by the prediction image selecting unit 1116 (i.e., in the event that an intra prediction image is selected), a 0 vector is stored in the motion information buffer 1135 as motion vector information.

The motion information buffer 1135 stores motion information of the optimal prediction mode of regions processed in the past. The stored motion information is supplied to each part as peripheral motion information, in processing as to regions processed later in time than that region.

As described above, the still region determining unit 1121 performs determination regarding whether or not a still region, for every prediction processing unit. The motion vector encoding unit 1122 then controls priority order of peripheral regions in merge mode based on the still region determination results, and in the event that the current region is a still region, compares temporal peripheral motion information with priority against the motion information of the current region. Conversely, in the event that the current region is a moving region, the motion vector encoding unit 1122 compares spatial peripheral motion information with priority against the motion information of the current region. Accordingly, the image encoding device 1100 can suppress increase in code amount of merge information, and improve encoding efficiency.

### 6. FLOW OF PROCESSING WHEN ENCODING ACCORDING TO ANOTHER EMBODIMENT

[Flow of Encoding Processing]

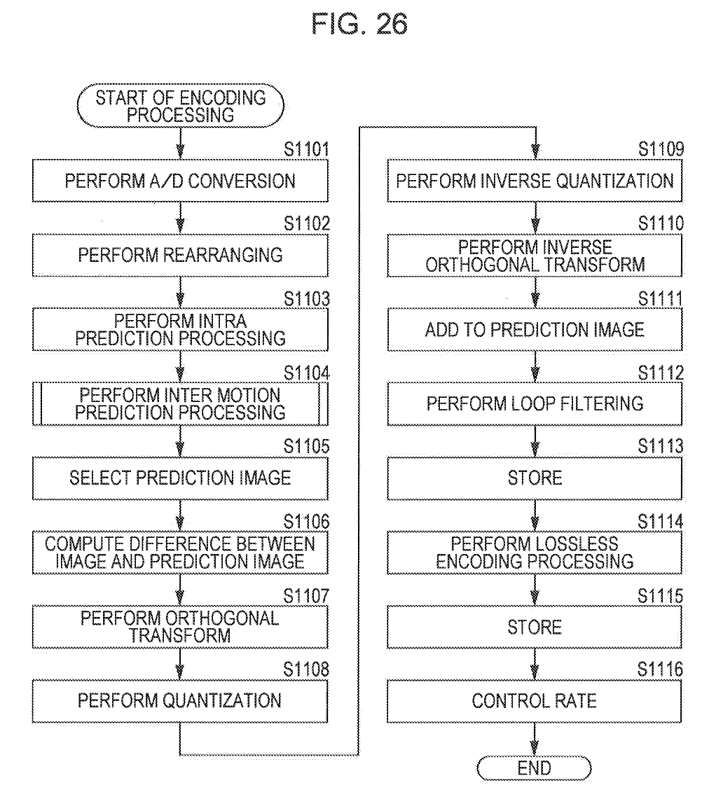

Next, the flow of each processing of the image encoding device 1100 such as described above will be described. First, the flow of encoding processing will be described with reference to the flowchart in FIG. 26.

In step S1101, the A/D conversion unit 1101 converts an input image from analog to digital. In step S1102, the screen rearranging buffer 1102 stores the A/D-converted image, and performs rearranging from the sequence for displaying the pictures to the sequence for encoding.

In step S1103, the intra prediction unit 1114 performs intra prediction processing in intra prediction mode. The step S1104, the motion prediction/compensation unit 1115 performs inter motion prediction processing where motion prediction and motion compensation is performed in inter prediction mode.

In step S1105, the prediction image selecting unit 1116 decides the optimal mode based on each cost function value output from the intra prediction unit 1114 and motion prediction/compensation unit 1115. That is to say, the prediction image selecting unit 1116 selects one of a prediction image generated by the intra prediction unit 1114 and a prediction image generated by the motion prediction/compensation unit 1115.

In step S1106, the computing unit 1103 computes the difference between an image rearranged by the processing in step S1102 and the predictions image selected by the processing in step S1105. The difference image has reduced data amount as compared to the original image data. Accordingly, the data amount can be compressed as compared to encoding the image as it is.

In step S1107, the orthogonal transform unit 1104 performs orthogonal transform of the difference information generated by the processing in step S1106. Specifically, orthogonal transform processing such as discrete cosine transform, Karhunen-Loéve transform, or the like, and a transform coefficient is output.

In step S1108, the quantization unit 1105 quantizes the orthogonal transform coefficient obtained by the processing in step S1107.

The difference information quantized by the processing in step S1108 is locally decoded as follows. That is to say, in step S1109, the inverse quantization unit 1108 inverse-quantizes the orthogonal transform coefficient quantized by the processing of step S1108 with a property corresponding to the property of the quantization unit 1105 (also called quantization coefficient). In step S1110, the inverse orthogonal transform unit 1109 performs inverse orthogonal transform of the orthogonal transform coefficients obtained by the processing of step S1107 with properties corresponding to the properties of the orthogonal transform unit 1104.

In step S1111, the computing unit 1110 adds the prediction image to the locally decoded difference information, and generates a locally decoded image (image corresponding to the input to the computing unit 1103). In step S1112, the loop filter 1111 performs loop filter processing including deblocking filter processing and adaptive filter processing and so forth, on the decoded image locally generated by the processing of step S1111, as appropriate.

In step S1113, the frame memory 1112 stores the decoded image that has been subjected to loop filter processing by processing of step S1112. Note that the image that has not been subjected to filtering processing by the loop filter 1111 is supplied from the computing unit 1110 to the frame memory 1112, and stored.

In step S1114, the lossless encoding unit 1106 encodes the transform coefficient quantized by the processing of step S1108. That is, lossless encoding such as variable length coding or arithmetic encoding is performed on the difference image.

Note that the lossless encoding unit 1106 encodes the quantization parameter calculated in step S1108, and adds to the encoded data. Also, for example, the lossless encoding unit 1106 encodes information relating to the prediction mode of the prediction image selected by the processing in step S1105, and adds to the encoded data obtained by encoding the difference image. That is to say, the lossless encoding unit 1106 encodes optimal intra prediction mode information supplied from the intra prediction unit 1114, or information according to the optimal inter prediction mode supplied from the motion prediction/compensation unit 1115, and so forth, as well, and adds to the encoded data.

In step S1115, the storage buffer 1107 stores the encoded data generated by the processing of step S1114. The encoded data stored in the storage buffer 1107 is read out as appropriate and is transmitted to the decoding side via a transmission path or storage medium or the like.

In step S1116, the rate control unit 1117 controls the rate of the quantization operation of the quantization unit 1105 such that overflow or underflow does not occur, based on the code amount of encoded data (generated code amount) stored in the storage buffer 1107 by the processing of step S1115.

When the processing of step S1116 ends, the encoding process ends.

Flow of Inter Motion Prediction Processing

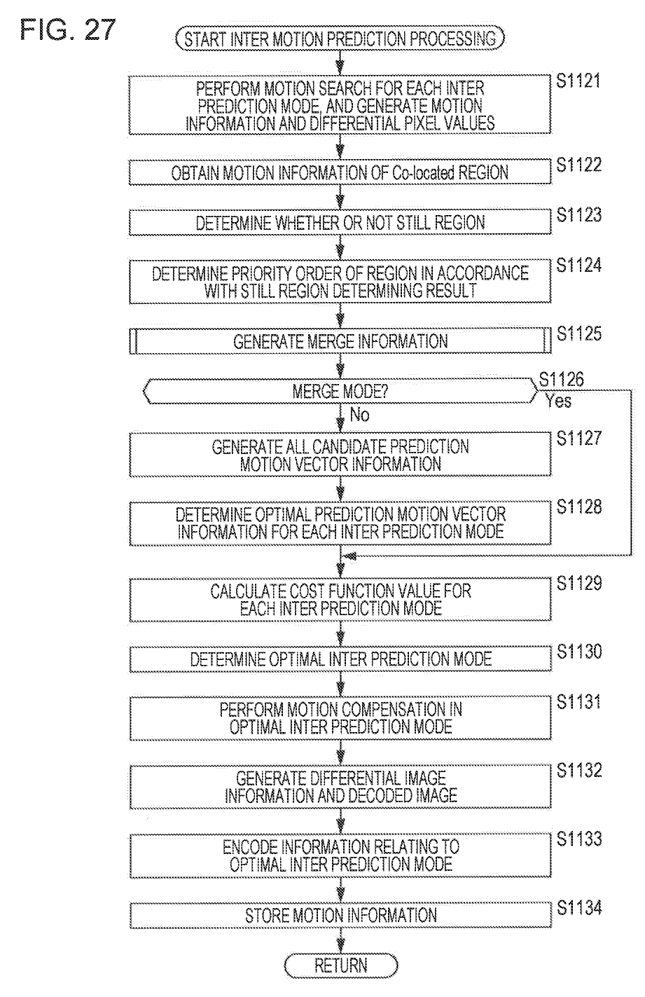

Next, an example of the flow of inter motion prediction processing performed in step S1104 in FIG. 26 will be described, with reference to the flowchart in FIG. 27.

Upon inter motion prediction processing being started, in this case, in step S1121 the motion search unit 1131 performs a motion search with regard to each inter prediction mode, and generates motion information and difference pixel values.

In step S1122, the still region determining unit 1121 obtains motion information of a Co-Located region which is a temporal peripheral region, from the motion information buffer 1135. In step S1123, the still region determining unit 1121 determines whether or not the current region is a still region, based on the motion information of the Co-Located region.

In step S1124, the priority order control unit 1141 decides the priority order of the peripheral regions with which to compare the motion information with the current region in merge mode, in accordance with the still region determination results.

In step S1125, the merge information generating unit 1142 compares the peripheral motion information with the motion information of the current region, following the priority order decided in step S1124, and generates merge information regarding the current region. In step S1126, the merge information generating unit 1142 determines whether or not merge mode has been employed in the current region by the processing in step S1125. In the event that determination is made that the motion information of the current region does not match the peripheral motion information and merge mode was not employed, the merge information generating unit 1142 advances the processing to step S1127.

In step S1127, the prediction motion vector generating unit 1143 generates all candidate prediction motion vector information.

In step S1128, the difference motion vector generating unit 1144 decides an optimal prediction motion vector information as to each inter prediction mode. Also, difference motion information including a difference motion vector, which is the difference between that prediction motion vector information and the motion vector of the motion vector information, is generated.

Upon the processing of step S1128 ending, the difference motion vector generating unit 1144 advances the processing to step S1129. Also, in step S1126, in the event that determination is made that the merge mode has been employed, the merge information generating unit 1142 advances the processing to step S1129.

in step S1129, the cost function calculating unit 1132 calculates the cost function value for inter prediction mode.

In step S1130, the mode determining unit 1133 decides an optimal inter prediction mode (Also called optimal prediction mode) which is the inter prediction mode that is optimal, using the cost function values calculated in step S1129.

In step S1131, the motion compensating unit 1134 performs motion compensation in the optimal inter prediction mode. In step S1132, the motion compensating unit 1134 supplies the prediction image obtained by the motion compensation in step S1130 to the computing unit 1103 and computing unit 1110 via the prediction image selecting unit 1116, and generates difference image information and a decoded image. Also, in step S1133, the motion compensating unit 1134 supplies information relating to the optimal inter prediction mode, such as the optimal prediction mode information, merge information, difference motion information, and code number of prediction motion vector information and so forth, to the lossless encoding unit 1106, so as to be encoded.

In step S1134, the motion information buffer 1135 stores the motion information selected regarding the optimal inter prediction mode. Upon storing the motion information, the motion information buffer 1135 ends the inter motion prediction processing.

[Flow of Merge Information Generating Processing]

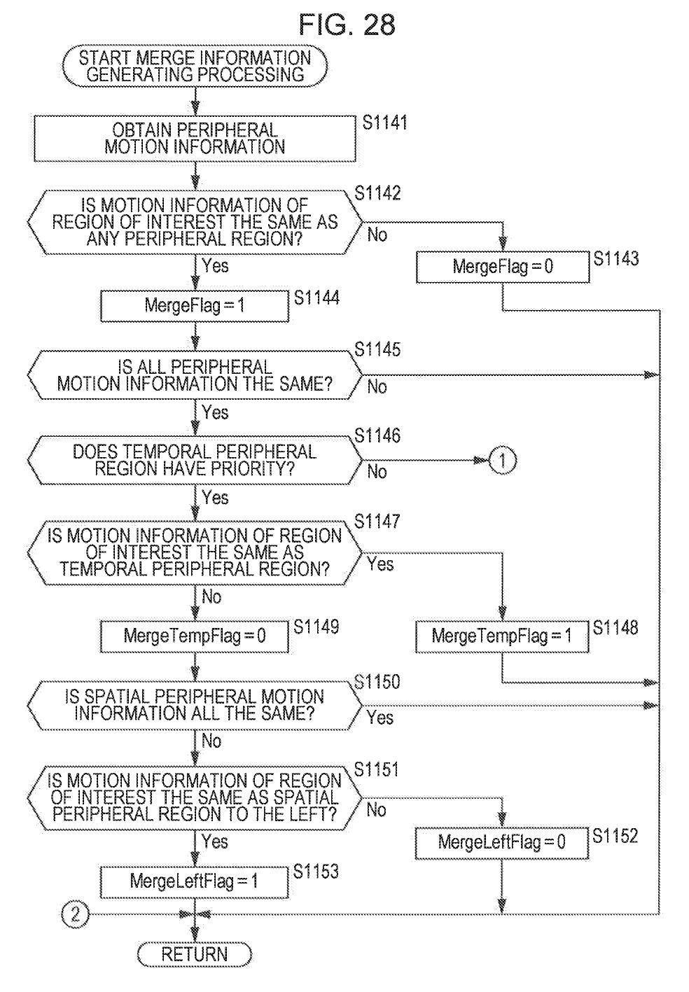

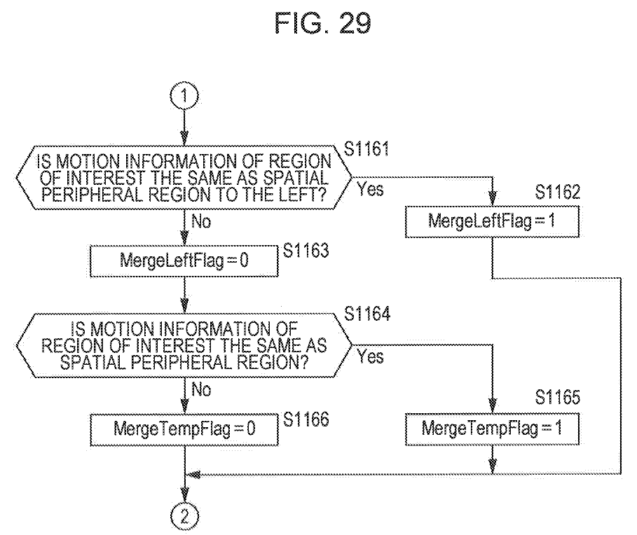

Next, an example of the flow of merge information generating processing executed in step S1125 of FIG. 27 will be described with reference to the flowchart in FIG. 28 and FIG. 29.

Upon the merge information generating processing being started, in step S1141, the merge information generating unit 1142 obtains motion information of candidate peripheral regions for merging with the current region from the motion information buffer 1135.

In step S1142, the merge information generating unit 1142 compares the motion information of the region of interest to be processed (current region) with each peripheral motion information obtained in step S1141, and determines whether the motion vector of the region of interest is the same as the motion vector of any of the peripheral regions.

In the event that determination is made that the motion vector of the current region is not the same as the motion vector of any of the peripheral regions, the merge information generating unit 1142 advances the processing to step S1143, and sets MergeFlag to 0 (MergeFlag=0) In this case, merge mode is not selected. The merge information generating unit 1142 ends the merge information generating processing, and returns the processing to FIG. 27.

Also, in the event that determination is made in step S1142 that the motion vector of the current region is the same as the motion vector of any one of the peripheral regions, the merge information generating unit 1142 advances the processing to step S1144, and sets the MergeFlag to 1 (MergeFlag=0). In this case, merge mode is selected. The merge information generating unit 1142 advances the processing to step S1145.

In step S1145, the merge information generating unit 1145 determines whether or not the peripheral motion information obtained in step S1141 is all the same. In the event that determination is made that this is all the same, the current region can be merged with any candidate, so the merge information generating unit 1145 sets MergeFlag alone as merge information, ends the merge information generating processing, and returns the processing to FIG. 27.

Also, in the event that determination is made in step S1145 that the peripheral motion information obtained in step 1141 are not all the same, the merge information generating unit 1145 advances the processing to step S1146.

In step S1146, the merge information generating unit 1145 determines whether or not the temporal peripheral region (also called temporal peripheral region) is given priority over spatial peripheral regions (also called (spatial peripheral regions) following the priority order determined in step S1124 in FIG. 27 based on the still region determination results of the current region. In the event that determination is made that this is given priority, the merge information generating unit 1145 advances the processing to step S1147, and performs comparison from the motion information of the temporal peripheral region.

In step S1147, the merge information generating unit 1145 determines whether or not the motion information of the region of interest is the same as the motion information of the temporal peripheral region, and in the event that determination is made that these are the same, the processing is advanced to step S1148, and the MergeTempFlag is set to 1 (MergeTempFlag=1). In this case, comparison with the motion information of the spatial peripheral regions is unnecessary, so the merge information generating unit 1145 sets MergeFlag and MergeTempFlag as merge information, ends the merge information generating processing, and returns the processing to FIG. 27.

On the other hand, in the event that determination is made in step S1147 that these are not the same, the merge information generating unit 1145 advances the processing to step S1149, sets the MergeTempFlag to 0, and advances the processing to step S1150 (MergeTempFlag=0).

In step S1150, the merge information generating unit 1145 determines whether or not the motion information of the spatial peripheral regions is all the same. In the event that determination is made that this is all the same, the motion of any spatial peripheral region may be used, so the merge information generating unit 1145 sets MergeFlag and MergeTempFlag as merge information, ends the merge information generating processing, and returns the processing to FIG. 27.

Also, in the event that determination is made in step S1150 that the motion information of the spatial peripheral regions is not all the same, the merge information generating unit 1145 advances the processing to step S1151.

In step S1151, the merge information generating unit 1145 determines whether or not the motion information of the region of interest is the same as motion information of the spatial peripheral region to the left (the peripheral region neighboring the current region at the left thereof). In the event that determination is made that this is not the same, the merge information generating unit 1145 advances the processing to step S1152, and sets MergeLeftFlag to 0 (MergeLeftFlag=0).

On the other hand, in the event that determination is made in step S1151 that the motion information of the region of interest is the same as motion information of the spatial peripheral region to the left, the merge information generating unit 1145 advances the processing to step S1153, and sets the MergeLeftFlag to 1 (MergeLeftFlag=1).

Upon the processing of step S1152 or step S1153 ending, the merge information generating unit 1145 sets MergeFlag, MergeTempFlag, and MergeLeftFlag as merge information, ends the merge information generating processing, and returns the processing to FIG. 27.

Also, in the event that determination is made in step S1146 that the spatial peripheral region is given priority, the merge information generating unit 1145 advances the processing to step S1161 in FIG. 29.

In this case, the motion information of the spatial peripheral regions is compared with the current region before the motion information of the temporal peripheral region is.

That is to say, in step S1161 in FIG. 29, the merge information generating unit 1145 determines whether or not the motion information of the region of interest is the same as motion information of the spatial peripheral region to the left (the peripheral region neighboring the current region at the left thereof). If determined to be the same, the merge information generating unit 1145 advances the processing to step S1162, and sets the MergeLeftFlag to 1 (MergeLeftFlag=1). In this case, comparison with the motion information of the temporal peripheral region is unnecessary, so the merge information generating unit 1145 sets MergeFlag and MergeLeftFlag as merge information, ends the merge information generating processing, and returns the processing to FIG. 27.

Also, in step S1161, in the event that determination is made that these are not the same, the merge information generating unit 1145 advances the processing to step S1163, sets the MergeLeftFlag to 0, and advances the processing to step S1164 (MergeLeftFlag=0).

In step S1164, the merge information generating unit 1145 determines whether or not the motion information of the region of interest is the same as the motion information of the temporal peripheral region. In the event that determination is made that these are the same, the processing is advanced to step S1165, and the MergeTempFlag is set to 1 (MergeTempFlag=1).

Also, in the event that determination is made in step S1164 that these are not the same, the merge information generating unit 1145 advances the processing to step S1166, and sets the MergeTempFlag to 0 (MergeTempFlag=0).

Upon the processing of step S1165 or step S1166 ending, the merge information generating unit 1145 sets MergeFlag, MergeTempFlag, and MergeLeftFlag as merge information, ends the merge information generating processing, and returns the processing to FIG. 27.

Thus, by performing each processing, the image encoding device 1100 can suppress increase in the code amount of merge information, and can improve encoding efficiency.

### 7. CONFIGURATION EXAMPLE OF IMAGE DECODING DEVICE ACCORDING TO ANOTHER EMBODIMENT

[Image Decoding Device]

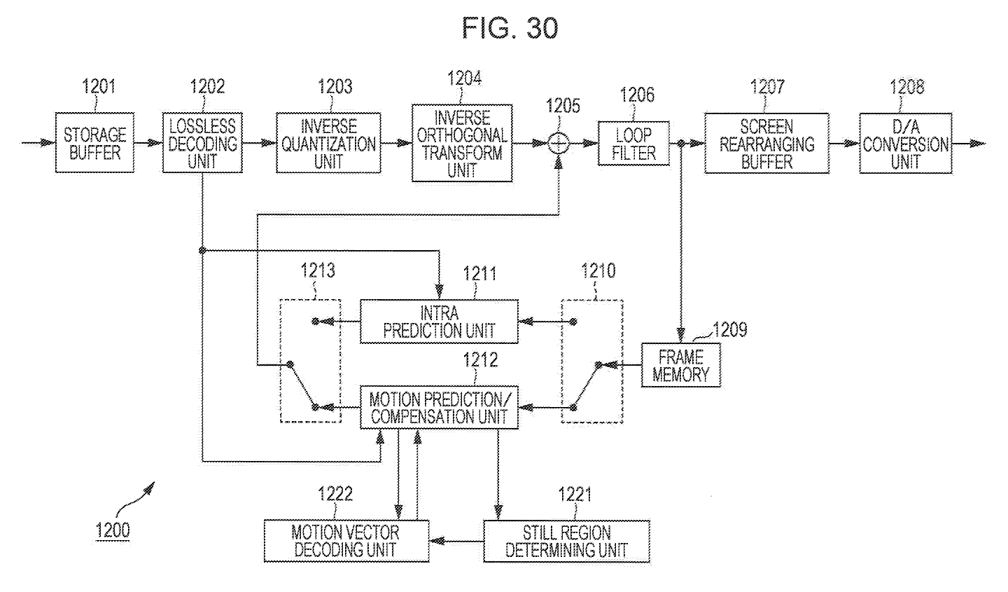

FIG. 30 is a block diagram illustrating a primary configuration example of an image decoding device corresponding to the image encoding device 1100 in FIG. 23.

The image decoding device 1200 illustrated in FIG. 30 decodes encoded data generated by the image encoding device 1100 with a decoding method corresponding to the encoding method thereof. Note that, in the same way as with the image encoding device 1100, the image decoding device 1200 performs inter prediction for each prediction unit (PU).

AS illustrated in FIG. 30, the image decoding device 1200 includes a storage buffer 1201, a lossless decoding unit 1202, an inverse quantization unit 1203, an inverse orthogonal transform unit 1204, a computing unit 1205, a loop filter 1206, a screen rearranging buffer 1207, and a D/A conversion unit 1208. The image decoding device 1200 also includes frame memory 1209, a selecting unit 1210, an intra prediction unit 1211, a motion prediction/compensation unit 1212, and a selecting unit 1213.

Further, the image decoding device 1200 includes a still region determining unit 1221 and a motion vector decoding unit 1222.

The storage buffer 1201 stores encoded data transmitted thereto, and supplies the encoded data to the lossless decoding unit 1202 at a predetermined timing. The lossless decoding unit 1202 decodes the information supplied from the storage buffer 1201 that has been encoded by the lossless encoding unit 1106 in FIG. 23 with a format corresponding to the encoding format of the lossless encoding unit 1106. The lossless decoding unit 1202 supplies the quantized coefficient data of the difference image obtained by decoding, to the inverse quantization unit 1203.

Also, the lossless decoding unit 1202 determines whether or not the intra prediction mode has been selected as the optimal prediction mode or the inter prediction mode has been selected, and supplies the information relating to the optimal prediction mode to, of the intra prediction unit 1211 and motion prediction/compensation unit 1212, the one of the mode regarding which determination of selection has been made. That is to say, in the event that the inter prediction mode has been selected at the image encoding device 1100 as the optimal prediction mode, information relating to that optimal prediction mode is supplied to the motion prediction/compensation unit 1212.

The inverse quantization unit 1203 performs inverse quantization of the quantized coefficient data obtained by decoding at the lossless decoding unit 1202, with a format corresponding to the quantization format of the quantization unit 1105 in FIG. 23, and supplies the obtained coefficient data to the inverse orthogonal transform unit 1204.

The inverse orthogonal transform unit 1204 performs inverse orthogonal transform of the coefficient data supplied from the inverse quantization-unit 1203, with a format corresponding to the orthogonal transform format of the orthogonal transform unit 1104 in FIG. 23. The inverse orthogonal transform unit 1204 obtains, by this inverse orthogonal transform processing, decoding residual data corresponding to the residual data before performing orthogonal transform at the image encoding device 1100.

The decoded residual data obtained by inverse orthogonal transform is supplied to the computing unit 1205. Also, the computing unit 1205 is supplied with a prediction image from the intra prediction unit 1211 or the motion prediction/compensation unit 1212 via the selecting unit 1213.

The computing unit 1205 adds the decoded residual data and the prediction image, and obtains decoded image data corresponding to the image data prior to the prediction image being subtracted therefrom by the computing unit 1103 of the image encoding device 1100. The computing unit 1205 supplies the decoded image data to the loop filter 1206.

The loop filter 1206 appropriately subjects the supplied decoded image to loop filter processing including deblocking processing and adaptive loop filer processing and so forth, and supplies this to the screen rearranging buffer 1207.

The loop filter 1206 includes a deblocking filter, adaptive loop filter, or the like, and performs filer processing on the decoded image supplied from the computing unit 1205 as appropriate. For example, the loop filter 1206 performs removes block noise in the decoded image by performing deblocking filter processing on the decoded image. Also, for example, the loop filter 1206 performs image quality improvement by performing loop filter processing on the deblocking filter processing results (decoded image regarding which removal of block noise has been performed) using a Wiener filter (Wiener Filter).

Note that the loop filter 1206 may perform optional filtering processing as to the decoded image. Also, the loop filter 1206 may perform filtering processing using filter coefficients supplied from the image encoding device 1100 in FIG. 23.

The loop filter 1206 supplies the filtering processing results (decoded image after filtering processing) to the screen rearranging buffer 1207 and frame memory 1209. Note that as described above, the decoded image output from the computing unit 1205 may be supplied to the screen rearranging buffer 1207 or frame memory 1209 without going through the loop filter 1206. That is to say, the filtering processing by the loop filter 1206 may be omitted.

The screen rearranging buffer 1207 performs image rearranging. That is to say, the order of frames rearranged in order for encoding by the screen rearranging buffer 1102 in FIG. 23 is rearranged in the original order for display. The D/A conversion unit 1208 performs D/A conversion of the images supplied from the screen rearranging buffer 1207, outputs to an unshown display, and displays.

The frame memory 1209 stores the decoded image supplied thereto, and supplies the stored decoded image to the selecting unit 1210 as a reference image, at a predetermined timing, or based on an external request such as the intra prediction unit 1211 or motion prediction/compensation unit 1212 or the like.

The selecting unit 1210 selects the supply destination of the reference image supplied from the frame memory 1209. In the event of decoding an intra encoded image, the selecting unit 1210 supplies the reference image supplied from the frame memory 1209 to the intra prediction unit 1211. Also, in the event of decoding an inter encoded image, the selecting unit 1210 supplies the reference image supplied from the frame memory 1209 to the motion prediction/compensation unit 1212.

The intra prediction unit 1211 is supplied with information indicating the intra prediction mode obtained by decoding the header information, from the lossless decoding unit 1202, as appropriate. The intra prediction unit 1211 performs intra prediction using the reference image obtained from the frame memory 1209 in the intra prediction mode used by the intra prediction unit 1114 in FIG. 23, and generates a prediction image. The intra prediction unit 1211 supplies the generated prediction image to the selecting unit 1213.

The motion prediction/compensation unit 1212 obtains information obtained by decoding the header information (optimal prediction mode information, difference information, and code number of motion prediction vector information and so forth) from the lossless decoding unit 1202.

The motion prediction/compensation unit 1212 performs inter prediction using the reference image obtained from the frame memory 1209 in the inter prediction mode used by the motion prediction/compensation unit 1115 in FIG. 23, and generates a prediction image.

The still region determining unit 1221 basically performs the same processing as that of the still region determining unit 1121, and determines whether or not the current region is a still region. In a case where the above-described Expression (8) and Expression (9) hold and also Expression (10) holds, from the motion information of the Co-Located region of the current region, a case where Ref_PicR_reordering is applied, or a case where the reference index Refcol has a POC value indicating a picture immediately before, the still region determining unit 1121 determines the current region PUcurr to be a still region.

The still region determining unit 1221 performs such still region determination in increments of prediction processing, and supplies the still region determination results to the motion vector decoding unit 1222.

The motion vector decoding unit 1222 determines the priority order of peripheral regions to merge with the current region, based on determination results of whether or not a still region, supplied from the still region determining unit 1221. Also, the motion vector decoding unit 1222 decodes each flag information included in the merge information supplied from the image encoding device 1100 in that order. That is to say, the motion vector decoding unit 1222 determines whether or not, at the time of encoding, the merge mode has been selected for prediction of the current region, and in the event that merge mode has been selected, determines which peripheral region has been merged, and so forth.

Following the determination results, the motion vector decoding unit 1222 merges the peripheral region with the current region, and supplies information specifying that peripheral region to the motion prediction/compensation unit 1212. The motion prediction/compensation unit 1212 reconstructs the motion information of the current region using the motion information of the specified peripheral region.

Also, in the event that determination has been made that merge mode has not been selected, the motion vector decoding unit 1222 reconstructs the prediction motion vector information. The motion vector decoding unit 1222 supplies the reconstructed prediction motion vector information to the motion prediction/compensation unit 1212. The motion prediction/compensation unit 1212 uses the prediction motion vector information supplied thereto to reconstruct the motion information of the current region.

In this way, by controlling the priority of peripheral regions in merge mode based on the determination results of still region determination by the still region determining unit 1221, for each prediction processing increment, the motion vector decoding unit 1222 can correctly restore control of priority of the peripheral regions in merge mode performed at the image encoding device 1100. Accordingly, the motion vector decoding unit 1222 can correctly decode the merge information supplied from the image encoding device 1100, and can correctly reconstruct the motion vector information of the current region.

Accordingly, the image decoding device 1200 can correctly decode the encoded data which the image encoding device 1100 has encoded, and can realized improved encoding efficiency.

[Motion Prediction/Compensation Unit, Still Region Determining Unit, Motion Vector Decoding Unit]

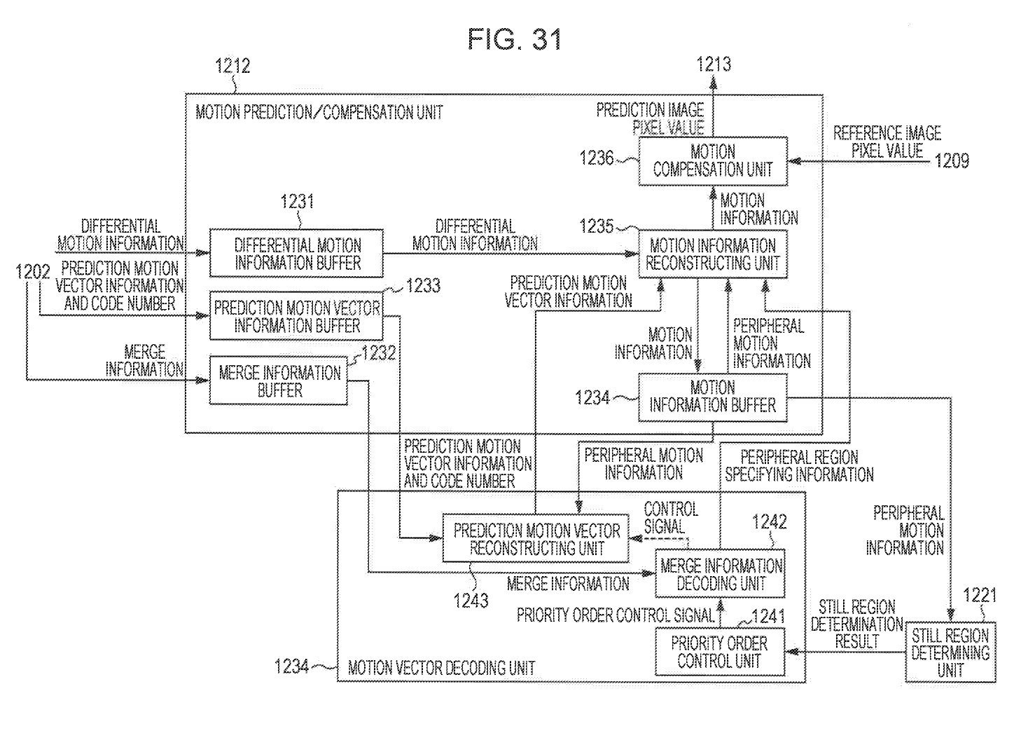

FIG. 31 is a block diagram illustrating a primary configuration example of the motion prediction/compensation unit 1212, still region determining unit 1221, and motion vector decoding unit 1222.

As illustrated in FIG. 31, the motion prediction/compensation unit 1212 includes a difference motion information buffer 1231, a merge information buffer 1232, a prediction motion vector information buffer 1233, motion information buffer 1234, a motion information reconstructing unit 1235, and a motion compensation unit 1236.

Also, the motion vector decoding unit 1222 includes a priority order control unit 1241, a merge information decoding unit 1242, and a prediction motion vector reconstructing unit 1243.

The difference motion information buffer 1231 stores difference motion information supplied from the lossless decoding unit 1202. This difference motion information is difference motion information in the inter prediction mode selected as the optimal prediction mode, supplied from the image encoding device 1100. The difference motion information buffer 1231 supplies the stored difference motion information to the motion information reconstructing unit 1235, either at a predetermined timing, or based on a request from the motion information reconstructing unit 1235.

The merge information buffer 1232 stores merge information supplied from the lossless decoding unit 1202. This merge information is merge information in the inter prediction mode selected as the optimal prediction mode, supplied from the image encoding device 1100. The merge information buffer 1232 supplies the stored merge information to the merge information decoding unit 1242 of the motion vector decoding unit 1222, at a predetermined timing, or based on a request from the merge information decoding unit 1242.

The prediction motion vector information buffer 1.233 stores the code number of the prediction motion vector information supplied from the lossless decoding unit 1202. This code number of the prediction motion vector information is supplied from the image encoding device 1100, and is a code number assigned to prediction motion vector information of the inter prediction mode selected as the optimal prediction mode. The prediction motion vector information buffer 1233 supplies the stored code number of the prediction motion vector information to the prediction motion vector reconstructing unit 1243 of the motion vector decoding unit 1222, at a predetermined timing, or based on a request from the prediction motion vector reconstructing unit 1243.

Also, the still region determining unit 1221 obtains motion information of the Co-Located region from the motion information buffer 1234 as peripheral motion information, for each region of the prediction processing increment, and performs still region determination. The still region determining unit 1221 supplies the determination results thereof (still region determination results) to the priority order control unit 1241 of the motion vector decoding unit 1222.

The priority order control unit 1241 of the motion vector decoding unit 1222 controls the priority order (priority) of the peripheral region of which motion information is used in merge mode, for each region of the prediction processing increment, following the still region determination results supplied from the still region determining unit 1221, and supplies priority order control signals to the merge information decoding unit 1242.

The merge information decoding unit 1242 obtains merge information supplied from the image encoding device 1100, from the merge information buffer 1232. The merge information decoding unit 1242 decodes the values of the flags such as MergeFlag, MergeTempFlag, and MergeLeftFlag, included in the merge information, under control of the priority order control unit 1241. In the event that it is found to be the merge mode as the result of the decoding, and also the peripheral region merged to the current region is identified, the merge information decoding unit 1242 supplies peripheral region specifying information to specify the peripheral region, to the motion information reconstructing unit 1235.

Note that if found not to be in the merge mode as the result of merge information decoding, the merge information decoding unit 1242 supplies the prediction motion vector reconstructing unit 1243 with control signals instructing reconstruction of the prediction motion vector information.

Upon being instructed by the merge information decoding unit 1242 to reconstruct the prediction motion vector information (upon control signals being supplied), the prediction motion vector reconstructing unit 1243 obtains from the prediction motion vector information buffer 1233 the code number of the prediction motion vector information supplied from the image encoding device 1100, and decodes the code number.

The prediction motion vector reconstructing unit 1243 identifies the prediction motion vector information corresponding to the decoded code number, and reconstructs the prediction motion vector information. That is to say, the prediction motion vector reconstructing unit 1243 obtains peripheral motion information of the peripheral region corresponding to the code number from the motion information buffer 1234, and takes this peripheral motion information as the prediction motion vector information. The prediction motion vector reconstructing unit 1243 supplies the reconstructed prediction motion vector information to the motion information reconstructing unit 1235 of the motion prediction/compensation unit 1212.

In the case of merge mode, the motion information reconstructing unit 1235 of the motion prediction/compensation unit 1212 obtains from the motion information buffer 1234 motion information of the peripheral region specified by the peripheral region specifying information supplied from the merge information decoding unit 1242, and takes this as motion information of the current region (reconstructs motion information).

On the other hand, if not merge mode, the motion information reconstructing unit 1235 of the motion prediction/compensation unit 1212 obtains from the difference motion information buffer 1231 the difference motion information supplied from the image encoding device 1100. The motion information reconstructing unit 1235 adds the prediction motion vector information obtained from the prediction motion vector reconstructing unit 1243 to this difference motion information, and reconstructs the motion information of the current region (current PU). The motion information reconstructing unit 1235 supplies the reconstructed motion information of the current region to the motion compensation unit 1236.

The motion compensation unit 1236 thus uses the motion information of the current region reconstructed by the motion information reconstructing unit 1235 to perform motion compensation on the reference image pixel values obtained from the frame memory 1209, and generate a prediction image. The motion compensation unit 1236 supplies the prediction image pixel values to the computing unit 1205 via the selecting unit 1213.

Also, the motion information reconstructing unit 1235 supplies the motion information of the current region that has been reconstructed to the motion information buffer 1234 as well.

The motion information buffer 1234 stores the motion information of the current region that has been supplied from the motion information reconstructing unit 1235. The motion information buffer 1234 supplies this motion information to the still region determining unit 1221 and prediction motion vector reconstructing unit 1243 as peripheral motion information, in processing as to other regions performed later time from the current region.

By each unit performing processing as described above, the image decoding device 1200 can correctly decode the encoded data which the image encoding device 1100 has encoded, and improved encoding efficiency can be realized.

### 8. FLOW OF PROCESSING WHEN DECODING ACCORDING TO ANOTHER EMBODIMENT

[Flow of Decoding Processing]

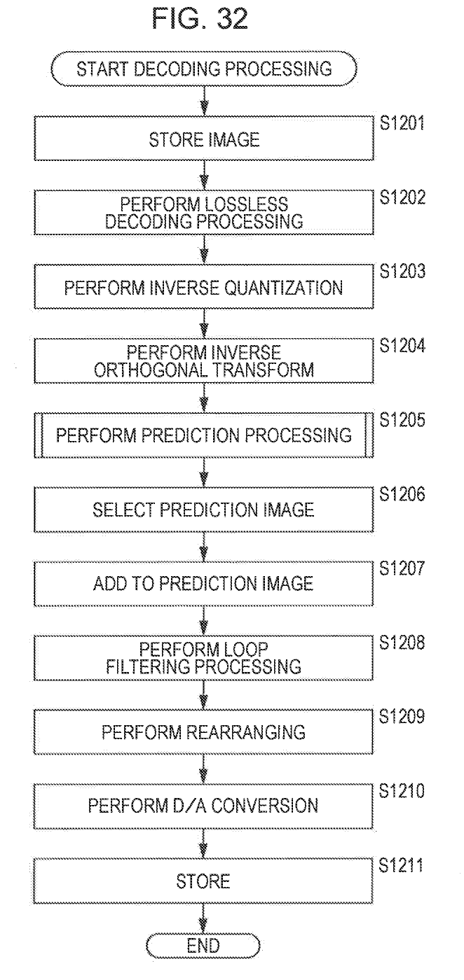

Next, the flow of each processing executed by the image decoding device 1200 such as described above, will be described. First, an example of the flow of decoding processing will be described with reference to the flowchart in FIG. 32.

Upon the decoding processing starting, in step S1201 the storage buffer 1201 stores a code stream transmitted thereto. In step S1202, the lossless decoding unit 1202 decodes the code stream (encoded difference image information) supplied from the storage buffer 1201. That is to say, the I picture, P pictures, and B pictures encoded by the lossless encoding unit 1106 in FIG. 23 are decoded.

At this time, various types of information other that the difference image information included in the code stream, such as difference motion information, code number of prediction motion vector information, and merge information and so forth, are also decoded.

In step S1203, the inverse quantization unit 1203 performs inverse quantization of the quantized orthogonal transfer coefficient obtained by the processing of step S1202. In step S1204 the inverse orthogonal transform unit 1204 performs inverse orthogonal transform of the orthogonal transfer coefficient subjected to inverse quantization in step S1203.

In step S1205, the intra prediction unit 1211 or motion prediction/compensation unit 1212 performs prediction processing using the information supplied thereto. In step S1206, the selecting unit 1213 selects a prediction image generated in step S1205. In step S1207, the computing unit 1205 adds the prediction image selected in step S1206 to the difference image information obtained by inverse orthogonal transfer in step S1204. Accordingly, the original image is decoded.

In step S1208, the loop filter 1206 subjects the decoded image obtained in step S1207 to loop filter processing including deblocking filter processing and adaptive loop filer processing and so forth, as appropriate.

In step S1209, the screen rearranging buffer 1207 performs rearranging of the images subjected to filter processing in step S1208. That is to say, the order of frames rearranged for encoding by the screen rearranging buffer 1102 of the image encoding device 1100 is rearranged in the original display order.

In step S1210, the D/A conversion unit 1208 performs D/A conversion of the images of which the frame order has been rearranged in step S1209. The images are output to an unshown display, and the images are displayed.

In step S1211, the frame memory 1209 stores the images subjected to filter processing in step S1208.

Upon the processing of step S1211 ending, the decoding processing ends.

[Flow of Prediction Processing]

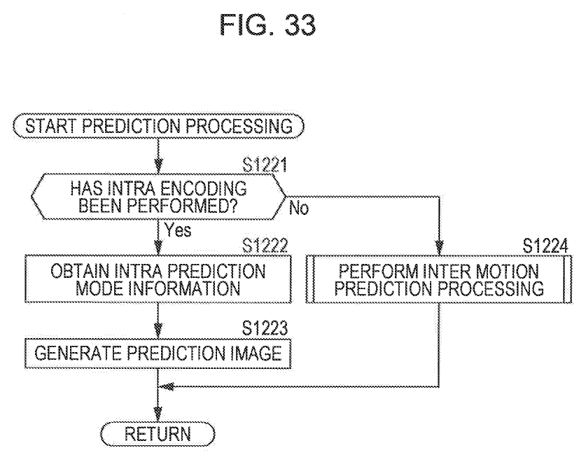

Next, an example of the flow of prediction processing executed in step S1205 in FIG. 32 will be described with reference to the flowchart in FIG. 33.

Upon prediction processing being started, in step S1221 the lossless decoding unit 1202 determines whether or not the encoded data to be processed has been intra encoded, based on the information relating to the optimal prediction mode supplied from the image encoding device 1100. In the event that determination is made that intra encoded, the lossless decoding unit 1202 advances the processing to step S1222.

In step S1222, the intra prediction unit 1211 obtains intra prediction mode information. In step S1223, the intra prediction unit 1211 performs intra prediction using intra prediction mode information obtained in step S1222, and generates a prediction image. Upon generating a prediction image, the intra prediction unit 1211 ends the prediction processing and returns the processing to FIG. 32.

Also, in the event that determination is made in step S1221 that inter encoded, the lossless decoding unit 1202 advances the processing to step S1224.

In step S1224, the motion prediction/compensation unit 1212 performs inter motion prediction processing. Upon the inter motion prediction processing ending, the motion prediction/compensation unit 1212 ends prediction processing, and returns the processing to FIG. 32.

[Flow of Inter Motion Prediction Processing]

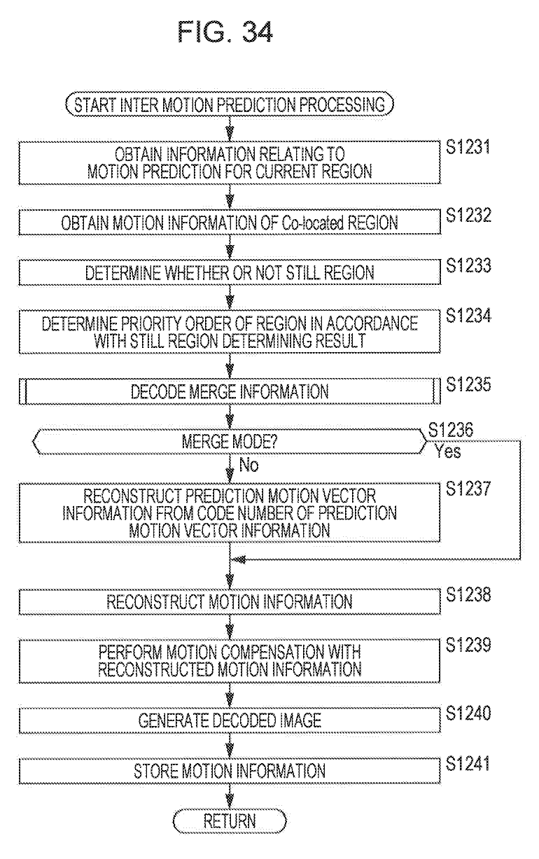

Next, an example of the flow of inter motion prediction processing executed in step S1224 in FIG. 33 will be described with reference to the flowchart in FIG. 34.

Upon the inter motion prediction processing being started, in step S1231 the motion prediction/compensation unit 1212 obtains information relating to motion prediction for the current region. For example, the prediction motion vector information buffer 1233 obtains the code number of the prediction motion vector information, the difference motion information buffer 1231 obtains difference information, and the merge information buffer 1232 obtains merge information.

In step S1232, the still region determining unit 1221 obtains motion information of the Co-Located region from the motion information buffer 1234. In step S1233, based on that information, the still region determining unit 1221 determines whether or not the current region is a still region, as described above.

In step S1234, the priority order control unit 1241 decides the priority of peripheral regions of which to use motion vectors in the merge information, in accordance with the still region determination results of step S1233. In step S1235, the merge information decoding unit 1242, merge information is decoded following the priority order decided in step S1234. That is to say, the merge information decoding unit 1242 decodes the value of the flags included in the merge information following the priority order decided in step S1234, which will be described later.

In step S1236, the merge information decoding unit 1242 determines whether or not merge mode has been applied for prediction of the current region at the time of encoding, as the result of the decoding (decoding) in step S1235.

In the event that determination has been made that merge mode has not been employed for prediction of the current region, the merge information decoding unit 1242 advances the processing to step S1237. In step S1237, the prediction motion vector reconstructing unit 1243 reconstructs the prediction motion vector information from the code number of the prediction motion vector information obtained in step S1231. Upon reconstructing the prediction motion vector information, the prediction motion vector reconstructing unit 1243 advances the processing to step S1238.

Also, in the event that determination is made in step 31236 that merge mode has been applied to prediction of the current region, the merge information decoding unit 1242 advances the processing to step S1238.

In step S1238, the motion information reconstructing unit 1235 reconstructs the motion information of the current region, using the decoding results of the merge information in step S1235, or the prediction motion vector information reconstructed in step S1237.

In step S1239, the motion compensation unit 1236 performs motion compensation using the motion information reconstructed in step S1238, and generates a prediction image.

In step S1240, the motion compensation unit 1236 supplies the prediction image generated in step S1239 to the computing unit 1205 via the selecting unit 1213, so as to generate a decoded image.

In step S1241, the motion information buffer 1234 stores the motion information reconstructed in step S1238.

Upon the processing of step S1241 ending, the inter motion prediction processing ends, and the processing is returned to FIG. 33.

[Flow of Merge information Decoding Processing]

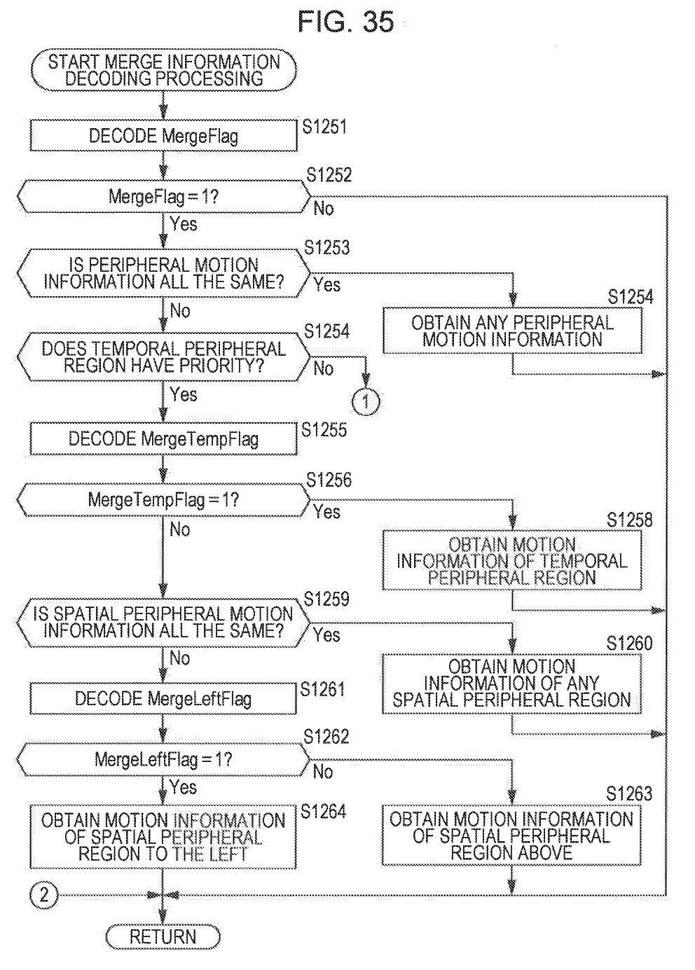

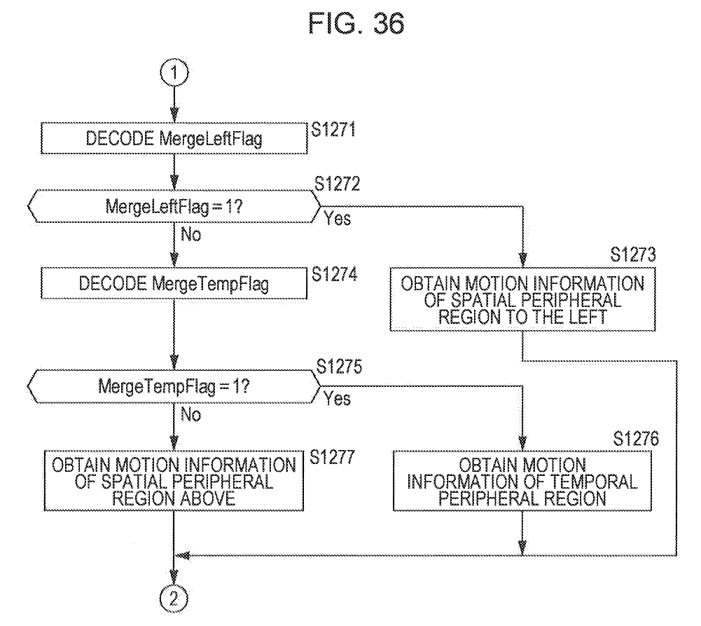

An example of the flow of merge information decoding processing executed in step S1235 in FIG. 34 will be described with reference to the flowchart in FIG. 35 and FIG. 36.

Upon the merge information decoding processing starting, in step S1251 the merge information decoding unit 1242 takes the first flag included in the merge information as MergeFlag, and decodes it. Then, in step S1252, the merge information decoding unit 1242 determines whether or not the value of the MergeFlag is “1”.

In step S1252, in the event that determination is made that the value of MergeFlag is “0”, merge mode has not been applied to prediction of the current region at the time of encoding, so the merge information decoding unit 1242 ends the merge information decoding processing, and returns the processing to FIG. 34.

Also, in the event that the value of MergeFlag is determined to be “1” in step S1252, this means that merge mode has been applied to prediction of the current region at the time of encoding, so the merge information decoding unit 1242 advances the processing to step S1253.

In step S1253, the merge information decoding unit 1242 determines whether or not all peripheral motion information is the same, by whether or not another flag is included in the merge information. In the event that there is included neither MergeTempFlag nor MergeLeftFlag in the merge information, the peripheral motion information is all the same. Accordingly, in this case, the merge information decoding unit 1242 advances the processing to step S1254. In step S1254, the merge information decoding unit 1242 specifies any one of the peripheral regions. The motion information reconstructing unit 1235 follows that instruction and obtains any one peripheral motion information from the motion information buffer 1234. Upon the peripheral motion information being obtained, the merge information decoding unit 1242 ends the merge information decoding processing and returns the flow to FIG. 34.

Also, in the event that determination is made in step S1253 that MergeTempFlag and MergeLeftFlag are included in the merge information, and the peripheral motion information is not all the same, the merge information decoding unit 1242 advances the processing to step S1255.

In step S1255, the merge information decoding unit 1242 determines whether or not the temporal peripheral region is given priority over the spatial peripheral regions, based on the still region determination results. In the event that determination is made that the temporal peripheral region is to be given priority, the merge information decoding unit 1242 advances the processing to step S1256. In this case, the flag following MergeFlag included in the merge information is interpreted as being MergeTempFlag.

In step S1256, the merge information decoding unit 1242 decodes the next flag included in the merge information as MergeTempFlag. In step S1257, the merge information decoding unit 1242 then determines whether or not the value of that MergeTempFlag is “1”.

In step S1257, in the event that the value of MergeTempFlag has been determined as being “1”, this means that the temporal peripheral region has been merged, so the merge information decoding unit 1242 advances the processing to step S1258. In step S1258, the merge information decoding unit 1242 specifies that temporal peripheral region. The motion information reconstructing unit 1235 follows that description to obtain motion information of the temporal peripheral region (also called temporal periphery motion information) from the motion information buffer 1234. Upon the temporal periphery motion information being obtained, the merge information decoding unit 1242 ends the merge information decoding processing, and returns the processing to FIG. 34.

Also, in the event that the value of MergeTempFlag is “0” in step S1257, and determination is made that the temporal peripheral region is not merged, the merge information decoding unit 1242 advances the processing to step S1259.

In step S1259, the merge information decoding unit 1242 determines whether or not the motion information of the spatial peripheral regions (also called spatial peripheral motion information) is all the same. In the event that MergeLeftFlag is not included in the merge information, the spatial peripheral motion information is all the same. In this case, the merge information decoding unit 1242 advances the processing to step S1260. In step 1260, the merge information decoding unit 1242 specifies any one spatial peripheral region. The motion information reconstructing unit 1235 follows that instruction and obtains any one spatial peripheral motion information from the motion information buffer 1234. Upon obtaining the spatial peripheral motion information, the merge information decoding unit 1242 ends the merge information decoding processing, and returns the processing to FIG. 34.

Also, in the event that determination is made in step S1259 that MergeLeftFlag is included in the merge information and that the spatial peripheral motion information is not all the same, the merge information decoding unit 1242 advances the processing to step S1261.

In step S1261, the merge information decoding unit 1242 decodes the next flag included in the merge information as MergeLeftFlag. In step S1262, the merge information decoding unit 1242 then determines whether or not the value of that MergeLeftFlag is “1”.

In the event that determination is made in step S1262 that the value of MergeLeftFlag is “1”, this means that the spatial peripheral region neighboring the current region above (also called top spatial peripheral region) has been merged, so the merge information decoding unit 1242 advances the processing to step S1263. In step S1263, the merge information decoding unit 1242 specifies the top spatial peripheral region. The motion information reconstructing unit 1235 follows that description and obtains the motion information of the top spatial peripheral region (also called top spatial peripheral motion information) from the motion information buffer 1234. Upon the top spatial peripheral motion information being obtained, the merge information decoding unit 1242 ends the merge information decoding processing, and returns the processing to FIG. 34.

Also, in the event that determination is made in step S1252 that the value of the MergeLeftFlag is “0”, this means that the spatial peripheral region neighboring the current region to the left (also called left spatial peripheral region) has been merged, so the merge information decoding unit 1242 advances the processing to step S1264. In step S1264, the merge information decoding unit 1242 specifies the left spatial peripheral region. The motion information reconstructing unit 1235 follows that description and obtains the motion information of the left spatial peripheral region (also called left spatial peripheral motion information) from the motion information buffer 1234. Upon the left spatial peripheral motion information being obtained, the merge information decoding unit 1242 ends the merge information decoding processing, and returns the processing to FIG. 34.

Also, in the event that determination is made in step S1255 that the spatial peripheral region is to be given priority over the temporal peripheral region, based on the still region determination results, the merge information decoding unit 1242 advances the processing to FIG. 36. In this case, the flag following MergeFlag included in the merge information is interpreted as being MergeLeftFlag.

In step S1271 in FIG. 36, the merge information decoding unit 1242 decodes the next flag included in the merge information as MergeLeftFlag. In step S1272, the merge information decoding unit 1242 then determines whether or not the value of that MergeLeftFlag is “1”.

In the event that determination is made in step S1272 that the value of the MergeLeftFlag is “1”, this means that the left spatial peripheral region has been merged, so the merge information decoding unit 1242 advances the processing to step S1273. In step S1273, the merge information decoding unit 1242 specifies the left spatial peripheral region. The motion information reconstructing unit 1235 follows that description and obtains the left spatial peripheral motion information from the motion information buffer 1234. Upon the left spatial peripheral motion information being obtained, the merge information decoding unit 1242 ends the merge information decoding processing, and returns the processing to FIG. 34.

Also, in the event that determination is made in step S1272 that the value of MergeLeftFlag is “0”, and that the left spatial peripheral region has not been merged, the merge information decoding unit 1242 advances the processing to step S1274.

In step S1274, the merge information decoding unit 1242 decodes the next flag included in the merge information as MergeTempFlag. In step S1275, the merge information decoding unit 1242 then determines whether or not the value of that MergeTempFlag is “1”.

In step S1275, in the event that the value of MergeTempFlag has been determined as being “1”, this means that the temporal peripheral region has been merged, so the merge information decoding unit 1242 advances the processing to step S1276. In step S1276, the merge information decoding unit 1242 specifies that temporal peripheral region. The motion information reconstructing unit 1235 follows that description to obtain the temporal periphery motion information from the motion information buffer 1234. Upon the temporal periphery motion information being obtained, the merge information decoding unit 1242 ends the merge information decoding processing, and returns the processing to FIG. 34.

Also, in the event that determination is made in step S1275 that the value of MergeTempFlag is “0”, this means that the top spatial peripheral region has been merged, so the merge information decoding unit 1242 advances the processing to step S1277. In step S1277, the merge information decoding unit 1242 specifies the top spatial peripheral region. The motion information reconstructing unit 1235 follows that description and obtains the top spatial peripheral motion information from the motion information buffer 1234. Upon the top spatial peripheral motion information being obtained, the merge information decoding unit 1242 ends the merge information decoding processing, and returns the processing to FIG. 34.

By performing each processing as described above, the image decoding device 1200 can correctly decode the encoded data encoded by the image encoding device 1100, and can realize improved encoding efficiency.

Note that the present technology can be applied to image encoding devices and image decoding devices used for receiving image information (bit stream) compressed by orthogonal transform such as discrete cosine transform or the like, and motion compensation, as with MPEG, H.26x, or the like, via network media such as satellite broadcasting, cable television, the Internet, cellular phones, or the like. Also, the present technology can be applied to image encoding devices and image decoding devices used for processing on storage media such as optical discs, magnetic disks, flash memory, and so forth. Further, the present technology can be applied to motion prediction/compensation devices included in these image encoding devices and image decoding devices and so forth.

The above-described series of processing may be executed by hardware, or may be executed by software. In the event of executing the series of processing by software, a program making up the software thereof is installed in a computer. Here, examples of the computer include a computer built into dedicated hardware, a general-purpose personal computer whereby various functions can be executed by various types of programs being installed thereto, and so forth.

[Configuration Example of Personal Computer]

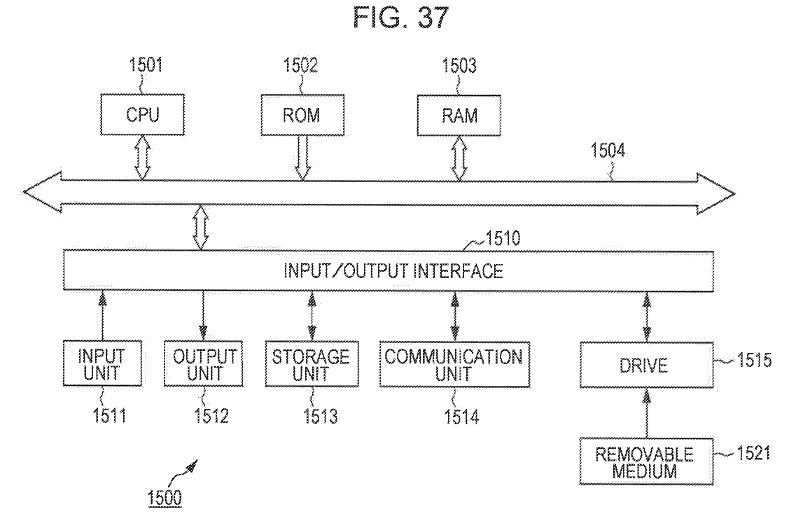

In FIG. 37, a CPU (Central Processing Unit) 1501 of a personal computer 1500 executes various processing according to a program stored in ROM (Read Only Memory) 1502 or a program loaded to RAM (Random Access Memory) 1503 from a storage unit 1513. Data used at the time of the CPU 1501 executing various processing is stored in the RAM 1503 as appropriate.

The CPU 1501, ROM 1502 and RAM 1503 are mutually connected via a bus 1504. An input/output interface 1510 is also connected to this bus 1504.

An input unit 1511 such as a keyboard, a mouse, or the like, a display made of a CRT (Cathode Ray Tube), LCD (Liquid Crystal Display), or the like, an output unit 1512 made of a speaker or the like, a storage unit 1513 configured of a hard disk or the like, and a communication unit 1514 configured of a modem or the like, are connected to the input/output interface 1510. The communication unit 1514 performs the communication processing via the network including the Internet.

A drive 1515 is also connected to the input/output interface 1510 as necessary, and removable media 1521 such as a magnetic disk, optical disc, MO disk, semiconductor memory, or the like is mounted as appropriate, and a computer program read by them is installed in the storage unit 1513 as necessary.

In the event of having the series of processing described above to be executed by software, a program making up the software is installed by network or recording medium.

For example, as shown in FIG. 37, this recording medium is configured not only of the removal media 1521 of a magnetic disk (including a flexible disk), optical disk (including CD-ROM (Compact Disc-Read Only Memory), DVD (Digital Versatile Disc)), MO disk (including MD (Mini Disc)) that the program which is distributed to deliver a program to a user is recorded, separately from the main body of the device, or the removable media 1521 made of such as semiconductor memory or the like, but also of the ROM 1502 or a hard disk included in the storage unit 1513, where a program to be delivered to a user in the state of being installed in the main body of the device beforehand, has been recorded.

Note that the program that a computer executes may be a program regarding which processing is performed in a time-sequence manner following the order described in the present description, or may be a program which regarding which processing is performed in a parallel manner, or at a suitable timing such as when a call-up has been performed or the like.

Also, with the present description, it goes without saying that the steps describing a program recorded in the recording medium includes processing performed in time-sequence manner following the described order, and also includes processing performed in parallel or individually, and is not particularly restricted to being performed processing in a time-sequence manner.

Also, in the present description, the term system represents the entirety of devices (devices) configured of multiple devices.

Also, a configuration described as one device (or processing unit) above may be divided and configured as multiple devices (or processing units). Alternately, a configuration described as multiple devices (or processing units) above may be integrated to be configured as one device (or processing unit). Also, it goes without saying that a configuration other than that described above may be added to the configuration of each device (or each processing unit). Furthermore, a part of the configuration of a certain device (or a processing unit) may be included in the configuration of other devices (or other processing units) if the configuration and operation as the overall system are substantially the same. That is to say, embodiments of the present technique are not limited to the described embodiments, and various modifications may be made without departing from the essence of the present technique.

### 9. APPLICATION EXAMPLES

The image encoding device and the image decoding device according to the embodiments described above can be applied to various electronic devices such as cable broadcasting such as satellite broadcasting, cable TV, and the like, a transmitter or a receiver in the delivery to a terminal by delivery on the Internet and cellular transmission, a recording device to record the image to the mediums such as an optical disk, a magnetic disk and the flash memory, or a playback device which plays images from these storage medium. Hereinafter, four application examples will be described.

### 9-1. First Application Example

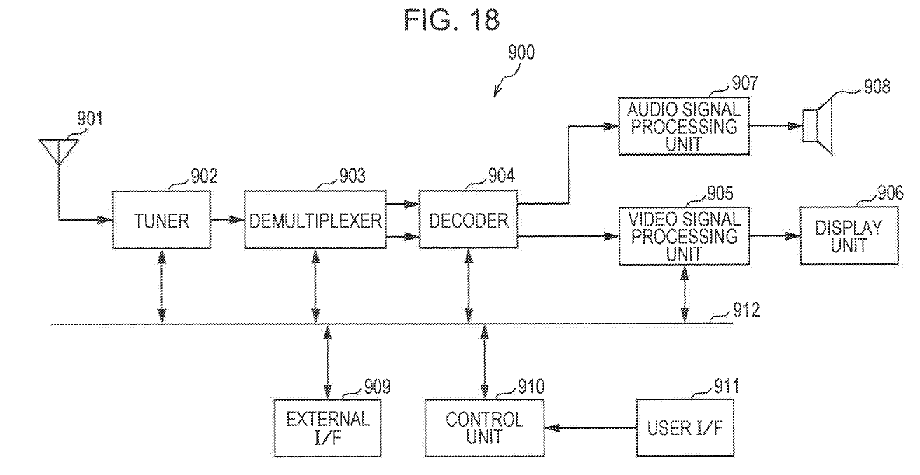

FIG. 18 shows an example of a schematic configuration of the television device to which the above-described embodiments have been applied. The television device 900 is configured of an antenna 901, a tuner 902, a demultiplexer 903, a decoder 904, a video signal processing unit 905, a display unit 906, and an audio signal processing unit 907, a speaker 908, an external interface 909, a control unit 910, a user interface 911 and a bus 912.

The tuner 902 extracts signals of a desired channel from the broadcast signal received via the antenna 901, and demodulates the extracted signals. The tuner 902 then outputs an encoded bit stream obtained by the demodulation to the demultiplexer 903. That is to say, the tuner 902 serves as a transmission unit in the television device 900 receiving the encoded stream where the image is encoded.

The demultiplexer 903 separates a video stream and an audio stream of a program to be viewed from encoded bit streams and outputs each separated stream to the decoder 904. Also, the demultiplexer 903 extracts the auxiliary data such as EPG (Electronic Program Guide) from encoded bit streams and supplies the extracted data to the control unit 910. Note that the demultiplexer 903 may perform descrambling when encoded bit streams are scrambled.

The decoder 904 decodes a video stream and an audio stream input from the demultiplexer 903. The decoder 904 then outputs the video data generated by decoding processing to the video signal processing unit 905. Also, the decoder 904 outputs the audio data generated by decoding processing to the audio signal processing unit 907.

The video signal processing unit 905 plays video data input from the decoder 904, and displays a picture on the display unit 906. Also, the video signal processing unit 905 may display an application screen supplied via a network on the display unit 906. Also, the video signal processing unit 905 may perform, for example, additional processing such as noise reduction regarding video data, according to the settings. Furthermore, for example, the video signal processing unit 905 may generate a GUI (Graphical User Interface) image such as a menu, a button or a cursor, and superimpose the generated image on the output image.

The display unit 906 is driven by driving signals supplied from the video signal processing unit 905, and displays video or an image on a picture screen of the display device (e.g., liquid crystal display, or plasma display, OLED or the like).

The audio signal processing unit 907 performs playback processing such as D/A conversion and the amplification about audio data input from the decoder 904 and makes a sound output from the speaker 908. Also, the audio signal processing unit 907 may perform additional processing such as noise reduction about audio data.

The external interface 909 is interface to connect external devices or a network to the television device 900. For example, a video stream or an audio stream received via the external interface 909 may be decoded by the decoder 904. That is, the external interface 909 also serves as the transmission unit in the television device 900, which receives the encoded stream where an image has been encoded.

The control unit 910 has processors such as a CPU (Central Processing Unit), and memory such as RAM (Random Access Memory) and ROM (Read Only Memory). The memory stores a program executed by CPU, program data, EPG data and data acquired through a network. For example, the program stored by the memory is read at the time of a start of the television device 900 by CPU, and executed. The CPU controls operation of the television device 900 according to the operating signals input from the user interface 911 for example, by executing a program.

The user interface 911 is connected to the control unit 910. For example, the user interface 911 has buttons and switches, and a receiver for a remote control signal, for a user to operate the television device 900. The user interface 911 detects the operation by the user through these components and generates an operating signal, and outputs the generated operating signal to the control unit 910.

The bus 912 mutually connects the tuner 902, demultiplexer 903, decoder 904, video signal processing unit 905, audio signal processing unit 907, external interface 909 and control unit 910.

In the television device 900 thus configured, the decoder 904 has a function of the image decoding device according to the above-described embodiments. Accordingly, when decoding images with the television device 900, merging of blocks in the temporal direction in motion compensation is enabled, and the code amount of motion information can be reduced.

### 9-2. Second Application Example

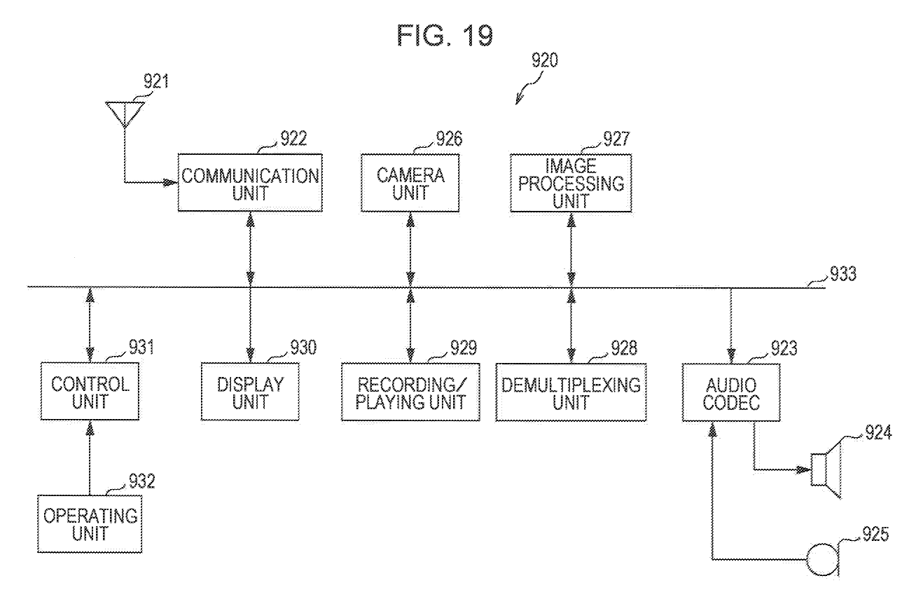

FIG. 19 illustrates an example of a schematic configuration of the cellular telephone to which the embodiment has been applied. The cellular telephone 920 is configured of an antenna 921, a communication unit 922, an audio codec 923, a speaker 924, a microphone 925, a camera unit 926, an image processing unit 927, a multiplex separating unit 928, a recording playback unit 929, a display unit 930, a control unit 931, an operating unit 932 and a bus 933.

The antenna 921 is connected to the communication unit 922. The speaker 924 and the microphone 925 are connected to the audio codec 923. The operating unit 932 is connected to the control unit 931. The bus 933 mutually connects the communication unit 922, audio codec 923, camera unit 926, image processing unit 927, multiplex separation unit 928, recording/playback unit 929, display unit 930 and control unit 931.

The cellular telephone 920 performs operation such as transmission and reception of audio signals, transmission and reception of E-mails or image data, imaging of an image and recording of data with various operation modes including a voice call mode, a data communication mode, a photography mode and a videophone mode.

In a voice call mode, the analog audio signal generated by the microphone 925 is supplied to the audio codec 923. The audio codec 923 converts the analog voice signal into audio data and subjects A/D conversion to the converted audio data and compresses. The audio codec 923 then outputs the audio data after compression to the communication unit 922. The communication unit 922 encodes and modulates the audio data, and generates transmission signals. The communication unit 922 then transmits the generated transmission signals to the base station (not shown) via the antenna 921. Also, the communication unit 922 amplifies radio signals received via the antenna 921 and performs frequency conversion and acquires reception signals. The communication unit 922 then modulates and decodes the reception signals, and generates audio data and outputs the generated audio data to the audio codec 923. The audio codec 923 decompresses the audio data and performs D/A conversion, and generates analog audio signals. The audio codec 923 supplies the generated audio signals to the speaker 924 so as to output audio.

Also, for example, in a data communication mode, the control unit 931 generates character data making up an E-mail according to the operation by the user via the operating unit 932. Also, the control unit 931 causes the display unit 930 to display text. Also, the control unit 931 generates E-mail data according to the transmission instructions from a user via the operating unit 932 and outputs the generated E-mail data to the communication unit 922. The communication unit 922 encodes and modulates the E-mail data and generates transmission signals. The communication unit 922 then transmits the generated transmission signals to a base station (not shown) via the antenna 921. Also, the communication unit 922 amplifies a radio signal received via the antenna 921 and performs frequency conversion, and acquires reception signals. The communication unit 922 then decodes and modulates the reception signals and restores the E-mail data and outputs the restored E-mail data to the control unit 931. The control unit 931 displays the contents of the E-mail on the display unit 930 and also causes the storage medium of the recording/playback unit 929 to store the E-mail data.

The recording/playback unit 929 has any storage medium that is readable/writeable. For example, the storage medium may be a built-in storage medium such as RAM or flash memory, or may be an externally mounted storage medium such as a hard disk, a magnetic disk, an MO disk, an optical disk, USE memory, or the memory card.

Also, for example, the camera unit 926 images a subject and generates image data and, outputs the generated image data to the image processing unit 927, in a shooting mode. The image processing unit 927 encodes the image data input from the camera unit 926 and stores the encodes stream in the storage medium of the recording/playback unit 929.

Also, for example, the multiplex separation unit 928 multiplexes a video stream encoded by the image processing unit 927 and an audio stream input from the audio codec 923 and, outputs a multiplexed stream to the communication unit 922 in a video phone mode. The communication unit 922 encodes and modulates the stream, and generates transmission signals. The communication unit 922 then transmits the generated transmission signal to the base station (not shown) via the antenna 921. Also, the communication unit 922 amplifies radio signals received via the antenna 921 and performs frequency conversion, and acquires reception signals. An encoded bit stream can be included in these transmission signals and reception signals. The communication unit 922 then demodulates and decodes the reception signals to restores the stream, and outputs the restored stream to the multiplex separation unit 9283. The multiplex separation unit 928 separates the video stream and audio stream from an input stream and outputs the video stream to the image processing unit 927, and outputs the audio stream to the audio codec 923. The image processing unit 927 decodes a video stream and generates video data. The video data is supplied to the display unit 930 and a series of images are displayed on the display unit 930. The audio codec 923 decompresses the audio stream and performs D/A conversion to generate analog audio signals. The audio codec 923 then supplies the generated audio signals to the speaker 924 to outputs audio.

In the cellular telephone 920 thus configured, the image processing unit 927 has a function of the image encoding device and the image decoding device according to the above-described embodiments. Accordingly, when encoding and decoding images with the cellular telephone 920, merging of blocks in the temporal direction in motion compensation is enabled, and the code amount of motion information can be reduced.

### 9-3. Third Application Example

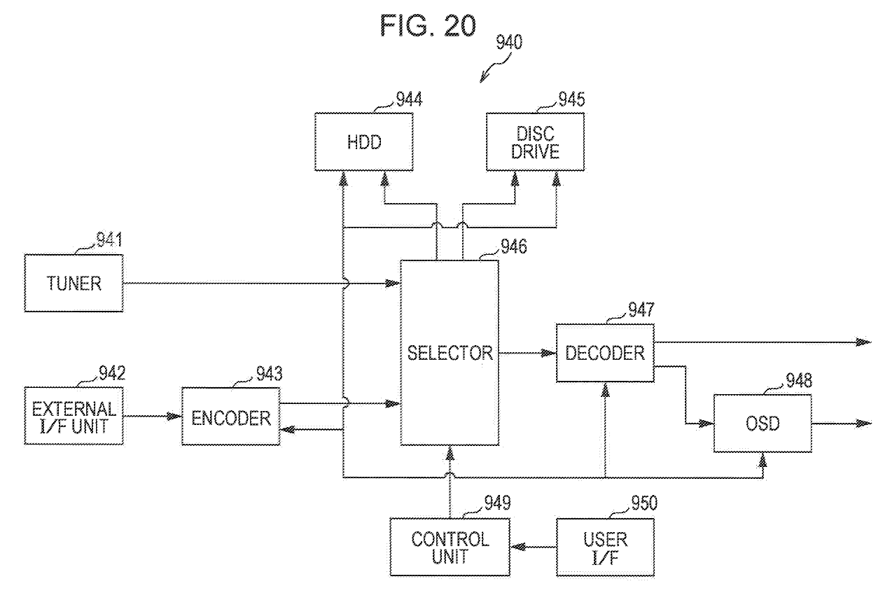

FIG. 20 illustrates an example of a schematic configuration of a recording/playback device to which the embodiment has been applied. The recording/playback device 940 may encode audio data and video data of the received broadcast program, for example, and record to the recording medium. Also, the recording/playback device 940 encodes, for example, acquired audio data and video data from other devices and may record to the recording medium. Also, for example, the recording/playback device 940 plays data recorded in a recording medium from a monitor and a speaker according to the instructions of the user. At this time, the recording/playback device 940 decodes audio data and video data.

The recording/playback device 940 includes a tuner 941, an external interface 942, an encoder 943, an HDD (Hard Disk Drive) 944, a disk drive 945, a selector 946, a decoder 947, an OSD (On-Screen Display) 948, a control unit 949 and an user interface 950.

The tuner 941 extracts the signal of a desired channel from broadcast signals received via an antenna (not shown), and demodulates an extracted signal. And the tuner 941 outputs an encoded bit stream obtained by the demodulation to the selector 946. That is, the tuner 941 serves as the transmission unit in the recording/playback device 940.

The external interface 942 is interface to connect an external device or a network to the recording/playback device 940. For example, the external interface 942 may be an IEEE1394 interface, network interface, USB interface or flash memory interface. For example, the video data and the audio data received via the external interface 942 are input into the encoder 943. That is, the external interface 942 serves as the transmission unit in the recording/playback device 940.

When the video data and audio data input from the external interface 942 are not encoded, the encoder 943 encodes the video data and audio data. The encoder 943 then outputs an encoded bit stream to the selector 946.

The HDD 944 records the encoded bit stream in which the content data such as video and audio have been compressed, various programs and other data in an internal hard disk. Also, the HDD 944 reads these data at the time of the playback of video and audio from the hard disk.

The disk drive 945 performs recording and reading of the data to the mounted recording medium. For example, the recording medium mounted on the disk drive 945 may be DVD disc (DVD-Video, DVD-RAM, DVD-R, DVD-RW, DVD+R, DVD+RW or the like) or Blu-ray (registered trademark) disc or the like.

The selector 946 selects an encoded bit stream input from the tuner 941 or the encoder 943 at the time of the recording of video and audio, and outputs the selected encoded bit stream to the HDD 944 or the disk drive 945. Also, the selector 946 outputs the encoded bit stream input from the HDD 944 or the disk drive 945 to the decoder 947 at the time of the playback of the video and the audio.

The decoder 947 decodes the encoded bit stream and generates video data and audio data. The decoder 947 then outputs the generated video data to the OSD 948. Also, the decoder 904 outputs the generated audio data to an outside speaker.

The OSD 948 plays the video data input from the decoder 947, and displays video. Also, the OSD 948 may superimpose, for example, an image of GUI such as a menu, a button or a cursor in video to display.

The control unit 949 has the processors such as CPU and memory such as RAM and ROM. The memory stores a program and program data executed by CPU. For example, the program stored by memory is read at the time of start of the recording/playback device 940 by the CPU, and executed. The CPU controls operation of the recording/playback device 940 according to the operating signals input from user interface 950 for example, by executing a program.

The user interface 950 is connected to the control unit 949. For example, the user interface 950 has the receivers of a button and a switch, and a remote control signal for a user to operate the recording/playback device 940. The user interface 950 detects the operation by the user via these components and generates operating signals, and outputs the generated operating signal to the control unit 949.

In the recording/playback device 940 thus configured, the encoder 943 has a function of the image encoding device according to the above-described embodiments. Also, the decoder 947 has a function of the image decoding device according to the above-described embodiments. Therefore, an arrangement can be made wherein, with regard to encoding and decoding of images with the recording/playback device 940, merging of blocks in the temporal direction in motion compensation is enabled, and the code amount of motion information can be reduced.

### 9-4. Fourth Application Example

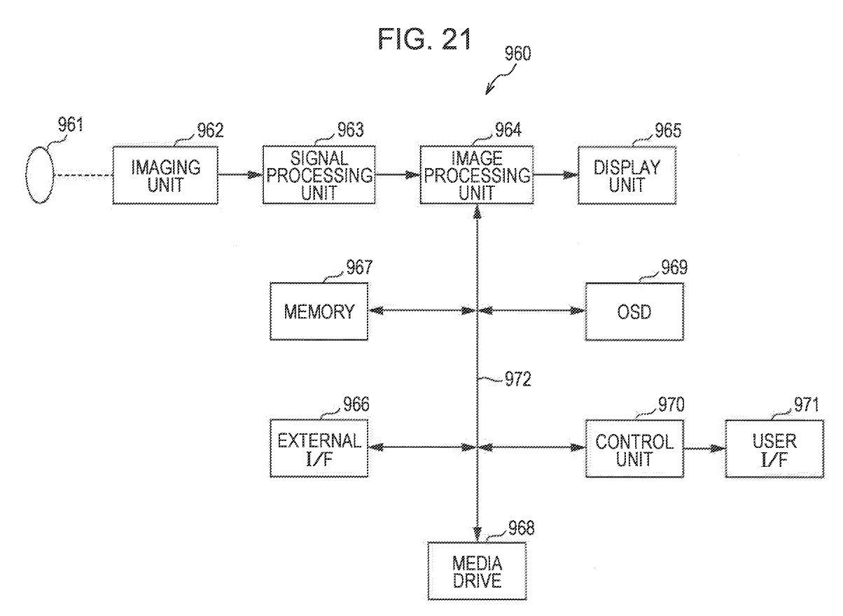

FIG. 21 illustrates an example of the schematic configuration of an imaging apparatus to which the embodiment has been applied. The imaging apparatus 960 images a subject, generates an image, encodes image data and records to a recording medium.

The imaging apparatus 960 is configured of an optical block 961, an imaging unit 962, a signal processor 963, an image processing unit 964, a display unit 965, an external interface 966, a memory 967, a media drive 968, an OSD 969, a control unit 970, a user interface 971 and a bus 972.

The optical block 961 is connected to the imaging unit 962. The imaging unit 962 is connected to the signal processor 963. The display unit 965 is connected to the image processing unit 964. The user interface 971 is connected to the control unit 970. The bus 972 mutually connects the image processing unit 964, external interface 966, memory 967, media drive 968, OSD 969 and control unit 970.

The optical block 961 has a focusing lens and diaphragm mechanism and so forth. The optical block 961 images an optical image of the subject on an imaging face of the imaging unit 962. The imaging unit 962 has an image sensor such as a CCD or a CMOS, and converts the optical image imaged on the imaging face into image signals as electrical signals by photoelectric conversion. The imaging unit 962 then outputs the image signals to the signal processing unit 963.

The signal processor 963 performs various kinds of camera signal processing such as KNEE correction, gamma correction, and color correction to image signals input from the imaging unit 962. The signal processor 963 outputs image data after the camera signal processing to the image processing unit 964.

The image processing unit 964 encodes the image data input from the signal processor 963 and generates an encoded data. The image processing unit 964 then outputs the generated encoded data to the external interface 966 or media drive 968. Also, the image processing unit 964 decodes an encoded data input from the external interface 966 or the media drive 968, and generates image data. The image processing unit 964 then outputs the generated image data to the display unit 965. Also, an arrangement may be made where the image processing unit 964 outputs image data input from the signal processor 963 to the display unit 965 and the image is be displayed. Also, the image processing unit 964 may superimpose data for display acquired from the OSD 969, on an image to be output to the display unit 965.

The OSD 969 generates, a GUI image such as a menu, a button or a cursor, for example, and outputs the generated image to the image processing unit 964.

The external interface 966 is configured, for example, as a USB input and output terminal. For example, the external interface 966 connects a printer to the imaging apparatus 960 at the time of printing of the image. Also, a drive is connected to the external interface 966 as appropriate. The removable media such as a magnetic disk or an optical disk is mounted on the drive, for example, and a program read out from the removable media can be installed in the imaging apparatus 960. Furthermore, the external interface 966 may be configured as a network interface connected to the networks such as LAN or the Internet. That is, the external interface 966 serves as a transmission unit in the imaging apparatus 960.

For example, the recording medium mounted on to the media drive 968 may be any readable/writable removable media, such as a magnetic disk, an MO disk, an optical disk or a semiconductor memory. Also, a non-portable storage unit may be configured, where a recording medium such as a built-in hard disk drive or SSD (Solid State Drive) is mounted on to the media drive 968 fixedly, for example.

The control unit 970 has a processor such as a CPU and memory such as RAM and ROM. The memory stores programs to be executed by the CPU, and data. For example, a program stored in memory is read at the time of a start of the imaging apparatus 960 by the CPU, and is executed. The CPU controls operation of the imaging apparatus 960 according to the operating signals which are input, for example, from the user interface 971 by executing the program.

The user interface 971 is connected to the control unit 970. For example, the user interface 971 has a button and a switch for a user to operate the imaging apparatus 960. The user interface 971 detects the operation by the user via these components, generates operating signals, and outputs the generated operating signals to the control unit 970.

In the imaging apparatus 960 thus configured, the image processing unit 964 has a function of the image encoding device and the image decoding device according to the above-described embodiments. Accordingly, when encoding and decoding images with the imaging apparatus 960, merging of blocks in the temporal direction in motion compensation is enabled, and the code amount of motion information can be reduced.

### 10. SUMMARIZATION

So far, an image encoding device and image decoding device according to an embodiment of the present disclosure have been described with reference to FIG. 1 through FIG. 37. According to the present embodiment, a MergeTempFlag, which indicates whether or not a block of interest within the image and a co-located block are to be merged, is introduced. A motion vector the same as that of the co-located block is set to a block of interest to be merged with the co-located block, at the time of image decoding, in accordance with the value of the MergeTempFlag. That is to say, merging of blocks in the temporal direction in motion compensation is enabled. Accordingly, the code amount of motion information can be reduced near boundaries between moving objects and the background, for example, without deteriorating image quality.

Also, according to the present embodiment, a MergeFlag, which indicates whether or not at least one of neighbor blocks and the co-located block are to be merged with the block of interest, is also used. If the MergeFlag indicates that the block of interest is not to be merged with any of neighbor blocks and the co-located block, the MergeTempFlag is not encoded. Also, even in the event that the MergeFlag indicates that at least one of neighbor blocks and the co-located block are to be merged with the block of interest, the MergeTempFlag is not encoded if the motion information of the neighbor blocks and the co-located block is all the same. Further, in the event that MergeTempFlag indicates that the block of interest and the co-located block are to be merged, the MergeLeftFlag which is used for merging blocks in the spatial direction is not encoded. Accordingly, increase in flags due to introducing the MergeTempFlag is suppressed.

Also, according to such a flag configuration according to the present embodiment, a device which uses only MergeFlag and MergeLeftFlag proposed in NPL 2 described above can be expanded with relatively low cost, and MergeTempFlag for merging blocks in the temporal direction can be readily introduced.

[temporal_merge_enable_flag]

Note that in addition to the above-described various flags (MergeFlag, MergeLeftFlag, and MergeTempFlag), a flag to control whether or not to use MergeLeftFlag (temporal_merge_enable_flag) may be used.

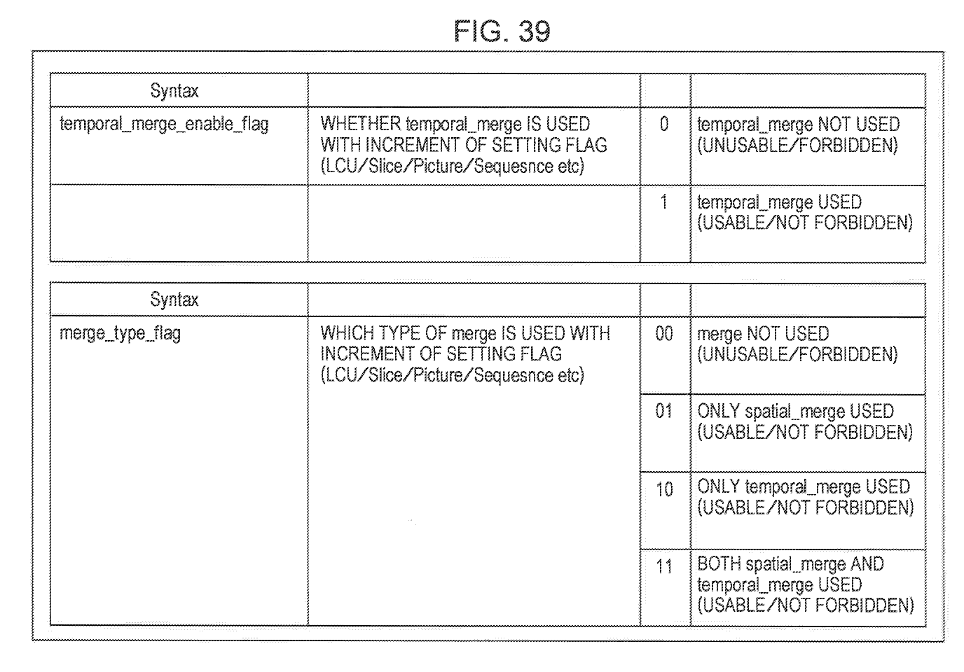

As illustrated in the table above in FIG. 39, this temporal_merge_enable_flag indicates whether or not MergeTempFlag is used in data increments which this flag has set (whether the temporal peripheral region is included in merge candidates) by the value thereof. For example, in the event that the value “0” is set, this indicates that MergeTempFlag is not used (unusable/forbidden) in that data increment. Conversely, in the event that the value “1” is set, this indicates that MergeTempFlag is used (usable/not forbidden) in that data increment.

The value of this temporal_merge_enable_flag controls the decoding processing at the decoding side (e.g., image decoding device 1200 (FIG. 30)).

In the event that the temporal peripheral region is to be included in merge candidates, the three flags of MergeFlag, MergeLeftFlag, and MergeTempFlag are necessary at the time of decoding. On the other hand, in the event that the temporal peripheral region is not to be included in merge candidates, only MergeFlag and MergeLeftFlag are necessary for decoding. The decoding side can correctly comprehend which flags are included in the merge information by the value of this temporal_merge_enable_flag, and correctly decode.

This temporal_merge_enable_flag is set as to optional data increments such as LCUs, slices, pictures, sequences and so forth, for example. The storage location of this temporal_merge_enable_flag is optional, and may be, for example, in the slice header, picture parameter set (PPS (Picture Parameter Set)), or sequence parameter set (SPS (Sequence Parameter Set)), or may be included in VAL.

For example, in the event of forbidding use of MergeTempFlag in a certain slice, a temporal_merge_enable_flag with a value of “0” is preferably stored in the slice header of the bit stream. If the merge information decoding unit 1242 of the image decoding device 1200 has obtained the temporal_merge_enable_flag as merge information, the fact that MergeTempFlag is not included in the merge information of that slice can be understood from that value. That is to say, the storage location (hierarchical level) of the temporal_merge_enable_flag indicates the range of application of the settings thereof.

By following such settings of the temporal_merge_enable_flag, the merge information decoding unit 1242 can correctly comprehend which flags are included in the merge information, so both merge information including MergeFlag and MergeLeftFlag but not including MergeTempFlag, and merge information including MergeFlag, MergeTempFlag, and MergeLeftFlag, and be correctly decoded.

Note that in the event of not using this temporal_merge_enable_flag, there has been the need to include a temporal peripheral region as a merge candidate in order to enable the merge information decoding unit 1242 to correctly decode merge information, regardless of whether the temporal peripheral region would actually be merged or not. That is to say, merge mode needed to be expressed by the values of the three flags of MergeFlag, MergeTempFlag, and MergeLeftFlag, and there has been the possibility that encoding efficiency would deteriorate accordingly.

Conversely, by using temporal_merge_enable_flag as described above, MergeTempFlag can be omitted in a case that the temporal peripheral region is not to be taken as a merge candidate over a desired data increment, just by indicating the value of temporal_merge_enable_flag one time, and encoding efficiency can be improved accordingly. Also, analysis of the MergeTempFlag becomes unnecessary, so the load on the merge information decoding unit 1242 (not only the load on the CPU, but also including amount of memory used, number of times of readout, occupied bus bandwidth, and so forth) is reduced.

Note that in the event of taking the temporal peripheral region as a merge candidate, that is to say, in the event that the value of temporal_merge_enable_flag is “1”, MergeFlag, MergeTempFlag, and MergeLeftFlag are necessary as merge information. Accordingly, the amount of information increases by an amount equivalent to that of the temporal_merge_enable_flag, but only 1 bit increases in that data increment, so this increase does not greatly affect encoding efficiency.

This temporal_merge_enable_flag is set at the encoding side (e.g., image encoding device 1100 (FIG. 23)). Also, the encoding processing is also controlled by the value of this temporal_merge_enable_flag.

The value of temporal_merge_enable_flag is, for example, instructed by the user, or decided based on optional conditions such as the content of the image and so forth. The merge information generating unit 1142 performs merge processing baled on the value of this temporal_merge_enable_flag. For example, in the event that temporal_merge_enable_flag forbids usage of MergeTempFlag, the merge information generating unit 1142 preforms merge processing without including the temporal peripheral region in the merge candidates, and generates MergeFlag and MergeLeftFlag as merge information. For example, in the event that temporal_merge_enable_flag does not forbid usage of MergeTempFlag, the merge information generating unit 1142 performs merge processing including the temporal peripheral region in the merge candidates, and generates MergeFlag, MergeTempFlag, and MergeLeftFlag as merge information.

Accordingly, in such processing at the encoding side as well, in the event that the temporal peripheral region is not to be taken as merge candidates in predetermined data increments, using temporal_merge_enable_flag allows the number of merge candidates to be reduced, and in the same way as with the decoding side, the processing load on the merge information generating unit 1142 (not only the load on the CPU, but also including amount of memory used, number of times of readout, occupied bus bandwidth, and so forth) is reduced.

Also, the lossless encoding unit 1106 stores the temporal_merge_enable_flag in a predetermined location of the bit stream. Thus, the temporal_merge_enable_flag is transmitted to the decoding side (e.g., image decoding device 1200)).

Note that while description has been made above that the temporal_merge_enable_flag is transmitted to the decoding side having been included in the bit stream, the transmission method of temporal_merge_enable_flag is optional, and may be transmitted as a separate file from the bit stream, for example. For example, the temporal_merge_enable_flag may be transmitted to the decoding side via a different transmission path or recording medium or the like as the bit stream.

As described above, the temporal_merge_enable_flag can be set to optional data increments. The temporal_merge_enable_flag may be set for each data increment, or may be set to a desired portion only. An arrangement may be made where data increments of application range are different for each temporal_merge_enable_flag. Note however, in the event of not setting to each of fixed data increments, there is the need to enable the temporal_merge_enable_flag to be identified.

Also, while description has been made above that the temporal_merge_enable_flag is i-bit information, the bit length of temporal_merge_enable_flag is optional, and may be two bits or longer, For example, an arrangement may be made where temporal_merge_enable_flag indicates the settings of “whether or not usage of MergeTempFlag is forbidden”, and also indicates “the application range of the settings thereof (data increments to which the settings are applied)”. For example, the value of temporal_merge_enable_flag stored in a slice header may include a bit indicating that ““usage of MergeTempFlag is forbidden”, and a bit indicating the LCU to which the settings are applied (to which LCU in the slice they are to be applied)”.

While description has been made that the application range of settings (control increments) of the temporal_merge_enable_flag is optional, generally, the wider the control increment is, i.e., controlling at a higher order hierarchical level such as a picture or sequence or the like, the number of instances of temporal_merge_enable_flag can be reduced, and encoding efficiency can be improved. Also, addition of encoding and decoding can be reduced. Conversely, the narrower the control increment is, i.e., controlling at a lower order hierarchical level such as an LCU or PU or the like, allows control of merge mode to be performed in more detail. In actual practice, employing a control unit where an optimal balance can be obtained based on various conditions under such a trade-off is desirable.

[merge_type_flag]

Further, a flag controlling which type of merge to perform (merge_type_flag) may be used.

As illustrated in the table below in FIG. 39, this merge_type_flag indicates by the value thereof which type of merge processing is to be performed in the application range (control increment) of settings of this flag. For example, in the event that the value “00” is set, merge processing is not performed (merge mode is unusable, forbidden). Also, in the event that the value “01” is set, only spatial peripheral regions are taken as merge candidates. Further, in the event that the value “10” is set, only the temporal peripheral region is taken as a merge candidate. Also, in the event that the value “11” is set, both spatial peripheral regions and temporal peripheral region are taken as merge candidates.

In the same way as with the case of temporal_merge_enable_flag, the value of this merge_type_flag controls the encoding processing at the encoding side and the decoding processing at the decoding side. For example, the merge information generating unit 1142 of the image encoding device 1100 performs merge processing using candidates according to the value of the merge_type_flag described above. Accordingly, the merge information generating unit 1142 can reduce the number of merge candidates, and the processing load (not only the load on the CPU, but also including amount of memory used, number of times of readout, occupied bus bandwidth, and so forth) is reduced.

By merge processing such as described above being performed at the encoding side, in the event of applying this merge_type_flag part or all of MergeFlag, MergeTempFlag, and MergeLeftFlag is stored in the merge information generated at the encoding side and transmitted to the decoding side, in accordance with the value of merge_type_flag.

Specifically, in the event that the value of merge_type_flag is “00” for example, merge processing is not performed, so merge information is not transmitted. Also, in the event that the value of merge_type_flag is “01” for example, only spatial peripheral regions are taken as merge candidates, so only MergeFlag and MergeLeftFlag are stored in the merge information. Further, in the event that the value of merge_type_flag is “10” for example, only the temporal peripheral region is taken as a merge candidate, so only MergeFlag (or MergeTempFlag) is stored in the merge information. Also, in the event that the value of merge_type_flag is “11” for example, both spatial peripheral regions and temporal peripheral region are taken as merge candidates, so all of MergeFlag, MergeTempFlag, and MergeLeftFlag are stored in the merge information.

Also, the lossless encoding unit 1106 stores the merge_type_flag in a predetermined location of the bit stream. Thus, the merge_type_flag is transmitted to the decoding side (e.g., image decoding device 1200)).

The merge information decoding unit 1242 of the image decoding device 1200 decodes merge information in accordance with the value of the merge_type_flag supplied form the encoding side in this way. Accordingly, the merge information decoding unit 1242 can correctly comprehend which flags of the MergeFlag, MergeTempFlag, and MergeLeftFlag are included in the merge information, and can correctly decode the merge information.

Accordingly, in the case of applying this merge_type_flag as well, encoding efficiency can be improved in the same way as with the case of temporal_merge_enable_flag. Also, analysis of flags where merge mode is not included becomes unnecessary, so the processing load of the merge information decoding unit 1242 (not only the load on the CPU, but also including amount of memory used, number of times of readout, occupied bus bandwidth, and so forth) is reduced.

Note that, in the same way as with the case of temporal_merge_enable_flag, settings of merge_type_flag can be made to optional data increments. The storage location is also optional. The features according to the control range and storage location of the merge_type_flag are the same as with the case of temporal_merge_enable_flag described above, so description will be omitted. Also, the transmission method and data length of merge_type_flag is also optional, in the same way as with temporal_merge_enable_flag.

While specific examples of values of temporal_merge_enable_flag and merge_type_flag have been described above, these are but exemplary, and temporal_merge_enable_flag and merge_type_flag may assume any values, and any settings may be assigned to those values.

Note that, in the present description, an example in which a various information such as prediction mode information and merge information are multiplexed in a header of an encoded stream and transmitted from the encoding side to the decoding side has been described. However, techniques to transmit these information are not restricted to these examples. For example, these information may be transmitted or recorded as different data correlated to the encoded bit stream without being multiplexed to the encoded bit stream. Here, the term “correlated” means that the image (or part of the image including slice or the block) included in the bit stream can be linked to the information corresponding to the image at the time of decoding. That is, the information may be transmitted on a transmission path different from that of the image (or bit stream). Also, the information may be recorded to a recording medium (or another recording area of the same recording medium) different from that of the image (or bit stream). Furthermore, the information and the image (or bit stream) may be mutually correlated with any increments of multiple frames, one frame, or a portion in the frame, for example.

Description has been made about the preferred embodiment of this disclosure with reference to an attached drawing, but the technical scope of the present disclosure is not limited to such an example. It goes without saying that a person having normal knowledge in the technical field of the present disclosure will be able to conceive various modifications and alterations within the scope of the technical idea according to the Claims and it is to be understood that these also belong to the technical scope of the present disclosure.

Note that the present technology may also assume the following configurations.

(1) An image processing device includes:

a determining unit configured to determine whether or not motion information of a current block which is to be processed, and motion information of a co-located block situated in the temporal periphery of the current block, match; and

a merge information generating unit configured to, in the event that determination is made by the determining unit that these match, generate temporal merge information specifying the co-located block as a block with which the current block is to be temporally merged.

(2) The image processing device according to (1), wherein the merge information generating unit selects the co-located block having motion information matching the motion information of the current block, as the block with which the current block is to be merged, and generates the temporal merge information specifying the selected co-located block.

(3) The image processing device according to (2), wherein the merge information generating unit generates temporal merge enable information specifying whether to temporally merge the co-located block with the current block, as the temporal merge information.

(4) The image processing device according to (3), wherein the merge information generating unit generates temporal motion identification information identifying that the motion information of the current block and the motion information of the co-located block are the same, as the temporal merge information.

(5) The image processing device according to (4),

wherein the determining unit determines whether or not motion information of the current block, and motion information of a peripheral block situated in the spatial periphery of the current block, match;

and wherein, in the event that determination is made by the determining unit that these match, the merge information generating unit generates spatial merge information specifying the peripheral block as a block with which the current block is to be spatially merged.

(6) The image processing device according to (5), wherein the merge information generating unit generates merge type information identifying the type of processing for merging.

(7) The image processing device according to (5) or (6), wherein, in the event of taking the co-located block and the peripheral block as candidate blocks for performing merging, the merge information generating unit generates identification information identifying that the motion information of the current block and the motion information of the candidate blocks are the same.

(8) The image processing device according to (7), further including a priority order control unit configured to control the priority order of merging the co-located block and the peripheral block with the current block;

wherein the merge information generating unit selects a block to merge with the current block following the priority order controlled by the priority order control unit.

(9) The image processing device according to (8), wherein the priority order control unit controls the priority order in accordance with motion features of the current block.

(10) The image processing device according to (9), wherein the priority order control unit controls the priority order such that, in the event that the current block is a still region, the co-located block is given higher priority than the peripheral block.

(11) The image processing device according to (9) or (10), wherein the priority order control unit controls the priority order such that, in the event that the current block is a moving region, the peripheral block is given higher priority than the co-located block.

(12) An image processing method of an image processing device, the method including:

a determining unit determining whether or not motion information of a current block which is to be processed, and motion information of a co-located block situated in the temporal periphery of the current block, match; and

in the event that determination is made by the determining unit that these match, a merge information generating unit generating temporal merge information specifying the co-located block as a block with which the current block is to be temporally merged.

(13) An image processing device, including:

a merge information reception unit configured to receive temporal merge information specifying a co-located block, situated in the temporal periphery of a current block which is to be processed, as a block to be temporally merged with the current block; and

a setting unit configured to set motion information of the co-located block, specified by the temporal merge information received from the merge information reception unit, as motion information of the current block.

(14) The image processing device according to (13), wherein the temporal merge information specifies a co-located block having motion information matching the motion information of the current block, as the block with which the current block is to be temporally merged.

(15) The image processing device according to (13) or (14), wherein the temporal merge information includes temporal merge enable information specifying whether to temporally merge the co-located block with the current block.

(16) The image processing device according to any one of (13) through (15), wherein the temporal merge information includes temporal motion identification information identifying that the motion information of the current block and the motion information of the co-located block are the same.

(17) The image processing device according to any one of (13) through (16),

wherein the merge information reception unit receives spatial merge information specifying a peripheral block, situated in the spatial periphery of the current block, as a block to be spatially merged with the current block;

and wherein the setting unit sets motion information of the peripheral block, specified by the spatial merge information received from the merge information reception unit, as motion information of the current block.

(18) The image processing device according to (17), wherein the merge information reception unit receives merge type information identifying the type of processing for merging.

(19) The image processing device according to (17) or (18), wherein, in the event of taking the co-located block and the peripheral block as candidate blocks for performing merging, the merge information reception unit receives identification information identifying that the motion information of the current block and the motion information of the candidate blocks are the same.

(20) The image processing device according to any one of (17) through (19), wherein the setting unit selects the co-located block or the peripheral block as a block to merge with the current block, following information received by the merge information reception unit, indicating priority order of merging with the current block, and sets the motion information of the selected block as the motion information for the current block.

(21) The image processing device according to (20), wherein the priority order is controlled in accordance with motion features of the current block.

(22) The image processing device according to (21), wherein, in the event that the current block is a still region, the co-located block is given higher priority than the peripheral block.

(23) The image processing device according to (21) or (22), wherein, in the event that the current block is a moving region, the peripheral block is given higher priority than the co-located block.

(24) An image processing method of an image processing device, the method including:

a merge information reception unit receiving temporal merge information specifying a co-located block, situated in the temporal periphery of a current block which is to be processed, as a block to be temporally merged with the current block; and

a setting unit setting motion information of the co-located block, specified by the temporal merge information received from the merge information reception unit, as motion information of the current block.

### REFERENCE SIGNS LIST

10 image processing device (image encoding device)
42 motion vector calculating unit
45 merge information generating unit
60 image processing device (image decoding device)
91 merge information decoding unit
93 motion vector setting unit
1100 image encoding device
1121 still region determining unit
1122 motion vector encoding unit
1200 image decoding device
1221 still region determining unit
1222 motion vector decoding unit

1. An image processing device, comprising:
a determining unit configured to determine whether or not motion information of a current block which is to be processed, and motion information of a co-located block situated in the temporal periphery of the current block, match; and
a merge information generating unit configured to, in the event that determination is made by the determining unit that these match, generate temporal merge information specifying the co-located block as a block with which the current block is to be temporally merged.

2. The image processing device according to claim 1, wherein the merge information generating unit selects the co-located block having motion information matching the motion information of the current block, as the block with which the current block is to be merged, and generates the temporal merge information specifying the selected co-located block.

3. The image processing device according to claim 2, wherein the merge information generating unit generates temporal merge enable information specifying whether to temporally merge the co-located block with the current block, as the temporal merge information.

4. The image processing device according to claim 3, wherein the merge information generating unit generates temporal motion identification information identifying that the motion information of the current block and the motion information of the co-located block are the same, as the temporal merge information.

5. The image processing device according to claim 4,
wherein the determining unit determines whether or not motion information of the current block, and motion information of a peripheral block situated in the spatial periphery of the current block, match;
and wherein, in the event that determination is made by the determining unit that these match, the merge information generating unit generates spatial merge information specifying the peripheral block as a block with which the current block is to be spatially merged.

6. The image processing device according to claim 5, wherein the merge information generating unit generates merge type information identifying the type of processing for merging.

7. The image processing device according to claim 5, wherein, in the event of taking the co-located block and the peripheral block as candidate blocks for performing merging, the merge information generating unit generates identification information identifying that the motion information of the current block and the motion information of the candidate blocks are the same.

8. The image processing device according to claim 7, further comprising:
a priority order control unit configured to control the priority order of merging the co-located block and the peripheral block with the current block;
wherein the merge information generating unit selects a block to merge with the current block following the priority order controlled by the priority order control unit.

9. The image processing device according to claim 8, wherein the priority order control unit controls the priority order in accordance with motion features of the current block.

10. The image processing device according to claim 9, wherein the priority order control unit controls the priority order such that, in the event that the current block is a still region, the co-located block is given higher priority than the peripheral block.

11. The image processing device according to claim 9, wherein the priority order control unit controls the priority order such that, in the event that the current block is a moving region, the peripheral block is given higher priority than the co-located block.

12. An image processing method of an image processing device, the method comprising:
a determining unit determining whether or not motion information of a current block which is to be processed, and motion information of a co-located block situated in the temporal periphery of the current block, match; and
in the event that determination is made by the determining unit that these match, a merge information generating unit generating temporal merge information specifying the co-located block as a block with which the current block is to be temporally merged.

13. An image processing device, comprising:
a merge information reception unit configured to receive temporal merge information specifying a co-located block, situated in the temporal periphery of a current block which is to be processed, as a block to be temporally merged with the current block; and
a setting unit configured to set motion information of the co-located block, specified by the temporal merge information received from the merge information reception unit, as motion information of the current block.

14. The image processing device according to claim 13, wherein the temporal merge information specifies a co-located block having motion information matching the motion information of the current block, as the block with which the current block is to be temporally merged.

15. The image processing device according to claim 13, wherein the temporal merge information includes temporal merge enable information specifying whether to temporally merge the co-located block with the current block.

16. The image processing device according to claim 13, wherein the temporal merge information includes temporal motion identification information identifying that the motion information of the current block and the motion information of the co-located block are the same.

17. The image processing device according to claim 13,
wherein the merge information reception unit receives spatial merge information specifying a peripheral block, situated in the spatial periphery of the current block which is to be processed, as a block to be spatially merged with the current block;
and wherein the setting unit sets motion information of the peripheral block, specified by the spatial merge information received from the merge information reception unit, as motion information of the current block.

18. The image processing device according to claim 17, wherein the merge information reception unit receives merge type information identifying the type of processing for merging.

19. The image processing device according to claim 17, wherein, in the event of taking the co-located block and the peripheral block as candidates for performing merging, the merge information reception unit receives identification information identifying that the motion information of the current block and the motion information of the candidate blocks are the same.

20. The image processing device according to claim 17, wherein the setting unit selects the co-located block or the peripheral block as a block to merge with the current block, following information received by the merge information reception unit, indicating priority order of merging with the current block, and sets the motion information of the selected block as the motion information for the current block.

21. The image processing device according to claim 20, wherein the priority order is controlled in accordance with motion features of the current block.

22. The image processing device according to claim 21, wherein, in the event that the current block is a still region, the co-located block is given higher priority than the peripheral block.

23. The image processing device according to claim 21, wherein, in the event that the current block is a moving region, the peripheral block is given higher priority than the co-located block.

24. An image processing method of an image processing device, the method comprising:
a merge information reception unit receiving temporal merge information specifying a co-located block, situated in the temporal periphery of a current block which is to be processed, as a block to be temporally merged with the current block; and
a setting unit setting motion information of the co-located block, specified by the temporal merge information received from the merge information reception unit, as motion information of the current block.
